(19) United States
(12) Patent Application Publication
(10) Pub. No.: US 2024/0366456 A1
(43) Pub. Date: Nov. 7, 2024

(54) INSTRUMENT

(71) Applicant: LEMON inc., Tokyo (JP)

(72) Inventors: Hisayo SUGAO, Tokyo (JP); Shinjiro YAMADA, Tokyo (JP)

(21) Appl. No.: 18/572,903

(22) PCT Filed: Jun. 9, 2022
(86) PCT No.: PCT/JP2022/023370

§ 371 Date: Dec. 21, 2023

(30) Foreign Application Priority Data
Jun. 22, 2021 (JP) 2021-103657
Jun. 22, 2021 (JP) 2021-103658
Jun. 22, 2021 (JP) 2021-103659
Jun. 22, 2021 (JP) 2021-103660
Jun. 22, 2021 (JP) 2021-103661
Jun. 22, 2021 (JP) 2021-103662

(51) Int. Cl. A61H 1/00; A61H 23/02

(52) U.S. Cl. CPC A61H 1/008; A61H 23/02; A61H 2201/1635; A61H 2205/065

(57) ABSTRACT

Provided is an instrument capable of promoting muscle stretching and increasing a range of motion of a joint. The instrument according to the present invention includes: a main body portion; a pressing portion that is provided to protrude from the main body portion, and a vibration applying unit that generates vibration, in which by grasping the main body portion with one hand, the pressing portion is configured to be brought into contact with skin on a Pacinian corpuscle present in the palm to press the Pacinian corpuscle while transmitting vibration to the Pacinian corpuscle, and the pressing portion can accurately be brought into contact with the Pacinian corpuscle to apply an appropriate pressure to the Pacinian corpuscle.

### TECHNICAL FIELD

The present invention relates to an instrument for increasing a range of motion of a joint.

### BACKGROUND ART

With aging, joint flexibility is lost and the body becomes stiff, and this loss of flexibility may cause unexpected disorders. In particular, in the case of an elderly person, it has also been reported that when a leg is broken at the time of tumbling or falling, the person tends to become bedridden, and when the person is bedridden, dementia progresses. In addition, even if the person is not an elderly person, an unexpected serious accident is caused due to low flexibility. In addition, there is a risk of causing unforeseen disorders such as Achilles tendon rupture and muscle damage during sports. High flexibility prevents such unforeseen accidents, injuries, and disorders. This flexibility is one type of human physical strength, involving the ability to stretch muscles and tendons, is one type of motor skill together with muscle strength, instantaneous force, endurance, and adjustment force, and is a physical ability that is a basis of basic actions. In other words, high flexibility means that the range of motion of a joint increases, and flexible movement is realized. In order to maintain and promote health and to perform activities with security throughout a 100 year life, it is one very important approach is to increase and maintain flexibility, which is a force for smoothly performing an action of a constituent of physical strength and is a physical ability that is a basis of basic actions.

For example, in order to improve flexibility, Patent Literature 1 proposes a stretching auxiliary instrument including a footboard, a heel stopper protruding from an upper portion of a rear end portion of the footboard, and a support member that supports the footboard while inclining the footboard at a desired angle, in which a desired number of engagement recessed grooves for angle adjustment in a width direction of the footboard are formed in parallel on an upper surface of the footboard at a predetermined interval in a front-back direction of the footboard, and the support member includes a pair of leg rods having a predetermined length that are placed parallel to each other with a distance interval slightly longer than a width dimension of the footboard, a connecting rod that connects and fixes both leg rods, an engaging rod that is located on a straight line connecting both leg rods and formed in a perpendicular direction at an upper end of both leg rods and engages with the recessed groove, and a support rod that is located below the engaging rod and is fixed to horizontally bridge a gap between both leg rods with a distance interval corresponding to a thickness of the footboard between the support rod and the engaging rod.

Then, according to the stretching auxiliary instrument, when the footboard is inserted between the engaging rod and the support rod of the support member from a tip side to engage the engaging rod with the engagement recessed groove, and the footboard is grounded by opening the leg rod toward a front side of the footboard in that state, the footboard is supported by the support rod, fixed by wedge action with the engaging rod, and stably supported in an inclined state. Thus, by standing on the footboard and using the footboard in the same way as before, it is said that it exhibits various excellent effects of stretching such as strengthening of the Achilles tendon.

### CITATION LIST

### Patent Literature

Patent Literature 1: JP 11-299926 A

### SUMMARY OF INVENTION

### Technical Problem

However, the conventional method for increasing the range of motion of a joint uses a large-scale apparatus or is accompanied with muscle pain or suffering during muscle stretching, and thus there is a problem that it is difficult to perform the method easily and continuously. In addition, there is a problem that the flexibility returns to an original state unless stretching is performed for a while. As described above, the conventional method for increasing the range of motion of a joint has little or no effect. Therefore, a more effective method is desired.

The present invention has been made in view of the above problems, and an object of the present invention is to provide an instrument capable of promoting muscle stretching and increasing the range of motion of a joint.

### Solution to Problem

In order to solve the above problems, the present inventors have found that when a specific Pacinian corpuscle (specifically, a Pacinian corpuscle present in a palm) among a large number of Pacinian corpuscles present in a human body is pressed, the muscle stretching is promoted, and the range of motion of a joint can be increased by reducing the muscle pain, and completed the present invention.

### Advantageous Effects of Invention

According to the present invention, it is possible to provide an instrument capable of promoting muscle stretching and increasing the range of motion of a joint. Moreover, according to the present invention, when the instrument is used, an effect of maintaining a muscle stretching effect for a certain period of time (for example, 5 minutes) after use is also exhibited. Further, according to the present invention, an effect of enabling the instrument to be effectively used is also exhibited.

### BRIEF DESCRIPTION OF DRAWINGS

FIG. 1 is a view illustrating a configuration of an instrument according to a first embodiment.

FIG. 2 is an enlarged view of FIG. 1(b).

FIG. 3 is a view illustrating a configuration of the instrument according to the first embodiment.

FIG. 4 is a view illustrating a function of the instrument according to the first embodiment.

FIG. 5 is a view illustrating a function of the instrument according to the first embodiment.

FIG. 6 is a view illustrating a method of grasping the instrument according to the first embodiment.

FIG. 7 is a view illustrating the method of grasping the instrument according to the first embodiment.

FIG. 8 is a view illustrating a configuration of an instrument according to a modification example of the first embodiment.

FIG. 9 is a view for explaining measurement in Example.

FIG. 10 is a view for explaining the measurement in Example.

FIG. 11 is a view for explaining the measurement in Example.

FIG. 12 is a view for explaining the measurement in Example.

FIG. 13 is a view for explaining the measurement in Example.

FIG. 14 is a view for explaining the measurement in Example.

FIG. 15 is a view for explaining the measurement in Example.

FIG. 16 is a view for explaining the measurement in Example.

FIG. 17 is a view for explaining the measurement in Example.

FIG. 18 is a view for explaining the measurement in Example.

FIG. 19 is a view for explaining the measurement in Example.

FIG. 20 is a view for explaining the measurement in Example.

FIG. 21 is a view for explaining the measurement in Example.

FIG. 22 is a view for explaining the measurement in Example.

FIG. 23 is a view for explaining the measurement in Example.

FIG. 24 is a view for explaining the measurement in Example.

FIG. 25 is a view for explaining the measurement in Example.

FIG. 26 is a view for explaining the measurement in Example.

FIG. 27 is a diagram showing measurement results (empty hand and instrument (grip)) of Example.

FIG. 28 is a diagram showing measurement results (stick and instrument (grip)) of Example.

FIG. 29 is a diagram showing measurement results (empty hand and stick) of Example.

FIG. 30 is a view illustrating positions of two Pacinian corpuscles present in hands (Pacinian corpuscle pressing portion that we called a Pacinian point).

FIG. 31 is a perspective view illustrating a configuration of an instrument according to a second embodiment.

FIG. 32 is a plan view illustrating the configuration of the instrument according to the second embodiment.

FIG. 33 is a view illustrating the configuration of the instrument according to a second embodiment.

FIG. 34(a) is a view for illustrating an example of an accurate position of a corpuscle pressing portion that we call as a Pacinian point, and FIG. 34(b) is a view for illustrating an effect in a case where the instrument is used accurately.

FIG. 35 is a view for illustrating a distribution of Pacinian points.

FIG. 36 is a view for illustrating a first embodiment according to the invention of a locating method of a Pacinian point.

FIG. 37 is a view for illustrating the first embodiment according to the invention of the locating method of a Pacinian point.

FIG. 38 is a view for illustrating a modification example of the first embodiment according to the invention of the locating method of a Pacinian point.

FIGS. 39(a) and 39(b) are views for illustrating an auxiliary tool.

FIG. 40 is a view for illustrating a second embodiment according to the invention of the locating method of a Pacinian point.

FIG. 41 is a view for illustrating the second embodiment according to the invention of the locating method of a Pacinian point.

FIGS. 42(a) and 42(b) are views for illustrating a point capturing device.

FIGS. 43(a) and 43(b) are views for illustrating a point printing device.

FIG. 44 is a view for illustrating a step of producing the auxiliary tool.

FIG. 45 is a view for illustrating AI learning of the second embodiment according to the invention of the locating method of a Pacinian point.

FIG. 46 is a view for illustrating a position locating system and a position locating method of the second embodiment according to the invention of the locating method of a Pacinian point.

FIG. 47(a) is a view for illustrating measurement of a hand in an embodiment of the invention relating to an automatic design method for the instrument, and FIG. 47(b) is a view for illustrating a position of a joint when the instrument is gripped.

FIG. 48 is a view for illustrating a model of a bone.

FIG. 49 is a view for illustrating 3D scanning regarding a shape of a hand.

FIG. 50 is a view illustrating an image obtained by capturing a model of a bone and a model of a hand side by side.

FIG. 51 is a view illustrating an image captured by superimposing the model of a hand on the model of a bone.

FIG. 52 is a view illustrating an image captured by gripping a dummy grip.

FIG. 53 is a view for illustrating a hand in a state where a little finger and a ring finger are bent.

FIG. 54 is a view for illustrating dimensions of parts of the instrument.

FIG. 55 is a view for illustrating a change in dimension of the instrument.

FIG. 56 is a flowchart schematically illustrating a procedure of automatic design for the instrument.

FIG. 57 is a view for illustrating an effect of the instrument according to the first embodiment or the second embodiment.

FIG. 58(a) is a view for illustrating the instrument according to the second embodiment, and FIGS. 58(b) to 58(f) are views for illustrating modification examples of a ring portion.

FIG. 59 is a view for illustrating a first modification example regarding a pressing portion.

FIGS. 60(a) and 60(b) are views for illustrating a second modification example regarding the pressing portion.

FIGS. 61(a) and 61(b) are views for illustrating a modification example regarding a first contact portion of the pressing portion.

FIG. 62 is a view for illustrating a third modification example regarding the pressing portion.

FIG. 63 is a view for illustrating an effect of a third modification example regarding the pressing portion.

FIGS. 64(a) and 64(b) are views for illustrating a fourth modification example regarding the pressing portion.

FIG. 65 is a view for illustrating a fifth modification example regarding the pressing portion.

FIG. 66 is a view for illustrating a sixth modification example regarding the pressing portion.

FIG. 67 is a view for illustrating a seventh modification example regarding the pressing portion.

FIGS. 68(a) and 68(b) are views for illustrating a type of instrument that does not include a ring portion used in the measurement of the effect illustrated in FIG. 55.

FIG. 69 is a view for illustrating an instrument according to a third embodiment.

FIG. 70 is a view for illustrating an instrument according to a fourth embodiment.

FIG. 71 is a diagram for illustrating a first embodiment of the invention relating to a user information providing system.

FIG. 72 is a diagram for illustrating a second embodiment of the invention relating to the user information providing system.

FIG. 73 is a view for illustrating a third embodiment of the invention relating to the user information providing system.

FIG. 74 is a diagram for illustrating a fourth embodiment of the invention relating to the user information providing system.

FIG. 75(a) is a view for illustrating a modification example of the instrument according to the fourth embodiment of FIG. 70, and FIG. 75(b) is a view illustrating a change in orientation of the modification example of FIG. 75(a).

FIG. 76 is a diagram for illustrating an integrated system in which the first embodiment and the second embodiment according to the invention of the locating method of a Pacinian point are integrated.

FIG. 77 is a diagram for illustrating an integrated system in which each embodiment according to the locating method of a Pacinian point and an embodiment of the invention relating to a method of designing the inventive instrument are integrated.

### DESCRIPTION OF EMBODIMENTS

Hereinafter, embodiments of the present invention will be described with reference to the drawings. The following description is roughly divided into the following sections.
(1) First embodiment regarding instrument
(2) Second embodiment regarding instrument
(3) First embodiment regarding Pacinian point locating system
(4) Second embodiment regarding Pacinian point locating system
(5) Third embodiment regarding instrument
(6) Various modification examples regarding pressing portion
(7) Automatic design of instrument
(8) Third embodiment regarding instrument
(9) Fourth embodiment regarding instrument
(10) Application to user information providing system

These sections will be sequentially described below.

Positions of the Pacinian corpuscles in the palms of the human body are almost the same, but the positions are slightly different depending on a person and left and right hands.

An instrument according to an embodiment has a structure in which, in a hand tool held in one hand and used, when gripped in the palm, a Pacinian ball (a contact portion 21 of a pressing portion 20), which is a protrusion provided in a main body, hits an accurate position of the Pacinian corpuscle every time. In addition, the instrument according to the embodiment is characterized in that a force or a pressure can be adjusted so that an appropriate pressure capable of maximally exhibiting an effect (muscle relaxation effect) of the Pacinian corpuscle is applied.

### (Pacinian Corpuscle)

The Pacinian corpuscle is a sensory receptor that detects the pressure or vibration, and in the hand, as illustrated in FIG. 30, the Pacinian corpuscles are present near a central portion of the palm (a surface from a wrist to a base of finger that is the inner side when the hand is gripped) on the little finger side (A in the figure) and at a tip portion of a middle finger (B in the figure). Among them, the Pacinian corpuscle according to the present invention is the Pacinian corpuscle present in the palm (A in the figure). An instrument 1 according to the embodiment stimulates the Pacinian corpuscle present near the central portion of the palm on the little finger side. An object of the present invention is to reduce pain on a side on which a muscle extends during muscle stretching by pressure stimulation to the Pacinian corpuscle (for the Pacinian corpuscle, see for example, Shoichi Ishiura (Superviser), “Motion and Body Illustration: Mechanism of Brain and Nerves”, Mynavi Publishing Corporation, Mar. 29, 2016, p. 45-46, and Seiji Ozawa and Koichiro Fukuda (Editors), “Standard physiology”, Igaku-Shoin Ltd., Apr. 1, 2009, p. 221-223, and for the position of the Pacinian corpuscle, see for example, Johansson R S, Vallbo A B (1983) Tactile sensory coding in the glabrous skin of the human hand. Trends Neurosci 6:27-31, Hie-yong Jeong, Makoto Kaneko, Mitsuru Higashimori, and Kanji Matsukawa (2007), “Improvement of Tactile Sensitivity under Pressing a Finger Base”, Transactions of the Society of Instrument and Control Engineers, Vol. 43, No. 11, pp. 973-979, https://www.jstage.jst.go.jp/article/sicetr1965/43/11/43_973/pdf/-char/ja, https://www.jstage.jst.go.jp/article/sicetr1965/43/11/43_973/_article/-char/ja/, Yuki Mori, Takayuki Tanaka, Shun′ichi Kaneko (2010) “Design of Vibration Alert Interface based on Vibration Strength Considering Skin Deformation with Respect to Grip Force”, The transaction of Human Interface Society, Vol. 12, No. 2, pp. 103-111, and https://www.jstage.jst.go.jp/article/his/12/2/12_103/_pdf/-char/ja).

### First Embodiment

### (Configuration of Instrument 1)

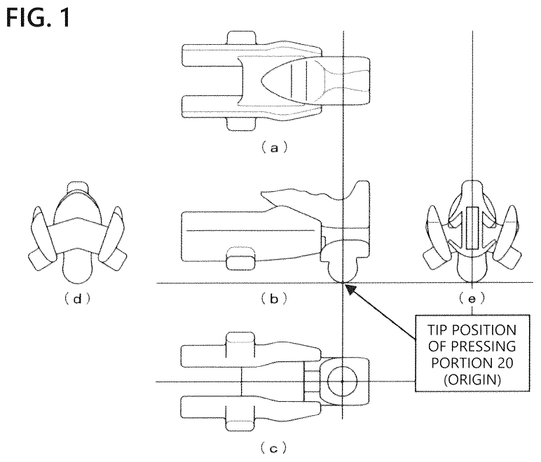

A configuration of the instrument 1 will be described with reference to FIGS. 1 to 4. The instrument 1 according to the embodiment is an instrument for increasing a range of motion of a joint. Specifically, an object of the instrument is to promote muscle stretching while reducing pain on the side on which the muscle extends during the muscle stretching, and increase the range of motion of a joint during motion, thereby making it possible to exercise more smoothly.

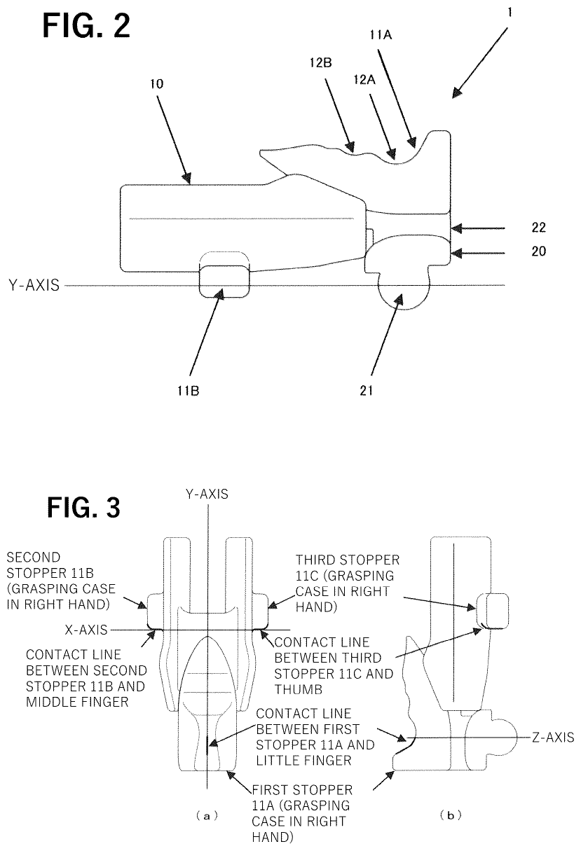

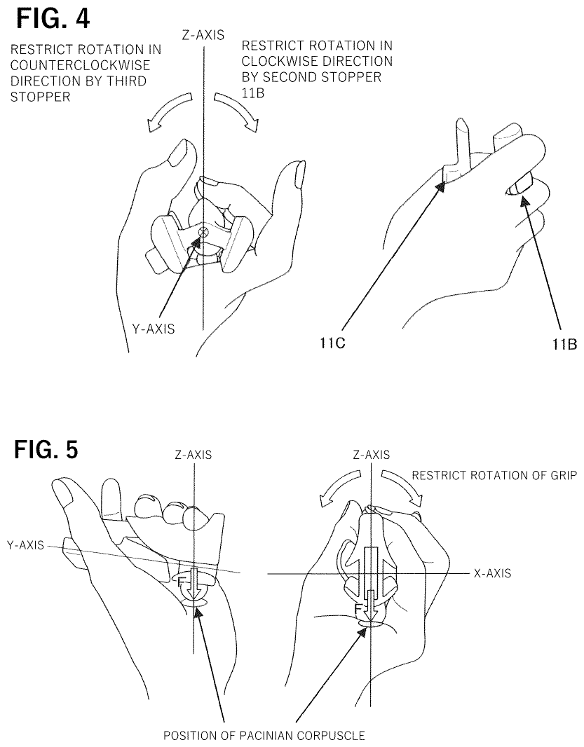

FIG. 1(a) is a plan view of the instrument 1, FIG. 1(b) is a right side view of the instrument 1, FIG. 1(c) is a bottom view of the instrument 1, FIG. 1(d) is a rear view of the instrument 1, and FIG. 1(e) is a front view of the instrument 1. FIG. 2 is an enlarged view of FIG. 1(b). FIG. 3(a) is a plan view of the instrument 1, and FIG. 3(b) is a left side view of the instrument 1. In addition, FIGS. 4 and 5 are views for explaining functions of respective units of the instrument 1.

Note that, in the following description, as illustrated in FIG. 3, a horizontal direction with respect to an imaginary line that is perpendicular to a Y-axis and connects two second stoppers 11B will be described as an X-axis, a longitudinal direction of the instrument 1 will be described as the Y-axis, and a horizontal direction with respect to an imaginary line that is perpendicular to the Y-axis and connects a first recess 12A and a contact portion 21 will be described as a Z-axis.

The instrument 1 is designed so that the contact portion 21 of the instrument 1 hits the position of the Pacinian corpuscle when the instrument 1 is grasped by a grasping method to be described below: The instrument 1 is designed to apply stimulation by pressing the Pacinian corpuscle with a contact surface 21A of the contact portion 21 of the instrument 1 with a gripping force of the little finger and an auxiliary gripping force of a ring finger. Note that the contact portion 21 has a spherical shape so that only the Pacinian corpuscle can be pressed at a pinpoint (it is preferable that it have a shape that does not stimulate (does not touch or hardly touches) portions other than the Pacinian corpuscle).

The instrument 1 includes a main body portion 10 grasped by a user, and the pressing portion 20 that is provided to protrude from the main body portion 10, and presses to stimulate the Pacinian corpuscle present in the palm of the user in a state where the main body portion 10 is grasped by the user. The pressing portion 20 includes the contact portion 21 (Pacinian ball) having the contact surface 21A that contacts the Pacinian corpuscle, and a connecting portion 22 that is separated from the palm of the user in the state where the main body portion 10 is grasped by the user and connects the main body portion 10 and the contact portion 21. Here, the contact portion 21 has a shape (although it has a ball shape in the present embodiment, it is sufficient as long as the Pacinian corpuscle can be pressed at the pinpoint, and other shapes are not excluded) capable of pressing only the Pacinian corpuscle at the pinpoint (it is preferable that it have the shape that does not stimulate (does not touch or hardly touches) portions other than the Pacinian corpuscle).

In addition, the main body portion 10 of the instrument 1 includes a first stopper 11A that is provided to protrude from the main body portion 10, and contacts the little finger of the user in the state where the main body portion 10 is grasped by the user to position the instrument 1 in the palm of the user. The first stopper 11A restricts movement in an upward direction of the Y-axis.

In addition, the main body portion 10 of the instrument 1 includes a second stopper 11B that is provided to protrude from the main body portion 10, positioned between an index finger and the middle finger of the user in the state where the main body portion 10 is grasped by the user, and restricts rotation of the instrument 1 in the palm of the user. The first stopper 11A restricts movement in a downward direction of the Y-axis.

Further, the main body portion 10 of the instrument 1 includes a third stopper 11C that is provided to protrude from the main body portion 10, and contacts a portion near a base of the thumb of the user in the state where the main body portion 10 is grasped by the user to restrict the rotation of the instrument 1 in the palm of the user. As illustrated in FIG. 3, the first stopper 11A restricts the movement in the downward direction of the Y-axis.

As described above, the movement of the instrument 1 in the downward direction of the Y-axis is restricted by the first to third stoppers 11A to 11C, and the position of the instrument 1 in the palm does not move in the Y-axis direction at a gripping position. In addition, when the instrument 1 rotates in the palm, the contact portion 21 is displaced from the position of the Pacinian corpuscle. In order to press the Pacinian corpuscle with the contact portion 21 by a force of the little finger, the instrument 1 should not rotate in the palm. Therefore, as illustrated in FIG. 4, since the second stopper 11B restricts rotation in a clockwise direction, and the third stopper 11C restricts rotation in a counterclockwise direction, the rotation of the instrument 1 grasped by the palm is restricted, and a pressing force of the little finger is reliably transmitted to the Pacinian corpuscle via the instrument 1. As described above, the instrument 1 is designed so that the instrument 1 comes to an intended position of the palm (a position where the contact portion 21 (Pacinian ball) of the pressing portion 20 contacts the Pacinian corpuscle) at three points of the first stopper 11A as a starting point, the second stopper 11B, and the third stopper 11C.

In addition, the main body portion of the instrument 1 has the first recess 12A for positioning the little finger of the user at a position substantially opposite to a position where the pressing portion 20 is provided. In addition, the main body portion 1 of the instrument 1 has a second recess 12B for positioning the ring finger of the user adjacent to the first recess 12A. The instrument 1 of the embodiment is configured such that by grasping the main body portion 10 with the little finger of the user positioned in the first recess 12A and the ring finger of the user positioned in the second recess 12B of the main body portion 10, the Pacinian corpuscle is pressed by the pressing portion 20 with an appropriate force as illustrated in FIG. 5.

Note that in the instrument 1 of the embodiment, the pressing portion 20 has a spherical shape. This is because when the Pacinian corpuscle is pressed and stimulated, if stimulation is applied to other sensory receptors and the like around the Pacinian corpuscle, they become disturbance, and sensitivity of pressure stimulation to the Pacinian corpuscle is reduced. By making the contact portion 21 (Pacinian ball) of the pressing portion 20 spherical, the pressure stimulation can be concentrated only on the Pacinian corpuscle, so that a space of a predetermined range is formed around the contact portion 21 of the ball-shaped pressing portion 20 that applies pressure, and effects of the present invention are increased. Note that since an appropriate pressure can be applied to the Pacinian corpuscle by the contact portion 21 (Pacinian ball) of the pressing portion 20 included in the instrument 1 sinking into the palm by about 1 mm to 15 mm (preferably 3 mm to 10 mm), it is preferred that, as illustrated in FIG. 5, a space is formed around the contact portion 21 (Pacinian ball) so as not to apply stimulation to a sensory receptor other than the Pacinian corpuscle in a state where the contact portion 21 (Pacinian ball) of the pressing portion 20 included in the instrument 1 sinks into the palm by about 1 mm to 15 mm. In addition, it is sufficient that the space of the predetermined range is formed around the contact portion 21 of the pressing portion 20 and the pressure stimulation can be concentrated only on the Pacinian corpuscle, and the contact portion 21 of the pressing portion 20 does not necessarily have a spherical shape.

As described above, it is preferable to press the Pacinian corpuscle of the palm in a pinpoint manner. This point will be described in more detail. There is an ulnar nerve in the palm. Then, it is understood that other mechanoreceptors are present on the ulnar nerve in addition to the Pacinian corpuscle. In this situation, when the instrument according to the present invention is used, the instrument is preferably designed so that a pressure applied to the Pacinian corpuscle of the palm is greater than a pressure applied to the other mechanoreceptors of the palm. From another point of view; it is preferred that a space is formed around the contact portion when the instrument of the present invention is used. In other words, a region (non-contact region) where the instrument does not contact the palm is preferably formed outside a region (contact region) where the contact portion is in contact with the palm so as to surround the contact region.

As described above, the pressing portion 20 preferably press the Pacinian corpuscle of the palm in a pinpoint manner. It is preferred that the pressing portion 20 can be directed toward the Pacinian corpuscle of the palm when used and the contact portion 21 has a curved surface bulging toward the Pacinian corpuscle. The curved surface may be spherical or aspherical. In addition, degree of bulging is appropriately determined. For example, when the Pacinian corpuscle is strongly stimulated, the degree of bulging is increased, and when the Pacinian corpuscle is weakly stimulated, the degree of bulging is reduced (brought close to a plane). Further, the pressing portion 20 may be formed of a column. When the pressing portion 20 is formed of a column, a bottom surface of the column serves as the contact portion 21, and the contact portion 21 has a planar shape. The plane faces and contacts the Pacinian corpuscle. Further, the pressing portion 20 may be formed of a plurality of columns having different radii and concentrically arranged. The pressing portion 20 may have any shape as long as it can be directed to the Pacinian corpuscle of the palm and can concentrate pressure on the Pacinian corpuscle when used.

### (Method of Grasping Instrument 1)

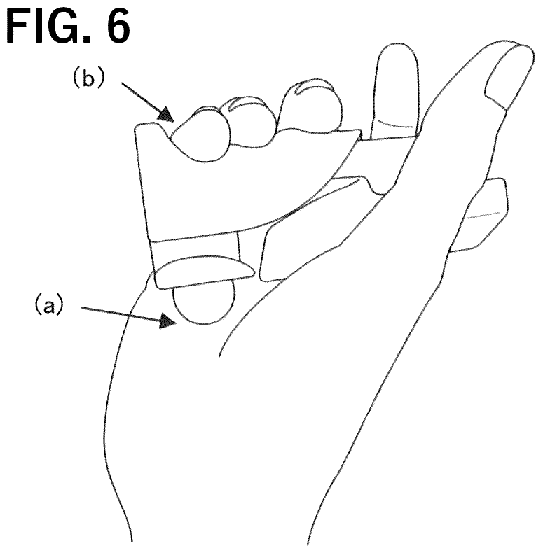

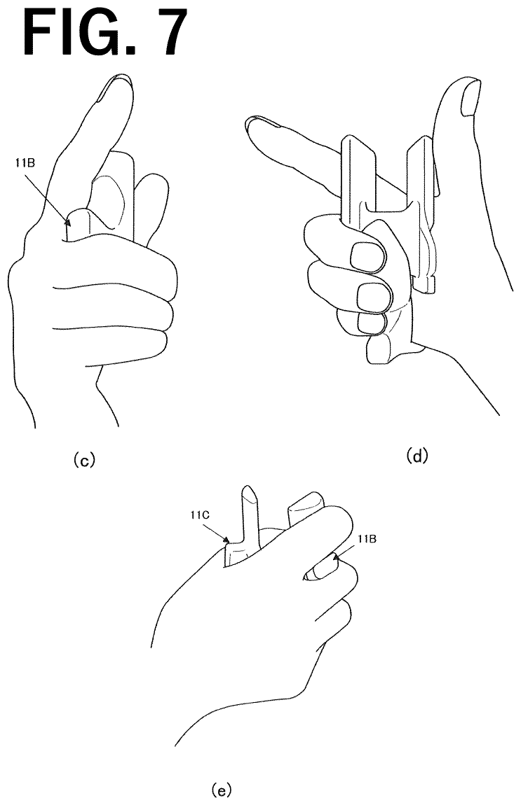

A method of using the instrument 1 (The grasping method) will be described with reference to FIGS. 6 and 7.
(1) The contact surface 21A of the contact portion 21 (Pacinian ball) of the instrument 1 is aligned with the position of the Pacinian corpuscle (see FIG. 6(a)).
(2) The little finger is brought into contact with the first stopper 11A, and the main body portion 10 of the instrument 1 is grasped by placing the little finger in the first recess 12A and placing the ring finger in the second recess 12B (see FIG. 6(b)).

Since the fingers and the hand conform to a shape of a grasped body, a position of a little finger stopper can be grasped even if the contact portion 21 (Pacinian ball) is aligned with the position of the Pacinian corpuscle.
(3) The middle finger is brought into contact with the second stopper 11B to grasp the main body portion 10 of the instrument 1 (see FIG. 7(a)).
(4) The portion near the base of the thumb (a webbed portion) is brought into contact with the third stopper 11C to grasp the main body portion 10 of the instrument 1 (see FIG. 7(b)).
(5) The position of the instrument 1 is properly determined in the palm by the first to third stoppers 11A to 11C. In other words, the contact surface 21A of the contact portion 21 of the instrument 1 is aligned with the Pacinian corpuscle (see FIG. 7(c)).

Note that as illustrated in FIG. 3(a), the instrument 1 is configured to be bilaterally symmetrical about the Y-axis in plan view, but does not necessarily have to be configured to bilaterally symmetrical about the Y-axis in plan view.

As described above, the instrument 1 according to the embodiment is an instrument for increasing the range of motion of a joint. The instrument 1 includes the main body portion 10 grasped by the user, and the pressing portion 20 that is provided to protrude from the main body portion 10, and presses to stimulate the Pacinian corpuscle present in the palm of the user in the state where the main body portion 10 is grasped by the user. Therefore, stretching can be performed in a state where the Pacinian corpuscle is stimulated, and the range of motion of a joint can be more effectively increased.

The pressing portion 20 of the instrument 1 according to the present embodiment includes the contact portion 21 having the contact surface that contacts the Pacinian corpuscle, and the connecting portion 22 that is separated from the palm of the user in the state where the main body portion 10 is grasped by the user and connects the main body portion 10 and the contact portion. Therefore, it is possible to press and stimulate only the Pacinian corpuscle, and to increase the range of motion of a joint by causing muscle relaxation more effectively.

The main body portion 10 of the instrument 1 according to the present embodiment includes the first recess 12A for positioning the little finger of the user at the position substantially opposite to the position where the pressing portion 20 is provided, and is configured such that the Pacinian corpuscle is pressed by the pressing portion 20 by grasping the main body portion 10 in a state where the little finger of the user is positioned in the first recess 12A of the main body portion 10. In this way, since the instrument 1 can be positioned in the palm of the user, the Pacinian corpuscle can be reliably pressed and stimulated.

The main body portion 10 of the instrument 1 according to the present embodiment includes the second recess 12B for positioning the ring finger of the user adjacent to the first recess 12A, and is configured such that the Pacinian corpuscle is pressed by the pressing portion 20 by grasping the main body portion 10 in a state where the ring finger of the user is positioned in the second recess 12B of the main body portion 10. In this way, since the instrument 1 can be positioned in the palm of the user, the Pacinian corpuscle can be reliably pressed and stimulated.

The main body portion 10 of the instrument 1 according to the present embodiment includes the first stopper 11A that is provided to protrude from the main body portion 10, and contacts the little finger of the user in the state where the main body portion 10 is grasped by the user to position the instrument in the palm of the user. In this way, since the instrument 1 can be positioned in the palm of the user, the Pacinian corpuscle can be reliably pressed and stimulated.

The main body portion 10 of the instrument 1 according to the present embodiment includes the second stopper 11B that is provided to protrude from the main body portion 10, positioned between the index finger and the middle finger of the user in the state where the main body portion 10 is grasped by the user, and restricts the rotation of the instrument 1 in the palm of the user. In this way, since the instrument 1 can be positioned in the palm of the user, the Pacinian corpuscle can be reliably pressed and stimulated.

The main body portion 10 of the instrument 1 according to the present embodiment includes the third stopper 11C that is provided to protrude from the main body portion 10, and contacts the portion near the base of the thumb of the user in the state where the main body portion 10 is grasped by the user to restrict the rotation of the instrument in the palm of the user. In this way, since the instrument 1 can be positioned in the palm of the user, the Pacinian corpuscle can be reliably pressed and stimulated.

### Modification Example of Embodiment

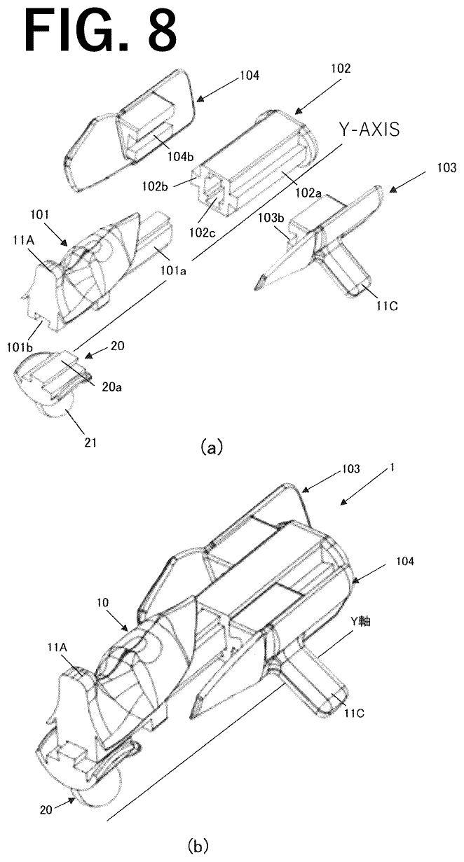

FIG. 8 is a view illustrating a configuration of the instrument 1 according to a modification example of the embodiment. FIG. 8(a) is a view in which the instrument 1 according to the modification example of the embodiment is exploded, and FIG. 8(b) is a view in which the instrument 1 according to the modification example of the embodiment is assembled. In the above embodiment, positions of the pressing portion 20 and the first to third stoppers 11A to 11C of the instrument 1 are fixed to the main body portion 10, but the instrument 1 according to the modification example of the embodiment is configured such that the pressing portion 20 and the first to third stoppers 11A to 11C can be separated from the main body portion 10.

As illustrated in FIG. 8(a), in the instrument 1 according to the modification example of the embodiment, the main body portion 10 is configured to be separable into a first main body portion 101, a second main body portion 102, a third main body portion 103, and a fourth main body portion 104. The first main body portion 101 is provided with a recess 101b with a longitudinal direction parallel to the Y-axis, and the pressing portion 20 is provided with a protrusion 20a slidably engaged with the recess 101b. Then, the protrusion 20a of the pressing portion 20 is slidably engaged with the recess 101b of the first main body portion 101, so that a position of the contact portion 21 (Pacinian ball) of the pressing portion 20 can be adjusted in parallel to the Y-axis.

In addition, the first main body portion 101 is provided with a protrusion 101a with a longitudinal direction parallel to the Y-axis, and the second main body portion 102 is provided with a recess 102c slidably engaged with the protrusion 101a of the first main body portion 101. Then, the protrusion 101a of the first main body portion 101 is slidably engaged with the recess 102c of the second main body portion 102, so that a position of the first stopper 11A (little finger stopper) can be adjusted parallel to the Y-axis (note that the position of the contact portion 21 (Pacinian ball) is also adjusted by adjusting the position of the first stopper 11A (little finger stopper)).

In addition, the second main body portion 102 is provided with a protrusion 102a with a longitudinal direction parallel to the Y-axis, and the third main body portion 103 is provided with a recess 103b slidably engaged with the protrusion 102a of the second main body portion 102. Then, the recess 103b of the third main body portion 103 is slidably engaged with the protrusion 102a of the second main body portion 102, so that a position of the third stopper 11C (a thumb stopper) can be adjusted in parallel with the Y-axis.

In addition, the second main body portion 102 is provided with the protrusion 102b with a longitudinal direction parallel to the Y-axis, and the fourth main body portion 104 is provided with a recess 104b slidably engaged with the protrusion 102b of the second main body portion 102. Then, the recess 104b of the fourth main body portion 104 is slidably engaged with the protrusion 102b of the second main body portion 102, so that a position of the second stopper 11B (a middle finger stopper) can be adjusted in parallel with the Y-axis.

With such a configuration, it is possible to adjust the positions of the contact portion 21 (Pacinian ball) of the pressing portion 20 and the first to third stoppers 11A to 11C according to differences in size and shape of the hand of each user, and by grasping the instrument with one hand, the contact portion 21 (Pacinian ball) of the pressing portion 20 can accurately hit the Pacinian corpuscle and apply an appropriate pressure to the Pacinian corpuscle.

Note that the instrument 1 according to the modification example of the embodiment illustrated in FIG. 8 is equivalent to the instrument 1 according to the embodiment described with reference to FIGS. 1 to 7 in terms of functions and configurations other than that the positions of the contact portion 21 (Pacinian ball) of the pressing portion 20 and the first to third stoppers 11A to 11C can be adjusted according to the differences in size and shape of the hand of each user. Therefore, redundant description of the functions and the grasping method of the instrument 1 according to the modification example of the embodiment illustrated in FIG. 8 will be omitted (see FIGS. 4 to 7 and corresponding descriptions for the functions and the grasping method).

In addition, as will be described below in Example, the effects of the present invention are exhibited as long as the stimulation can be applied to the Pacinian corpuscle by pressing or the like. Therefore, the instrument 1 according to the embodiment described with reference to FIGS. 1 to 6 does not necessarily have a shape to be gripped with one hand, and may be, for example, a clip-shaped instrument provided with a pressing portion that contacts the Pacinian corpuscle so as to sandwich the palm and apply stimulation to the Pacinian corpuscle by pressing. In addition, a pressing portion having a contact surface in contact with the Pacinian corpuscle may be provided inside a glove. Further, as a shape of the instrument, for example, a shape to be grasped with both hands (also including a stick-like or handle-like shape, a shape of a game controller, and the like) can also be considered. In this case, it is conceivable that one instrument includes two pressing portions 20 corresponding to the left and right hands.

### [Application]

Since the instrument according to the present invention promotes the muscle stretching, it is effective for various applications involving the muscle stretching. For example, specific applications can include instruments for improving motion function (for example, for muscle stretching training (for example, stretching, yoga, and muscle training), for athletics (for example, sprint, marathon, and long jump), for ball game (for example, baseball and golf), for ice sports (for example, figure skating and jumping)), and for rehabilitation (for example, low back pain, frozen shoulder, and stiff shoulder). Here, for example, in the case of golf, when a glove provided with a Pacinian corpuscle pressing portion inside the glove is used, making a correct form or an effect of further raising an arm can be expected. In addition, in the case of figure skating, a further increase in the number of rotations is expected when rotation is performed while the Pacinian of the palm of the hand is pressed during practice (including practice on the day of the game, practice immediately before actual performance on the day of the game, and the like, in addition to practice until the day of the game). The present invention can further improve performance for athletes, and can improve muscle flexibility without pain for ordinary people. Note that in order to further achieve the effects of the present invention, it is preferable to continuously press the Pacinian corpuscle for a predetermined time (for example, about 5 minutes).

In addition, it has been confirmed that in a case where the instrument according to the present invention is used, the effect lasts for a while (for example, about 5 minutes) after use, and even after the use of the instrument is stopped, the same degree of flexibility as that during use is exhibited. Further, it has also been confirmed that even in a case where the instrument is not used for a long period of time (about several weeks) after the use of the instrument is stopped, and then the instrument is used after a long time, the same degree of flexibility as before the use of the instrument is stopped is exhibited.

As described above, the instrument according to the present invention causes muscle relaxation. Hence, the instrument according to the present invention can be used in, for example, the field of mental care, in addition to exercise and rehabilitation. Examples of using muscle relaxation can include “progressive muscle relaxation” developed by Edmund Jacobson. This “progressive muscle relaxation” is known as a method of guiding the body to relaxation by repeatedly causing tension and relaxation of muscles. In the following internet site, “progressive muscle relaxation” is introduced as one of relaxation methods for mental care. https://www.mext.go.jp/a_menu/shotou/clarinet/002/003/010/004.htm

In addition, in order to improve depressive symptoms, social phobia, insomnia, or the like, the tension may be alleviated by administration of a drug. For example, paragraph 0042 of Japanese Patent No. 6739846 B2 describes that “a patient diagnosed with depression (30s, female) suffers from social phobia and insomnia together with depressive symptoms and has been receiving intramuscular injection of Abilify (indications, depression) prescribed by a doctor in a psychiatric department and taking Lexotan tablets 2 (indications, anxiety/tension due to depression) and Brotizolam tablets (indications, insomnia)”. The instrument according to the present invention makes it possible to relieve tension without depending on drugs, and there is no need to worry about side effects due to drugs. Further, even in a case where symptoms of a developmental disorder (autism spectrum disorder, attention-deficit hyperactivity disorder (ADHD), learning disorder (learning disorder), tic disorder, stuttering, or the like) are observed, relaxation can be guided by causing muscle relaxation, and alleviation of the symptoms can be expected.

In addition, the Pacinian corpuscle is a sensory receptor that detects the pressure or vibration. Therefore, by vibrating the instrument, vibration associated with music, sound, or the like can also be transmitted as stimulation to the Pacinian corpuscle. Further, it is possible to input stimulation of a factor such as tempo, rhythm, a tune (melody), and strength of music to the body via the Pacinian corpuscle and transmit the stimulation to the brain. As a result, the brain can simultaneously perceive auditory information from the ears and body sensory information from the Pacinian corpuscle. Further, it is possible to fuse hearing and touch to create a situation as if a human is given a sensation other than the five senses (visual sense, auditory sense, olfactory sense, taste sense, tactile sense).

In addition, the Pacinian corpuscle receives vibration at 100 to 400 Hz and is most sensitive to vibration around 200 Hz. Further, the Pacinian corpuscle can be effectively stimulated by using a music sound using a scale of a specific frequency or the like. Examples of the music sound include music composed of only a scale of around 400 Hz from a scale (scale frequency) of around 100 Hz, music in which a relatively large number of these scales (for example, half or more of the scale number, time, or the like) are used, or the like. In addition, it is also possible to newly compose music, sound effects, or the like or to arrange (including modulate) existing music or the like to have contents suitable for such stimulation to the Pacinian corpuscle. Note that the term “vibration” in the present invention is a term having a meaning including various modes of vibration such as a mode in which a plurality of frequencies are combined, a mode in which a vibration applying unit changes a pressing force, a mode in which pressing is performed at uneven time intervals or displacement amounts, a mode of vibration at lower than 1 Hz, a mode in which pressing is performed while vibration is applied, and a mode by a combination thereof, in addition to a mode having a single frequency.

### EXAMPLES

### (Purpose of the Present Example)

In the present example, test was performed on the following 8 males and females (hereinafter referred to as a subject) of different ages by the following method using a grip (the instrument 1 described with reference to FIGS. 1 to 5).

### (Subject)

Randomly selected males and females in their twenties to seventies (total 8 people) were measured.
1 female in her twenties
2 males and 1 female in their thirties
1 male and 2 females in their forties
1 female in her seventies

Attributes of the subject measured this time are shown in Table 1 below.

TABLE 1

| Subject | Attribute | |
|---|---|---|
| number | Ages | Gender |
| 1 | 29 | Female |
| 2 | 34 | Female |
| 3 | 36 | Male |
| 4 | 39 | Male |
| 5 | 41 | Male |
| 6 | 41 | Female |
| 7 | 42 | Female |
| 8 | 70 | Female |

### (Measurement Method 1)

The subject was asked to perform three types of measurement motions (three types of lateral bending, leg raising, and waist twisting) under three types of states, that is, an empty hand state (a state where nothing is grasped), a stick grasping state (a state where a stick is grasped), and a grip grasping state (a state where the grip is grasped), and the subject was asked about muscle pain and stretching during the muscle stretching. As a result, for all the three types of measurement motions (three types of lateral bending, leg raising, and waist twisting), it was confirmed that the pain and stretching of the muscle during the muscle stretching were smaller during grip grasping than during the empty hand or stick grasping for all subjects.

### (Measurement Method 2)

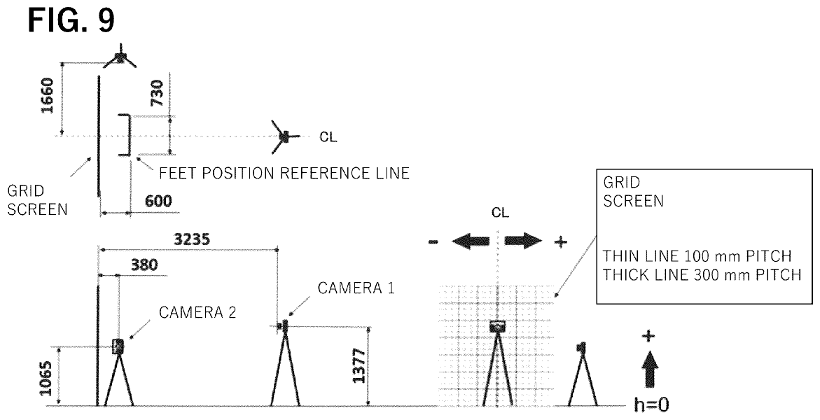

The subject was caused to stand at a predetermined position, the three types of measurement motions (three types of lateral bending, leg raising, and waist twisting) were captured by a video camera (a camera 1 and a camera 2), and angles of the range of motion of a joint were measured under states of the empty hand (the state where nothing is grasped), the stick grasping state (the state where a stick is grasped), and the grip grasping state (the state where the grip is grasped). Note that in the measurement, a mat for fixing a position of a foot of the subject was placed on the floor. Imaging with the video camera was performed on the subject by placing one video camera in front of and one video camera in a side of the subject (see FIG. 9).

Specifically, the subject was measured by the following procedure.

The subject stands in line with a predetermined foot position reference line and performs the three types of measurement motions.

### (Camera 1)

The camera 1 captured the range of motion of a joint in various motions of the subject and used them as data to check increase of the range of motion of the joint.

### (Camera 2)

Various motions were captured from the side of the subject with the camera 2, it was checked from the side whether the positions of the feet of the subject during the motion were correct, and it was checked whether the motion was performed at a correct angle of the body of the subject during each motion.

### (Type of Motion for Effect Measurement)

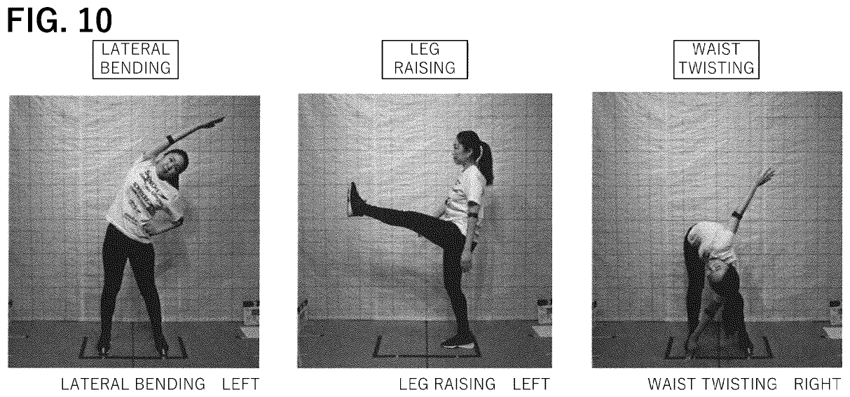

As motions for effect measurement (hereinafter referred to as measurement motions), the three types of lateral bending, leg raising, and waist twisting were respectively performed on left and right sides (see FIG. 10).

### (Positioning of Feet)

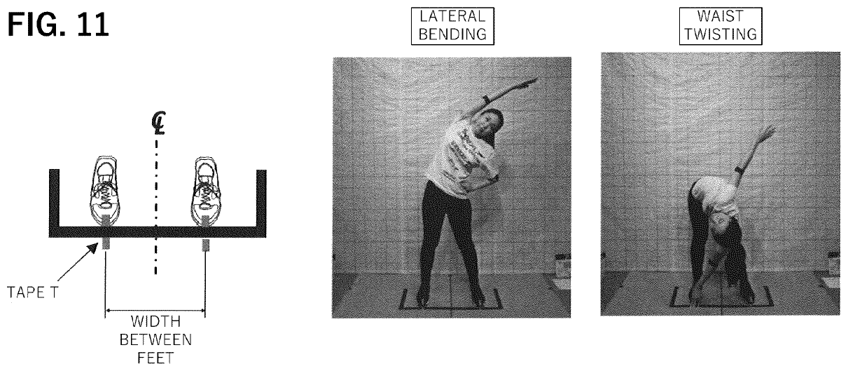

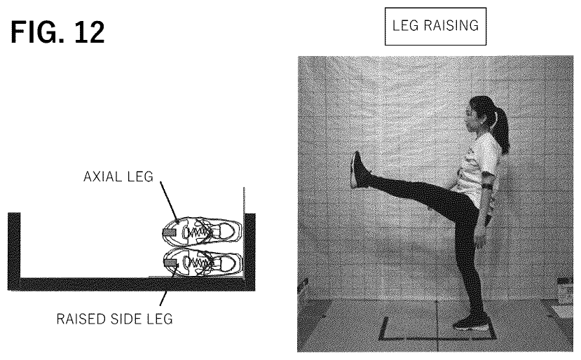

A distance of the subject from the camera 1 was kept constant and positioning for the subject to stand at a right angle to a line of sight of the camera 1 was performed as follows.
(a) Foot positions for lateral bending and waist twisting (see FIG. 11)
The subject was asked to stand with toe tips of shoes aligned with a foot positioning line.
A width between feet was determined by opening legs about a vertical axis center line (CL) with a width of easy motion of each subject.
As illustrated in the figure, tapes T were attached to the tips of the shoes and the floor at positions determined by the subject oneself so that the feet could return to their original positions even if the feet were displaced during the test.
Whether a standing position of the subject during motion measurement was correct was checked by an image of the camera 1, and whether the image can be used for data was determined.
(b) Foot position of leg raising (see FIG. 12)
The subject was asked to stand with a heel portion and a side surface of a shoe of a foot on the side to be raised being along a line L indicated by the foot position reference line.
For a position of a pivot foot of the subject, a foot position on the side to be raised was determined, and then the foot position of the pivot foot was set to touch a shoe on the side to be raised, and so that a position of a heel was set along a frame line indicated by the line L.
The subject checked the foot position each time the subject took a leg raising motion.
Whether the foot position of the subject during motion measurement was correct was checked by an image of the camera 2, and whether the image can be used for the data was determined.

### (Measurement Procedure)

(a) The subjects were gathered one by one at a fixed time.
(b) A purpose of the measurement, a purpose of use of the data, safety management, risk, and the like were sufficiently explained to the subjects.
(c) The position of the Pacinian corpuscle of the subject was detected by a method described below, and marked with a marker (see detection of the position of the Pacinian corpuscle described below).
(d) The subjects were asked to perform warm-up exercise for about 5 minutes before the test to prepare their bodies.
(e) After the warm-up exercise, the subject immediately started the measurement exercise.

### (Detection of Position of Pacinian Corpuscle of Palm)

As described above, the Pacinian corpuscles in the palm are one of mechanical receptors found in skin, and as described with reference to FIG. 1, are in a tip of the middle finger and the palm below the little finger, and are the range of motion of a joint that detects the pressure.

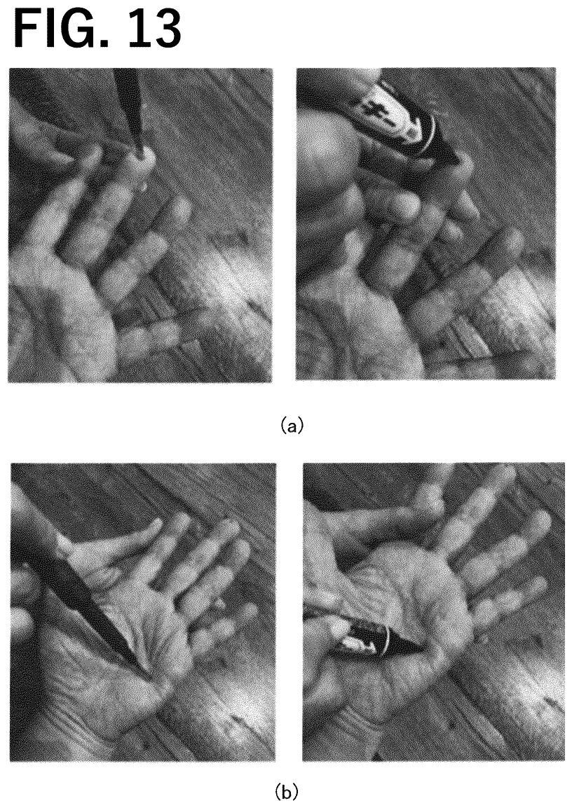

(Detection of Position of Pacinian Corpuscle of Middle Finger: See FIG. 13(a))

Since the Pacinian corpuscle is in the tip of the middle finger, it is easy to detect the position, and it was performed in order to allow the user to feel sensation of throbbing when the Pacinian corpuscle was pressed.
(a) A ventral side of the middle finger was stimulated using a pressure point pressing stick while changing locations, and difference in stimulation when pressed with the pressure point pressing stick was felt.
(b) Subsequently, a central portion of a tip (first joint) on the ventral side of the middle finger was slowly and quickly pressed with the pressure point pressing stick to detect a spot of throbbing pain (but comfortable pressure pain).
(c) Subsequently, the spot of throbbing pain (but comfortable pressure pain) (Pacinian corpuscle pressing portion that we called a Pacinian point) was marked with the marker.
   (Detection of Position of Pacinian Corpuscle of Palm: See FIG. 13(b))

The Pacinian corpuscle in the palm pressed was detected in the measurement of the present example.
(a) The palm was stimulated using a pressure point pressing stick while changing locations, and difference in stimulation when pressed with the pressure point pressing stick was felt.
(b) Subsequently, a central portion of the palm on the little finger side was slowly and quickly pressed with the pressure point pressing stick to detect a spot of throbbing pain (but comfortable pressure pain) similar to that felt with the middle finger.
(c) Subsequently, the spot of throbbing pain (but comfortable pressure pain) (Pacinian corpuscle pressing portion that we called a Pacinian point) was marked with the marker.

Note that the Pacinian corpuscles were in almost the same position on the palm and the tip of the middle finger of all the subjects.

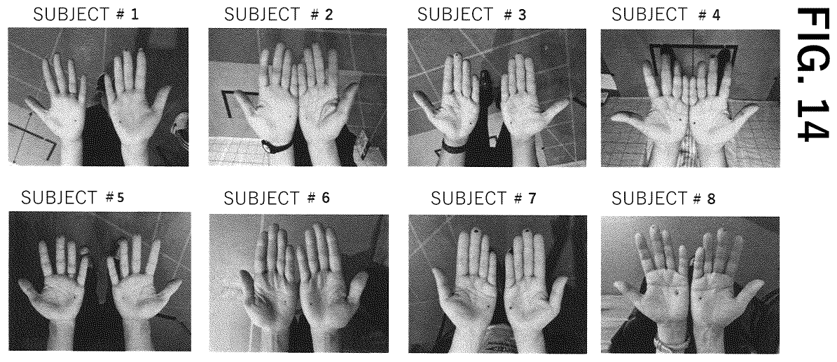

FIG. 14 is an image illustrating the position of the Pacinian corpuscle detected on the palm of each subject. Note that a mark marked with a marker is surrounded by an open circle because it is difficult to see in the image of FIG. 14.

### (Measurement)

(a) At a time when a maximum angle of each motion was reached, the camera 1 and the camera 2 were simultaneously operated with two remote controllers so as not to shake the cameras, and images were taken continuously. About 30 images were taken continuously at one time.
(b) During the empty hand, the stick grasping, and the grip grasping, an experimenter checked whether the subject did not move from the determined position so that a position of the body (particularly, a position of the foot) was not displaced, and also checked whether the grip properly hits the Pacinian corpuscle, so that the grip was grasped at the predetermined position.
(c) Intervals of 3 minutes were provided between the three types of motions, and the subject completed the motions.

Note that it was checked for each motion that the pressing portion 20 of the instrument 1 reliably hits (presses) the position of the Pacinian corpuscle of the palm of the subject.

### (Definition of Origin)

An origin of the body of the subject (an origin for measuring an effect of increasing the range of motion of the joint) was defined as follows.

First, absolute coordinates were defined as follows.
(a) A floor surface was set to zero, and the upward direction was set to plus.
(b) The vertical axis center line CL was set to zero, a right direction was set to plus, and a left direction was set to minus.

### (Grid Origin)

In addition, a position on the vertical axis center line (CL) at a position of 150 cm from the floor surface was defined as a grid origin for use in the measurement.

### (Origin of Body of Subject)

The following origins were defined as origins for measuring the effect of increasing the range of motion of the joint.
origin of leg raising right
origin of leg raising left
origin of lateral bending left and right

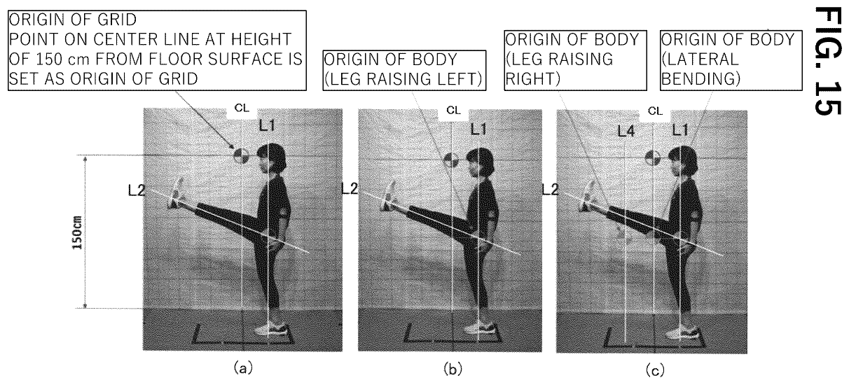

Concept of the origin of the body will be described below.
(a) Draw a center line of the foot of each subject. In addition, a line L1 passing through an approximate center of the body is drawn vertically at a position considered to be a joint of a femur (see FIG. 15(a)).
(b) A position where a line L2 passing through a central portion of the foot intersects the line L1 is defined as the origin of the body of the leg raising left. (see FIG. 15(b)).
(c) A position symmetrical about the vertical axis center line CL as the center line of the origin of the body of the leg raising left is defined as the origin of the body of the leg raising right, and a point intersecting the vertical axis center line CL at a height of the origin of the body of the leg raising right is defined as the origin of the body of lateral bending (see FIG. 15(c)).

Next, a procedure for obtaining measurement results will be described.

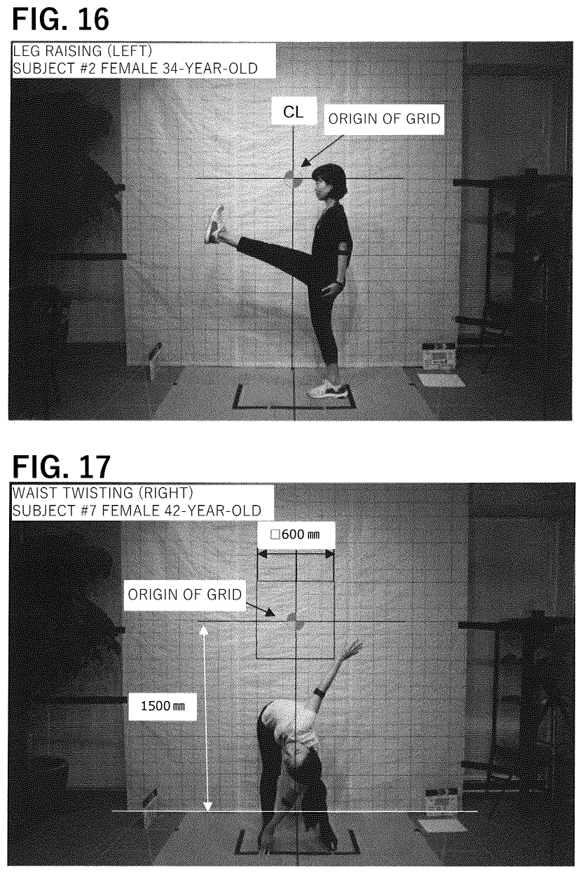

The measurement results of each motion were compared using the origin of the body as a reference (see FIG. 16).
(a) From measurement images taken, an image with a maximum performance of each motion is selected.
(b) Using an illustration function, only the human body is extracted from the image and pasted on Power Point (registered trademark) (hereinafter, referred to as PPT) as image data.
(c) With a function of PPT, the image is pasted on a left and right center of PPT screen in full size in an up-down direction. Thus, all pasted images are pasted on the center of the PPT at the same scale. Hence, a grid origin of any image is at the same position on the PPT screen, so that an accurate comparison can be made.

Dimensional comparison method between the empty hand and the grip grasping (see FIG. 17)
(a) The image pasted on PPT was displayed on a 65 inch high vision liquid crystal monitor, a tracing paper was attached to the screen, the origin was set, and dimensions of measurement points and line copied on the tracing paper were measured using a ruler or a protractor.
(b) The measurement results were converted to actual dimensions at the following magnifications.

On the 65 inch screen, a box with an actual size of 600 mm was measured and found to be 167 mm. From this, measurement magnification of the screen was calculated as 600/167=3.593 times.

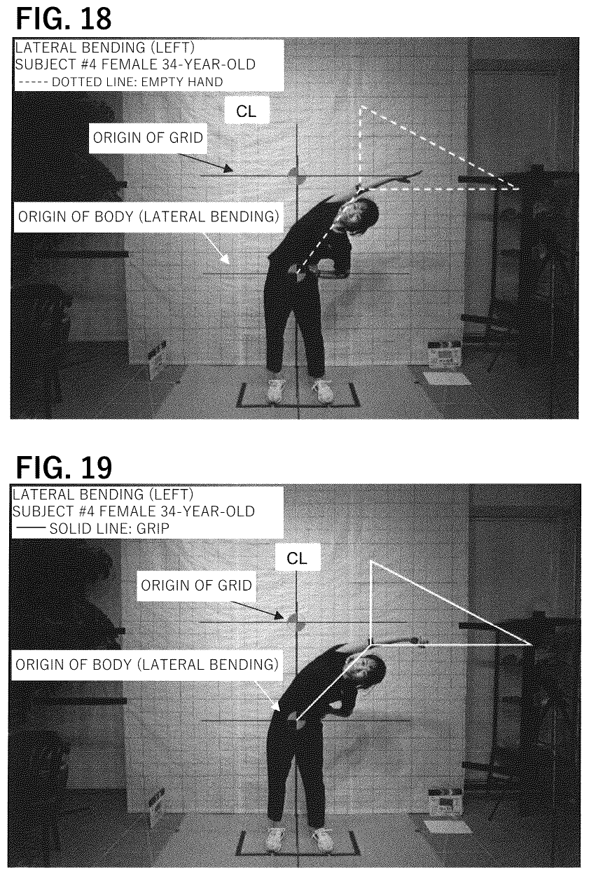

Results of lateral bending (also regarding leg raising and waist twisting, a method of collecting data is basically the same) (see FIG. 18)
(a) The origin of the body described above (the origin of the body of lateral bending in FIG. 18) is specified.
(b) Place a point with a pencil at a central portion of an elbow joint in the image copied on the tracing paper. On PPT of a personal computer, a right angle portion of a white triangle is set as a point in accordance with the point.
(c) Connect a straight line (vertical axis center line) from the origin of the body of lateral bending to the point.
(d) A bending angle of a trunk inclined from the vertical axis center line CL is defined as the range of motion of the joint in lateral bending during the empty hand.
(e) An angle of motion of the joint from the origin during the grip grasping is determined in the same procedure as during the empty hand (see FIG. 19).

### (Comparison Between Empty Hand and Grip Grasping)

(a) An image during the grip grasping is processed by extracting only a human body using the illustration function.
(b) The above extracted image is pasted on an image of the empty hand.

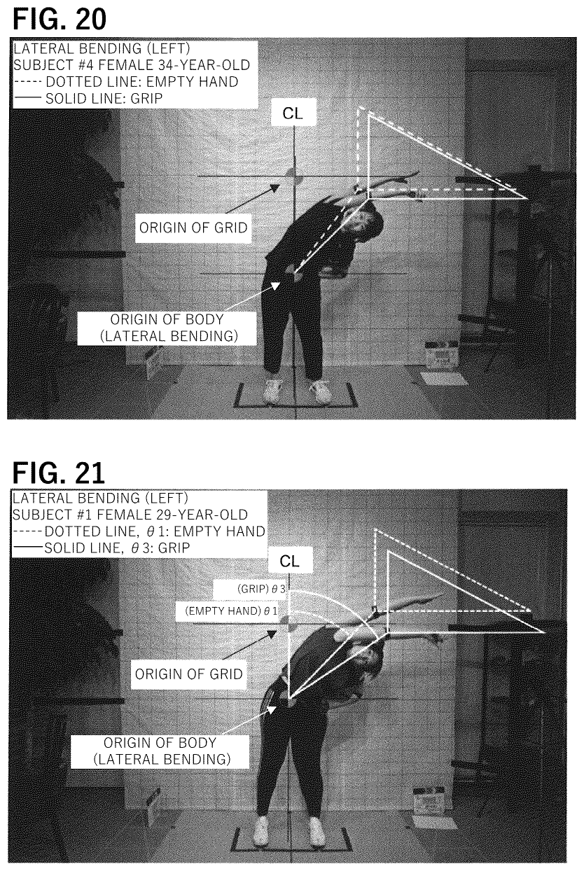

Note that all images of only the human body pasted on PPT are extracted at the same scale and the same origin. Hence, even when the image of the grip grasping is pasted on the image of the empty hand, the origin and the scale are kept accurately, and comparison is accurate (see FIG. 20). Note that comparison between the empty hand and the stick grasping was also made by the same procedure.

### (Comparison Image of Measurement Results)

### (Lateral Bending)

Lateral bending is a motion of bending sides of the body. How to do it is to stand on the floor with the body straight and raise a right arm straight up so as to be parallel to the vertical axis center line, and it is a motion of bending only an upper body to the left or right side without moving a lower body as in a lower image. In the present example, the subject bends the side about the vertical axis center line and a lateral bending origin, a tilt angle (θ1) of the trunk during the empty hand, a tilt angle (θ2) of the trunk during the stick grasping, and a tilt angle (θ3) of the trunk during the grip grasping were measured, and differences therebetween were compared. Note that FIG. 21 shows an image when the tilt angle (θ1) of the trunk during the empty hand (dotted line) and the tilt angle (θ3) of the trunk during the grip grasping (solid line) were measured.

### (Leg Raising)

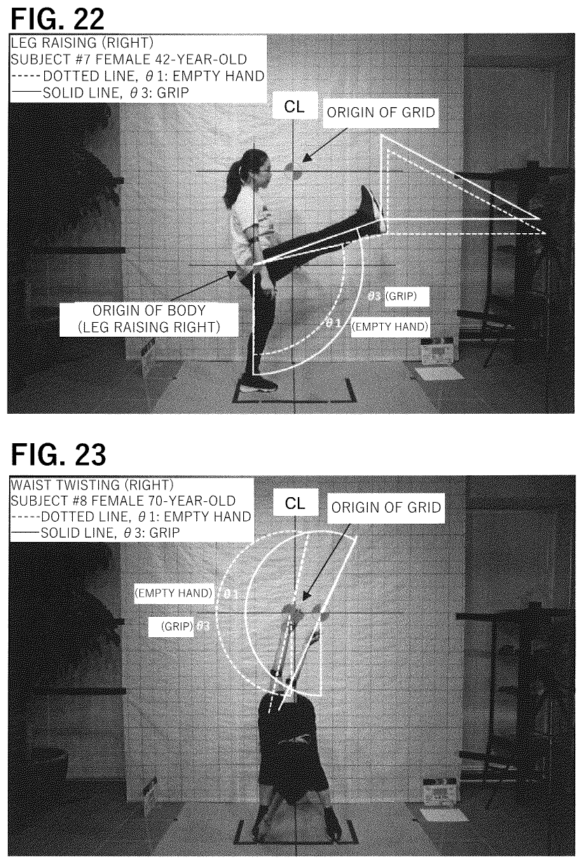

The leg raising is a motion of standing up straight with both feet aligned, and swinging a left foot or a right foot forward as in the image without back action. In the present embodiment, a bending angle (θ1) between an axial leg and a swing leg during the empty hand, a bending angle (θ2) between the axial leg and the swing leg during the stick grasping, and a bending angle (θ3) between the axial leg and the swing leg in the grip grasping were measured from a leg raising origin, and differences therebetween were compared. Note that FIG. 22 shows an image when the bending angle (θ1) between the axial leg and the swing leg during the empty hand (dotted line) and the bending angle (θ3) between the axial leg and the swing leg during the grip grasping (solid line) were measured.

### (Waist Twisting)

The waist twisting is a motion of standing with the body straight, and then bending the body forward to the maximum, keeping the lower body not to move, directing the left hand in a direction of a positioning tape of a shoe of the right foot, stretching the right hand straight down, slowly raising the right hand toward the vertical axis center line at an upper side, and twisting the body only with the upper body. In the present example, centering on an intersection of a vertical line of the vertical axis center line and a line of a twist angle, a twist angle (θ1) during the empty hand, a twist angle (θ2) during the stick grasping, and a twist angle (θ3) during the grip grasping were measured, and differences therebetween were compared. Note that FIG. 23 shows an image when the twist angle (θ1) during the empty hand (dotted line) and the twist angle (θ3) during the grip grasping (solid line) were measured.

### (Comparison Results)

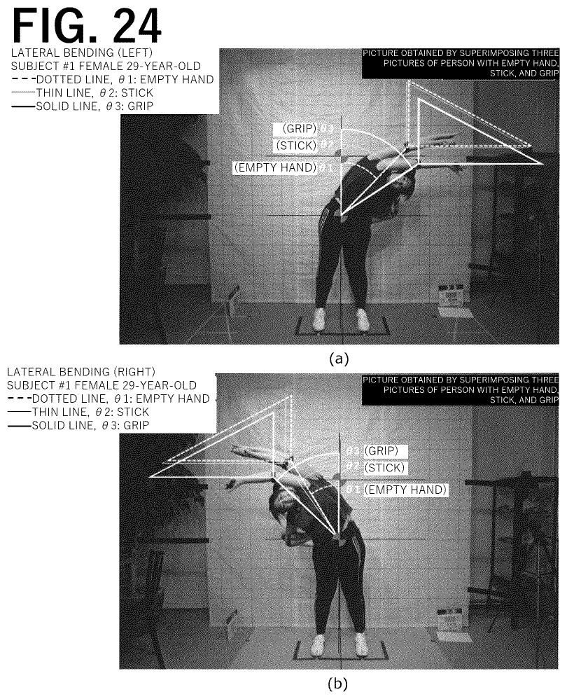

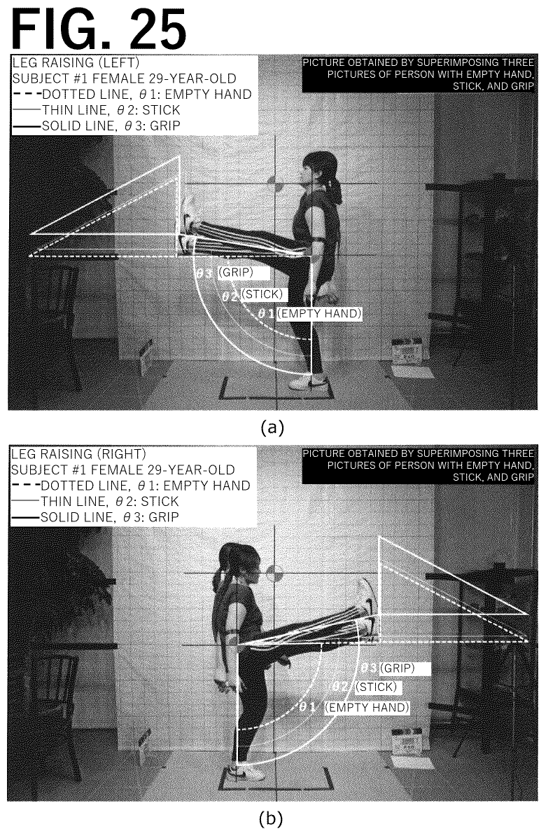

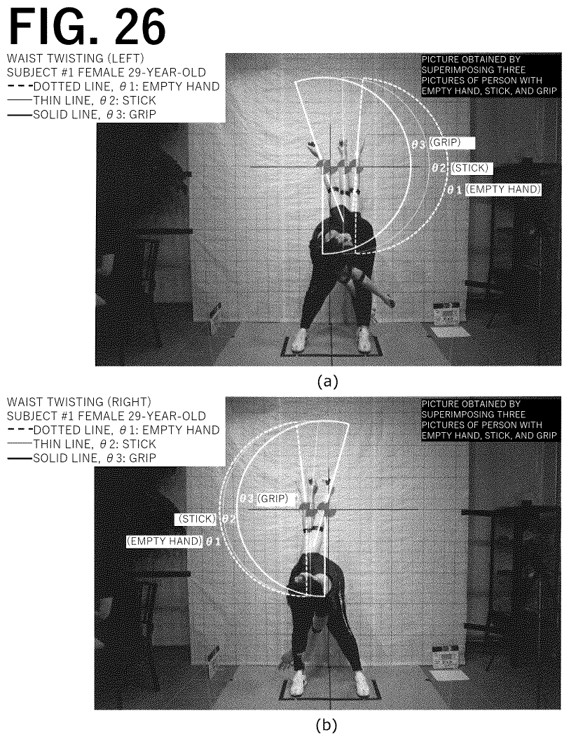

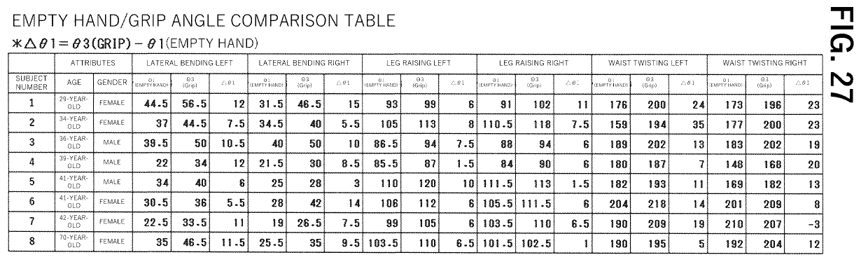

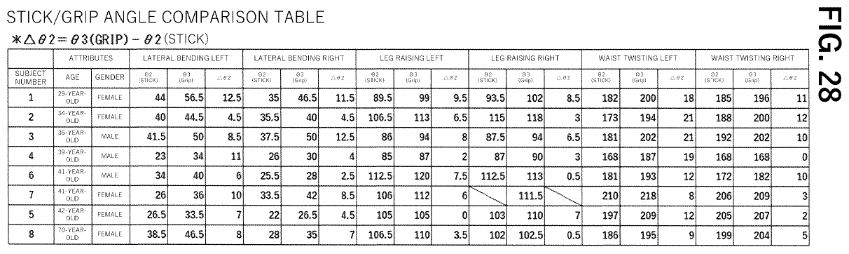

For reference, FIGS. 24 to 26 illustrate measurement images of the lateral bending, the leg raising, and the waist twisting. FIG. 24(a) is an image of lateral bending left, and FIG. 24(b) is an image of lateral bending right. FIG. 25(a) is an image of the leg raising left, and FIG. 25(b) is an image of the leg raising right. FIG. 26(a) is an image of the waist twisting left, and FIG. 26(b) is an image of the waist twisting right. Note that FIGS. 24 to 26 illustrate a measurement image of the empty hand in addition to the measurement image of “stick” and the measurement image of “grip (instrument 1)”.

### (Comparison Between Empty Hand and Instrument (Grip))

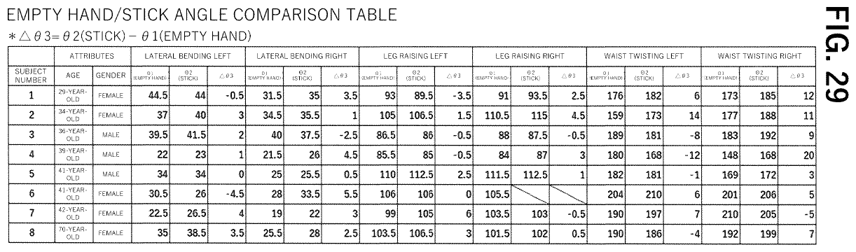

FIG. 27 is a diagram showing measurement results of the angle (θ1) with the “empty hand” and the angle (θ3) during the “grip (instrument 1)” grasping measured as described above and differences (Δθ1) therebetween.

As illustrated in FIG. 27, although there is a difference in degree, in all the subjects 1 to 8, the angle is larger when the grip (instrument 1) is grasped than during the empty hand, and it can be seen that the range of motion of the joint is increased. Although the value of Δθ1 is negative in only the waist twisting right of the subject 7 but the difference is small and does not affect results of this measurement, and it can be said that effects by the grip (instrument 1) of the present invention is obvious.

### (Comparison Between Stick and Instrument (Grip))

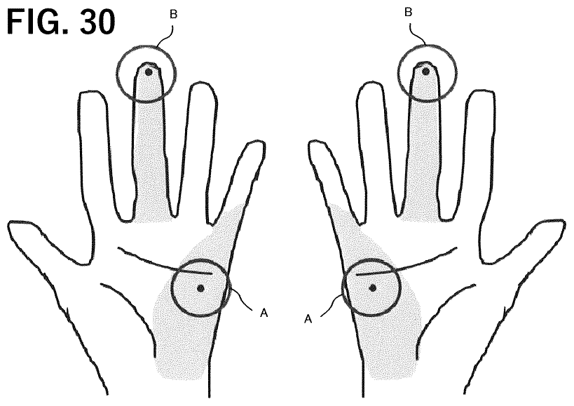

FIG. 28 is a diagram showing measurement results of the angle (θ2) during the “stick” gripping and the angle (θ3) during the “grip (instrument 1)” grasping measured as described above and differences (Δθ2) therebetween.

As illustrated in FIG. 28, although there is a difference in degree, in all the subjects 1 to 8, the angle is larger when the grip (instrument 1) is grasped than when the stick is grasped, and it can be seen that the range of motion of the joint is increased.

In addition, when the stick is grasped, the range of motion of the joint is slightly increased as compared with during the empty hand, but a difference in the effect of increasing the range of motion of the joint from when the grip (instrument 1) is grasped is obvious.

This is considered to be because, when the stick is grasped, it seems that the range of motion of the joint is increased due to muscle strength because the force is easily applied, but as will be described below in “Consideration”, when the pressure is applied to the Pacinian corpuscle by the grip, the range of motion of the joint is increased due to no muscle pain, and thus operational effects are fundamentally different.

Note that the subject 6 was the first person in the test, and could not perform recording well for the leg raising right. For other subjects, since the recording and the measurement have been performed well, and the effects are also remarkable, lack of data of the subject 6 does not affect the results of this measurement, and it can be said that the effects by the grip (instrument 1) of the present invention is obvious.

### (Comparison Between Empty Hand and Stick)

FIG. 29 is a diagram showing measurement results of the angle (θ1) with the “empty hand” and the angle (θ2) during the “stick” grasping measured as described above and differences (Δθ4) therebetween.

As illustrated in FIG. 29, although there is a subject having a larger angle when the stick is grasped as compared with the empty hand, the degree is small, and the difference in the effect of increasing the range of motion of the joint from when the grip (instrument 1) is grasped is obvious.

As described above, this is considered to be because, when the stick is grasped, it seems that the range of motion of the joint is increased due to the muscle strength because the force is easily applied, but as will be described below in “Consideration”, when the pressure is applied to the Pacinian corpuscle by the grip, the range of motion of the joint is increased due to no muscle pain, and thus the operational effects are fundamentally different.

Note that for the leg raising right of the subject 6, since the subject 6 was the first person and the images could not be taken, the measurement could not be performed.

### (Consideration)

As described above, it has been found that by applying stimulation due to an appropriate pressure with a protrusion having an appropriate shape to an accurate position of the Pacinian corpuscle present in the palm, rigidity of muscles of the whole body is eliminated and muscle relaxation occurs. It has also been found that muscle relaxation increases flexibility of the whole body, resulting in an increased range of motion of the joint.

Further, in other measurements (not illustrated) by the inventors and the like, a right-left crossing-over property was observed in muscle relaxing action. For example, when the instrument was grasped with the right hand and used, muscle relaxation remarkably appeared in the muscle on the left side of the body. On the other hand, when the instrument was grasped with the left hand and used, muscle relaxation remarkably appeared in the muscle on the right side of the body.

Regarding lateral bending motion as illustrated in FIGS. 24(a) and 24(b) as an example, in a case of grasping the instrument with the right hand to perform lateral bending toward the left side (refer to FIG. 24(a)), higher flexibility of the body was exhibited than in a case of grasping the instrument with the left hand to perform lateral bending toward the same left side. Conversely, in a case of grasping the instrument with the left hand to perform lateral bending toward the right side (refer to FIG. 24(b)), higher flexibility of the body was exhibited than in a case of grasping the instrument with the right hand to perform lateral bending toward the same right side.

### Second Embodiment Regarding Instrument

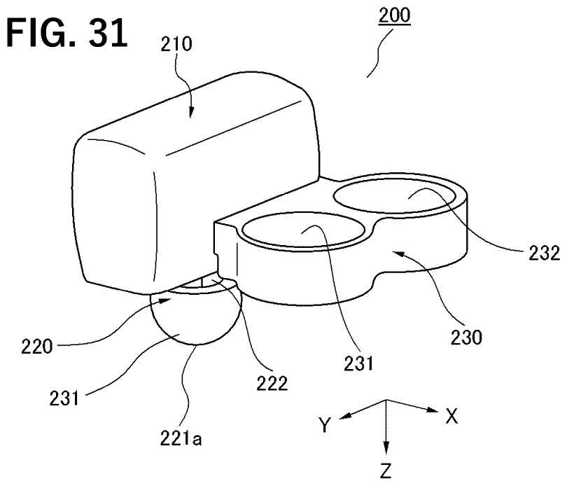

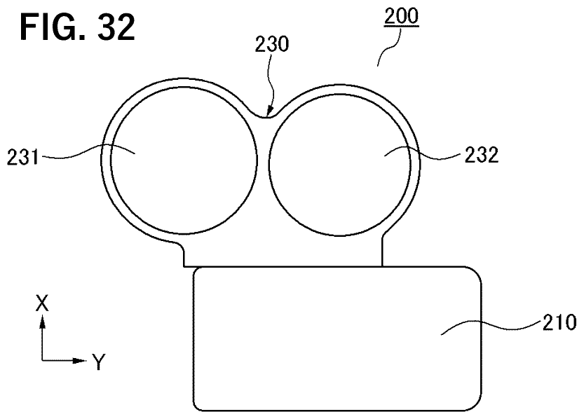

Subsequently, a second embodiment regarding the instrument will be described. FIGS. 31 and 32 illustrate an instrument 200 (grip) of the second embodiment. The instrument 200 of the second embodiment mainly differs from the instrument 1 (illustrated in FIGS. 1 and 8) described above in that the instrument 200 of the second embodiment is a ring model. The term “ring model” as used herein means to have a ring (finger lock portion) which is locked to a user's finger.

### (Configuration of Instrument 200)

A configuration of the instrument 200 according to the second embodiment will be described with reference to FIGS. 31 and 32. Note that description of structures and functions similar to those of the above-described instrument 1 will be omitted as appropriate. Similarly to the instrument 1 described above, the instrument 200 according to the second embodiment applies pressure stimulation to the accurate position of the Pacinian corpuscle to increase the range of motion of the joint.

The instrument 200 includes a main body portion 210 grasped by a user, a pressing portion 220 provided to protrude from the main body portion 210, and a ring portion 230 into which the user inserts the little finger and the ring finger. In FIGS. 31 and 32, the main body portion 210 has a rectangular parallelepiped shape with chamfered corners.

The ring portion 230 is fixed to the main body portion 210. In a case where the ring portion 230 and the main body portion 210 are separately molded, various general fixing methods can be employed for fixing to the ring portion 230 to the main body portion 210. For example, the ring portion 230 may be press-fitted into the main body portion 210, fixed thereto using a general screw (fixing screw), or fixed thereto employing an engaging claw structure.

In the ring portion 230, two rings of a little finger ring 231 for the little finger and a ring finger ring 232 for the ring finger are formed side by side, and the little finger ring 231 and the ring finger ring 232 will be described below. Note that the ring portion 230 can also be integrally molded (synthetic resin molding) with the main body portion 210. In the present embodiment, the main body portion 210, the pressing portion 220, the ring portion 230, and a shaft portion (connecting portion) 222 to be described below are produced by integral molding with a synthetic resin.

The pressing portion 220 has the shaft portion 222 functioning as the connecting portion and is fixed to the main body portion 210 in a state where the shaft portion 222 is inserted into the main body portion 210. Various general fixing methods can be employed to fix the pressing portion 220. For example, the shaft portion 222 may be press-fitted into the main body portion 210, fixed thereto using a general screw (fixing screw), or fixed thereto employing an engaging claw structure. Note that the pressing portion 220 can also be integrally molded (synthetic resin molding) with the main body portion 210.

The shape of the main body portion 210 is not limited to the rectangular parallelepiped shape. As the shape of the main body portion 210, various shapes can be employed in consideration of ease of grasping, improvement in function, and the like. For example, it is conceivable that the main body portion 210 is unevenly formed in consideration of ease of grasping, weight reduction, and the like. Further, it is also conceivable that the shape of the main body portion 210 is an asymmetric shape, a character shape (for example, various alphabet shapes, katakana shapes, hiragana shapes, or the like), or a symbol shape in consideration of designability.

In a state where the main body portion 210 is grasped by a user, the pressing portion 220 presses and stimulates a Pacinian corpuscle present in the palm of the user. The pressing portion 220 includes a contact portion 221 (Pacinian ball). The contact portion 221 has a contact surface 221a that is brought into contact with the Pacinian corpuscle, and is integrated with the shaft portion 222.

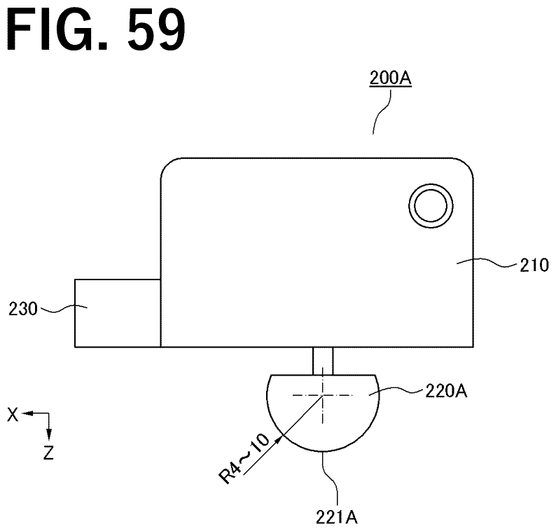

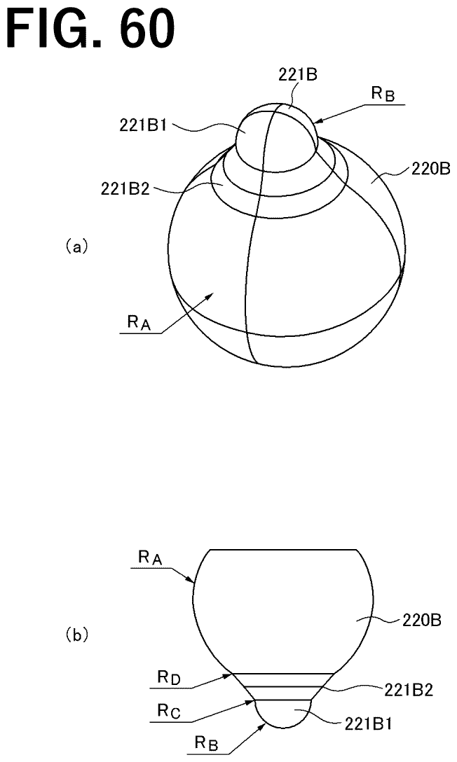

Here, the contact portion 221 has a shape (although it has a ball shape in the present embodiment, it is sufficient that only the Pacinian corpuscle can be pressed at the pinpoint, and other shapes are not excluded) capable of pressing only the Pacinian corpuscle at the pinpoint (it is preferable to have the shape that does not stimulate (does not touch or hardly touch) the portion other than the Pacinian corpuscle). This will be described below as modification examples (FIGS. 59 and 60).

The shaft portion 222 connects the main body portion 210 and the contact portion 221. The shaft portion 222 also has a function of separating the main body portion 210 and the contact portion 221 from the palm of the user in a state where the main body portion 210 is grasped by the user.

Here, in the following description, as illustrated in FIGS. 31 and 32, a direction in which the pressing portion 220 protrudes with respect to the main body portion 210 is defined as a Z-axis direction, a direction in which the ring portion 230 protrudes with respect to the main body portion 210 is defined as an X-axis direction, and a direction orthogonal to the X-axis direction and the Z-axis direction is defined as a Y-axis direction.

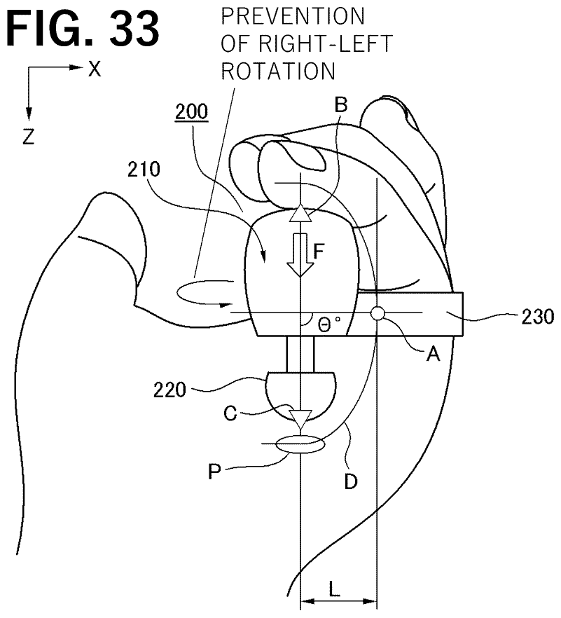

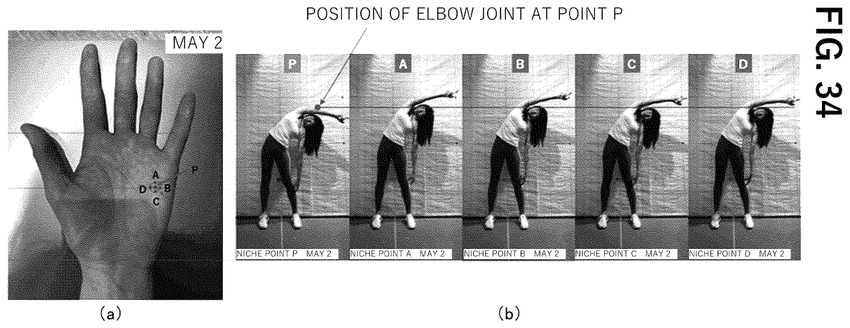

As described above, the ring portion 230 has two rings of the little finger ring 231 and the ring finger ring 232 formed side by side. The user inserts the little finger into the little finger ring 231, inserts the ring finger into the ring finger ring 232, and wraps the main body portion 210 inside the palm with the pressing portion 220 facing the palm (FIG. 33).

Positional relationships of the portions of the instrument 200 are designed such that the contact portion 221 at a tip of the pressing portion 220 reaches the position of the Pacinian corpuscle when the user grasps the instrument 200. The instrument 200 presses the Pacinian corpuscle with the contact surface 221a of the contact portion 221 with a gripping force of the little finger in the little finger ring 231 and an auxiliary gripping force by the ring finger in the ring finger ring 232 to apply stimulation.

Note that the contact portion 221 has a spherical shape so that only the Pacinian corpuscle can be pressed at a pinpoint (it is preferable to have a shape that does not stimulate (does not touch or hardly touch) a portion other than the Pacinian corpuscle). That is, when the instrument 200 is used, similarly to the instrument 1 of the first embodiment, it is preferred that a space is formed around the contact portion 221. In other words, a region (non-contact region) where the instrument 200 is not brought into contact with the palm is preferably formed outside a region (contact region) where the contact portion 221 is brought into contact with the palm such that the non-contact region surrounds the contact region.

A ring-model instrument (here, the instrument 200) may also be described as follows. In an instrument capable of pressing a Pacinian corpuscle, the most difficult problem (alternatively, one of the difficult problems) is to prevent a sphere (Pacinian ball) in the palm from being displaced from an accurate position due to rotation, slippage, or the like.

That is, in developing this type of instrument, it is very important that a sphere accurately hits a Pacinian point (also referred to as a position where a Pacinian corpuscle can be accurately pressed, a “Pacinian position”, or the like) in the palm of the hand gripping the instrument, and thereafter, a position of a Pacinian ball is prevented from being displaced from the accurate position due to a pressing force, movement of fingers, or the like.

In the instrument 1 of the first embodiment illustrated in FIGS. 1 and 8, as illustrated in FIGS. 3 to 7, the second stopper 11B and the third stopper 11C are used such that the position of the grip is fixed at three points of the thumb, the index finger, and the Pacinian ball of the palm, and the palm is pressed by forces of the little finger and the ring finger.

On the other hand, in the instrument 200 according to the second embodiment, the main body portion 210 (grip) in the palm is positioned so that the contact portion 221 is accurately fixed at the position of the Pacinian corpuscle by the three points of the little finger ring 231 attached to the main body portion 210, a pressing portion (a part of the main body portion 210 pressed by the little finger) of the little finger, and the contact portion 221 (Pacinian ball) in the pressing portion 220.

FIG. 33 illustrates a state where the ring-model instrument 200 is grasped with the left hand. However, the instrument 200 illustrated in FIG. 33 is schematically illustrated by illustrating a prototype of the instrument 200 illustrated in FIGS. 31 and 32 so that the positional relationships can be easily illustrated. Therefore, although the shape does not match the shape of the instrument 200 illustrated in FIGS. 31 and 32, the instrument has portions corresponding to the main body portion 210 and the ring portion 230. In FIG. 33, these portions are denoted by reference numerals 210 and 230.

The position of the Pacinian corpuscle of the palm (a point P which is a Pacinian point) is located almost directly below the first joint (fingertip in FIG. 33) of the little finger in a state where the little finger is naturally bent in an arch shape as illustrated in FIG. 33. In the present embodiment, the ring portion (little finger ring 231) of main body portion 210 is provided at a position facing a base (third joint) of a little finger, so that the following functions are realized.

That is, in the instrument 200, the position of the little finger is restricted by the little finger ring 231. Therefore, in the state where the little finger is naturally bent, a distance (a distance L in the X-axis direction) between the position of the third joint of the little finger (a position A on the little finger ring 231 in FIG. 33, represented by circle) and a virtually indicated tip of the pressing portion 220 (a point C represented by a triangle mark or the Pacinian point P represented by an ellipse mark) is maintained constant. Hence, the pressing portion 220 of the main body portion 210 accurately hits the Pacinian point (point P).

In addition, an angle θ(θ°) between the ring portion 230 and the main body portion 210 is fixed, a portion (a point B, represented by a triangle) pressed by the little finger and the pressing portion 220 are arranged on an arc (D) formed by the little finger and the palm, and a pressing force of the little finger accurately acts as a pressure on the Pacinian corpuscle. Further, the point B and the point C and the point P described above are almost accurately arranged on the same straight line.

The pressing force (pressing force, represented by an arrow F) to the Pacinian corpuscle is generated by the little finger and the ring finger (mainly the little finger). When the main body portion 210 whose position is restricted by the ring portion 230 is pressed mainly by the force of the little finger, the pressing portion 220 (the tip is the point C) is sunk in the palm by the force in an axial direction. In addition, a frictional force is generated between the main body portion 210 and the palm by a force of the little finger or the like pressing from almost directly above. Then, the force from almost directly above and the restriction by the ring portion 230 combine to suppress right and left rotation of the instrument 200 (right/left rotation which is displacement around the Z-axis) as illustrated in FIG. 33.

Hence, when the user grips the main body portion 210, the instrument 200 does not escape in any direction under an influence of the pressing force of the little finger and the ring finger and is stably fixed at an accurate position. The pressing force F directly acts on the Pacinian corpuscle. Further, the instrument 200 is supported at three points of the little finger ring 231 (point A), a part pressed by the little finger (point B), and the pressing portion 220 (point C), and thereby the angle θ is maintained between the little finger and the palm, and the instrument is stably fixed at the accurate position. As compared with the instrument 1 of the first embodiment, it is possible to easily press the Pacinian corpuscle accurately.

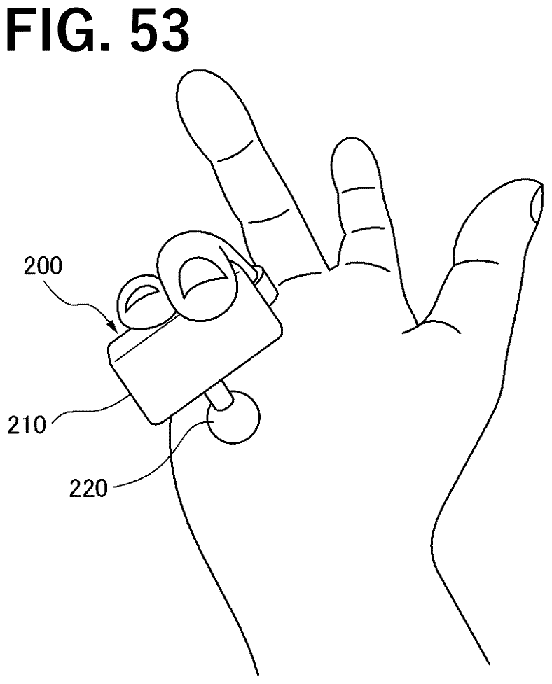

In order to fix the main body portion 210, the little finger may be in contact with the main body portion 210 at the point B of the first joint on the tip side. In addition, except for the point B, it is desirable to define a relationship between the shape or dimension (size) of the main body portion 210 and the little finger so that a gap (gap of reference numeral 882 with reference to FIG. 52) can be secured between the little finger and the main body portion 210. By making the little finger (the part on the base side from the point B) float from the main body portion 210, a space for moving the little finger can be secured, and the force applied from the little finger to the main body portion 210 can be easily adjusted.

### (Effect of Using Instrument 200)

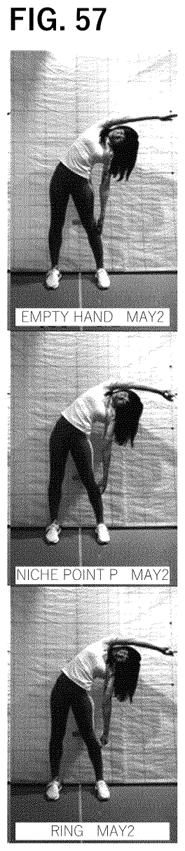

According to the ring-model instrument 200 described above, the range of motion of the joint can be increased to the same extent as the instrument 1 of the first embodiment (illustrated in FIGS. 1 and 8). FIG. 57 illustrates results of an experiment of the effect of increasing the range of motion of the joint by the instrument 200. For comparison, a type without the ring portion (referred to as a “niche model”) as illustrated by changing an orientation in FIGS. 68(a) and 68(b) was used. This type has the basic function of the instrument 1 of the first embodiment illustrated in FIGS. 1 and 8 and includes a main body portion 10 and a pressing portion 20 similarly to the instrument 1.

As a result of an experiment of the effect of increasing the range of motion of the joint by using the niche model illustrated in FIG. 68 and the ring model (instrument 200) illustrated in FIG. 31, it was confirmed that the range of motion of the joint can be increased to the same extent in both models as long as there is no difference in pressing force by the pressing portions (20 and 220) (see FIG. 57). From the upper image to the lower image, FIG. 57 sequentially illustrates photographic images of forms of lateral bending in the case of empty hands (in a state where nothing is grasped), in the case of using the niche model, and in the case of using the ring model.

According to FIG. 57, in the case of empty hands (upper image), the right arm of a subject stops at a position higher than the horizontal. On the other hand, it can be seen that the right arm of the subject reaches a position lower than the horizontal to the same extent in both the case of using the niche model (middle image) and the case of using the ring model (lower image).

As described above, regarding a positional displacement in a rotation direction, by providing the ring portion 230, it is possible to prevent the rotation (right/left rotation) around the Z-axis and to more easily and accurately press the Pacinian corpuscle than the instrument 1 of the first embodiment.

### [Application]

As long as any problem does not arise, the instrument 200 can be used for various applications such as an instrument for improving motion function, athletics, ice sports, or rehabilitation, similarly to the instrument 1 of the first embodiment (illustrated in FIGS. 1 and 8). In addition, the use of the ring-model instrument 200 can be described as follows.

For example, in a case where an athlete or a professional athlete performs a serious exercise, it is considered that it is more suitable to restrict the angle between the thumb and the index finger. In addition, for example, when the hand is opened for some reason while the instrument 1 of the first embodiment is gripped and an exercise is performed, the instrument 1 falls and the instrument is easily damaged. However, in the ring-model instrument 200, since the finger passes through the ring portion 230 and is locked to the ring portion 230, the instrument 200 does not fall even if the palm is opened. That is, even if the hand is opened, the ring model does not simply fall off the palm because there is a ring for the little finger (the little finger ring 231).

In addition, the three fingers of the thumb, the index finger, and the middle finger are not restricted by the ring portion 230 and thus can be freely moved while using the instrument 200. Hence, an impact on the exercise is minimized.

Further, since the ring-model instrument 200 can be held by the little finger, the ring finger, and the palm, and there is no need to extend the main body portion 210 to the thumb and the index finger, the instrument is small and convenient to carry. Since it is convenient to carry the instrument, for example, when an ordinary person performs daily exercise, walking, jogging, mountain walking, or the like, the effect (grip effect) of the instrument 200 causes muscle relaxation of the entire body, and it becomes easy to routinely obtain sensation that the range of motion of the joint increases. Then, as compared with the case of performing such an action without gripping the instrument 200, an effect of raising the feet or the like more comfortably can be obtained, and a feeling that the entire body becomes lighter can be felt more routinely.

Here, in general, there are individual differences in the size or shape of the palm, the shape and length of the finger, and the like, and there are individual differences in the position of the Pacinian point. In addition, regarding a growing child, the size of the hand and the Pacinian point change every year as the child grows. Therefore, the highest effect can be easily exhibited by producing the instrument (personal grip) having a shape or a size suitable for a palm of a person depending on individual differences or an age or a generation.

### [Invention of Locating Method of Pacinian Point]

Next, embodiments according to the invention of a locating method of a Pacinian point will be described. Note that portions similar to those of the instrument 1 according to the first embodiment and the instrument 200 according to the second embodiment are denoted by the same reference numerals, and descriptions thereof will be omitted as appropriate.

### First Embodiment of Invention of Locating Method of Pacinian Point

As described above, there are individual differences in the position of the Pacinian point. Thus, the effect of the instrument 1 or the instrument 200 can be easily exhibited by producing the instrument (personal grip) having a shape or a size suitable for a palm of a person depending on individual differences or an age or a generation.

Further, the Pacinian corpuscle of the palm is a sensory receptor having a size of about 1 mm and located at only one position of the palm. It is known that the range of motion of joint most increases by accurately pressing the position of the Pacinian corpuscle (Pacinian point). Therefore, an object of the first embodiment regarding the invention to be described here (invention of the locating method of a Pacinian point) is to accurately detect a Pacinian point. In the following literature, it is described that a Pacinian corpuscle has a size of about 0.5 mm to 2 mm and a diameter of about 0.7 mm.

Tadasu Oyama et al., “New Edition: Handbook of Sensory and Perceptual Psychology”, 1994 Jan. 20, pp. 1180-1181

### [Comparison Test of Range of Motion of Joint Depending on Position of Pressing Against Pacinian Corpuscle]

First, the inventors detected an accurate Pacinian point (Pacinian position) for a specific subject by using the subject's own sense. The accurate detection of the Pacinian point was performed in the same manner as the detection of the position of the Pacinian corpuscle of the palm (Pacinian point) (FIG. 13(b)) in the first embodiment regarding the instrument 1.

FIG. 34(a) illustrates an image of a palm of a subject taken at that time. On the palm, a mark is marked with a marker (a felt pen, the “marker” described above also refers to a felt pen). A position of the mark at this time is set as a point P.

Subsequently, points separated by predetermined distances (here, 3 mm) vertically and horizontally with the point P as a center were sequentially set as a point A, a point B, a point C, and a point D at every angle of 90 degrees in the clockwise direction. The increase in the range of motion of the joint was measured during lateral bending motion while the instrument (the instrument 1 in this case) was grasped and pressed each point including the point P with almost the same force.

### [Results]

Even when the individual points (points A to D) separated by 3 mm from the point P were pressed, the range of motion of the joint was obviously narrower than the pressing of the point P. In FIG. 34(b), five images represented by symbols “P” and “A” to “D” in the upper part of the drawing (the end portion on the head side of the subject) illustrate forms of lateral bending in a case where the point P and the points A to D are pressed.

A horizontal line is added to these images with a position of the elbow joint of the subject as a reference in the image to which the symbol “P” is attached (the leftmost image in FIG. 34(b)). Comparing the leftmost image of the point P and the images of the points A to D represented by the symbols “A” to “D”, the elbow joint of the subject reaches below the horizontal line, in the case where the point P is pressed.

In the case where the point P is pressed, the elbow joint of the subject reaches a lower position than in the case where the points A to D are pressed. In addition, in the case where the points A to D are pressed, flexibility is exhibited only to the same extent as each other. Hence, it is effective to accurately find (locate) and press the Pacinian point (point P). In addition, in order to accurately press the Pacinian point, it is necessary to enable a user to recognize the located Pacinian point immediately before use of the instrument.

### [Pacinian Point Locating System]

In view of the results and circumstances described above, in the first embodiment according to the invention of the locating method of a Pacinian point, the Pacinian point of the palm is accurately found, and the found Pacinian point can be reproduced by the user before use of the instrument. Hereinafter, the system of the present embodiment (Pacinian point locating system) will be described.

The system (Pacinian point locating system, which may be simply referred to as the “locating system”, hereinafter) of the present embodiment applies stimulation to a Pacinian corpuscle and measures a human body reaction generated at that time. As the human body reaction, various reactions can be employed as long as the reactions are produced in the human body due to the stimulation to the Pacinian corpuscle.

Examples of the human body reactions include an action potential, brain activity, hormone secretion, blood flow, and the like. In the locating system of the present embodiment, the action potential is employed as the human body reaction.

The fact that the action potential is generated when the Pacinian corpuscle is stimulated has been explained and proved by various media. Examples of literature describing the action potential and the measurement of the action potential include the following literature.

Hiroshi IZUMI (2011), ‘“Human” in the eyes of physiology’, The Dental Journal of Health Sciences University of Hokkaido https://core.ac.uk/download/pdf/268116367.pdf

On the right column of p. 11 of this paper (lines 7 to 11), it is described that “the Pacinian corpuscle of the tactile receptor generates a generator potential at the terminal portion according to the intensity of stimulation of pressure or vibration, and when the stimulation increases, the generator potential increases, and an action potential is generated in the sensory nerve and transmitted to the center to be recognized as sensation”.

In addition to that, the literature can be exemplified with the following examples.
Maki, Makoto; Kishigami, Hirotoshi: Yamaguchi, Natsuko; Wada, Tatsuhiko; Ueno, Takeji (1995), “An Attempt to Make a Mini-Surface Electrode of EMG for Evaluation of Fine Movements of the Hand Muscles”, https://eprints.lib.hokudai.ac.jp/dspace/bitstream/2115/37580/1/8_137-142.pdf
Tadashi MASUDA (2015) “Special Issues No. 3 Measurement Technique for Ergonomics, Section 4: Measurements and Analyses of Bioelectric phenomena and Others (1) 1-Surface Electromyography for Human Factors Research” https://www.jstage.jst.go.jp/article/jje/51/6/51_400/_pdf/-char/ja
“3” in “Special Issues No. 3” is a circled number.
Michinori Ichikawa, “Characteristics of voltage sensitive dye as means for observing neural activity” https://www.brainvision.co.jp/ref1-1/
Miyaoka and Mano (1985), “Mechanoreception in the Glabrous Skin of Humans”, Applied Physics, Volume 54, Issue 4, pp. 368 to 372 https://www.jstage.jst.go.jp/article/oubutsu1932/54/4/54_4_368/pdf/-char/ja
Shinya Ueno (Hirosaki University Graduate School) “Basic Mind-Body Science Exercise” http://www.med.hirosaki-u.ac.jp/˜neurophysiol/data/kankakujugyo1.pdf
“Converting electrical signal into chemical signal at a synapse”, https://www.jmedj.co.jp/files/item/books % 20PDF/978-4-7849-3225-2.pdf

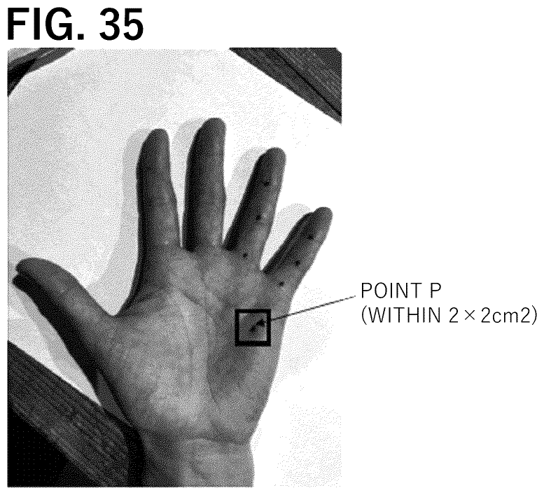

The action potential can be measured using an action potential meter (also referred to as the “action potential measuring device”, the “action potential measuring means”, the “human body reaction meter”, the “human body reaction measuring device”, or the “human body reaction measuring means”). The inventors have conducted research (for example, various types of research such as research in the experiment described with reference to FIG. 14) so far and found that a Pacinian point on a palm of any person is present approximately within 2×2 cm². The region of 2×2 cm² is hereinafter referred to as a “distribution region”. FIG. 35 illustrates that the point P of a certain subject is located almost at the center of the distribution region surrounded by a square frame.

In the Pacinian point locating system of the present embodiment, a stick-shaped body having a thin tip (having a tip diameter of about several mm) is pressed in the distribution region, and the action potential is measured by an action potential meter.

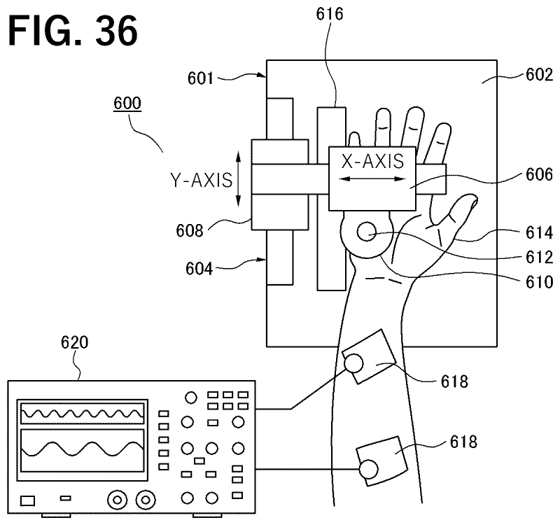

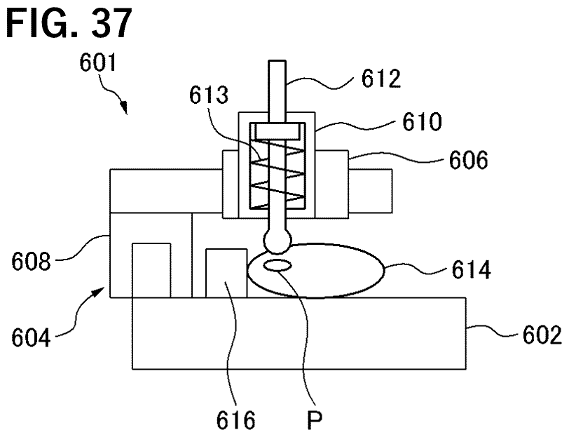

FIGS. 36 and 37 schematically illustrate a configuration of a Pacinian point locating system (locating system) 600 according to the present embodiment. In the locating system 600, a point locating device 601 is used. In the point locating device 601, a linear guide 604 is provided on a surface plate 602 having a flat surface. The linear guide 604 includes an X-axis stage 606 and a Y-axis stage 608, and the X-axis stage 606 and the Y-axis stage 608 can be linearly displaced in directions orthogonal to each other.

As illustrated in FIG. 37, the Y-axis stage 608 has a Z-axis displacement mechanism unit 610, and the Z-axis displacement mechanism unit 610 holds a pressing stick (pressing body) 612. The pressing stick 612 is displaceable in the Z-axis direction via an elastic body (for example, a coil spring, a leaf spring, or the like) 613. Here, the Z-axis direction is a direction orthogonal to a plane formed by the X-axis and the Y-axis (approximate to the flat surface of the surface plate 602). Here, an X-axis, a Y-axis, and a Z-axis according to the locating system of the present embodiment are defined regarding the point locating device 601.

As illustrated in FIG. 36, an arm (right arm in this case) 614 of a subject can be placed on the surface plate 602. A stopper 616 for locking the arm 614 of the subject is provided to protrude upward on the surface plate 602.

Two electrode sheets 618 are pasted on the arm 614 of the subject, and the electrode sheets 618 are connected to the action potential meter 620. As the electrode sheet 618 and the action potential meter 620, various general ones can be employed as long as the action potential can be measured. For example, as the action potential meter 620, a general oscilloscope, a personal computer (PC) capable of displaying an input waveform, or the like can be employed. In addition, instead of the electrode sheet 618, an electrode having a needle (needle electrode) can also be employed.

In addition, the X-axis stage 606, the Y-axis stage 608, and the Z-axis displacement mechanism unit 610 may be automatically controlled via a controller (not illustrated) or may be manually displaced by a measurer (operator). In addition, an automatic one and a manual one may be used in combination, for example, the X-axis stage 606 and the Y-axis stage 608 may be automatically controlled, and the Z-axis displacement mechanism unit 610 may be configured so that the pressing stick 612 is manually displaced.

In order to locate the Pacinian point, first, the subject places the arm 614 on the surface plate 602 with the palm facing upward. The subject puts a site of the arm 614 on the little finger side against the stopper 616 and positions the palm below the linear guide 604.

The measurer moves the linear guide 604 and moves the pressing stick 612 within an XY plane to guide the pressing stick to the vicinity of the described-above distribution region (region of 2×2 cm² in FIG. 35) of the palm below the little finger. The measurer randomly moves the pressing stick 612 within the XY plane so as not to significantly protrude from the distribution region. Further, the measurer stops the pressing stick 612 at any position and lowers the pressing stick 612 after stopping.

When the lowered pressing stick 612 hits the palm and presses the palm, an electric signal indicating an action potential at that time is detected by the electrode sheet 618 and input to the action potential meter 620 via the electrode sheet 618. The action potential meter 620 displays a waveform corresponding to a change in action potential on a screen on the basis of the input electric signal. Then, the measurer moves the pressing stick 612 also to a peripheral region and observes a waveform for each moved destination.

Then, a site where the waveform appears most clearly is determined as the Pacinian point, and the position is marked. This mark may be a seal pasted by a measurer or may be ink or the like by a pen tip provided at the tip (here, a lower end) of the pressing stick 612.

According to the invention (the first embodiment) of the locating method of a Pacinian point as described above, it is possible to search for (probe) and locate Pacinian points at intervals (pitches) corresponding to the performance (resolution) of the linear guide 604 in the point locating device 601. For example, when the performance of the linear guide 604 is such that the pressing stick 612 can be moved every 0.1 mm, the Pacinian point can be located in increments of 0.1 mm. The use of the instrument 200 with the located positions as marks enables appropriate use of the instrument (the instrument 1, the instrument 200, or the like).

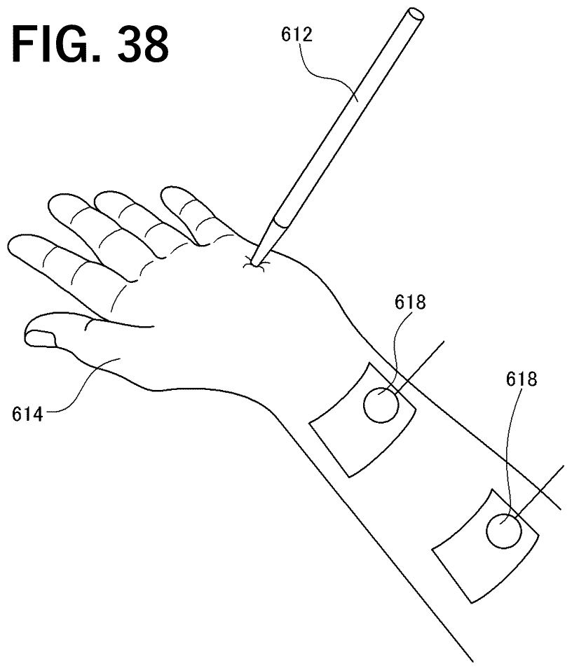

Note that, in the present embodiment, the linear guide 604 is provided in the locating system 600 to locate the Pacinian point, but the present invention is not limited thereto, and for example, the linear guide 604 may be omitted. In this case, the measurer presses the pressing stick 612 held in the hand one site after another site against the palm in the distribution region (FIG. 38) and can locate the Pacinian point while checking a change in action potential with the action potential meter 620 (refer to FIG. 36).

In addition, according to the locating system 600, since it is possible to locate the Pacinian point on the basis of a change of the action potential meter 620, it is possible to search out the Pacinian point with objectivity as compared with a case where the locating system 600 is not used. Then, it is possible to scientifically search out the Pacinian point without relying on the skill of the measurer or the sensation of the subject.

Therefore, it is possible to provide a distributor, a distribution agent, an exhibition hall, a showroom, an antenna shop, a trading station, or the like (hereinafter referred to as the “distributor or the like”) of instruments (the instrument 1, the instrument 200, and the like) in a wide area in Japan or overseas and introduce the locating system 600 to each distributor or the like. Further, in each distributor or the like, it is possible to realize a business model in which a specific person (a person in charge of each store or the like) clearly locates a Pacinian point for each customer and then sells the instrument (the instrument 1, the instrument 200, or the like). Then, it is possible to use the instrument (the instrument 1, the instrument 200, or the like) as effectively as possible.

In addition, according to the locating system 600, it is possible to search out the Pacinian point with objectivity as described above. Therefore, there is no need to perform advanced education and guidance that require a lot of time to enable workers of the distributor or the like to search for the Pacinian point.

Further, the locating system 600 may be used by being installed in a home of a user of the instrument (the instrument 1, the instrument 200, or the like). In this case, for example, it is possible for the user to locate the Pacinian point before the use of the instrument (the instrument 1, the instrument 200, or the like) every morning so that the Pacinian point can always be stimulated accurately.

### (Production of Support Jig)

In addition, it is also possible to produce an auxiliary tool (also referred to as a “support jig”, a “2D support jig”, a “2D jig”, a “template”, or the like) as a jig in which a Pacinian point for each user is located and recorded, use the auxiliary tool as a format for positioning the Pacinian point (positioning format), and always easily reproduce the Pacinian point. The auxiliary tool (support jig) is studied in consideration of the following points.

In other words, in a case where the locating system 600 as described above is installed in the distributor or the like, it is possible to use the locating system 600 in the distributor or the like to search out an accurate position of the Pacinian point. However, the user of the instrument (the instrument 1, the instrument 200, or the like) needs to know his/her Pacinian point immediately before every time the instrument is used. In addition, in a case where the user installs the locating system 600 at home as described above, problems of costs and installation positions easily occur. Hence, a technique that enables the user to easily locate the Pacinian point needs to be provided.

Thus, in the distributor or the like, the Pacinian point is accurately found out by the locating system 600, the Pacinian point is marked with a marker or the like on the spot, and then a photograph of the palm is taken with a camera. As the camera used here, in addition to a camera dedicated machine such as a digital camera, a camera or the like provided in a smartphone, a mobile phone, a tablet terminal, a notebook PC, an electronic book reader, a wearable computer, a portable game machine, or the like can be employed. In addition, the camera may be a camera owned by the user. Further, capturing may be performed by the user using his/her own camera or may be performed by using a camera of a distributor or the like.

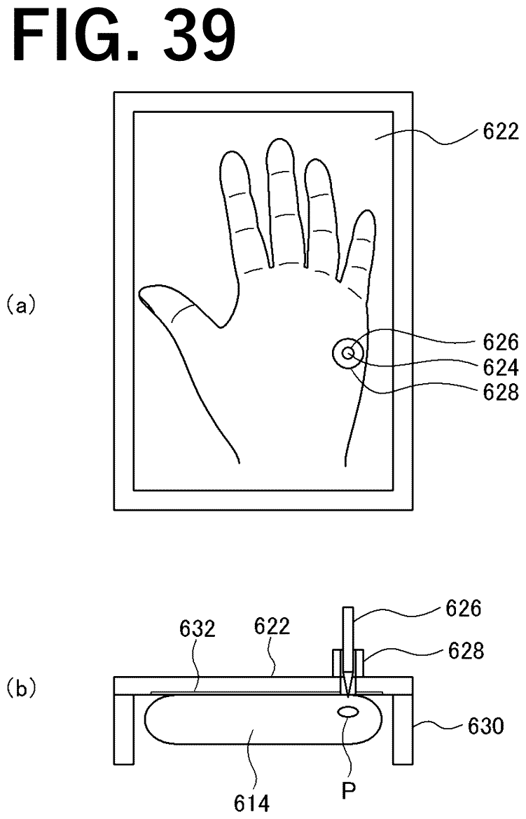

Subsequently, based on captured image data of a palm, a captured image of the palm is printed at equal magnification (full size) on, for example, a transparent acrylic plate or the like (transparent plate as a transfer base). FIG. 39(a) schematically illustrates a transparent plate 622 on which an image of a palm is printed. As a mode of printing the image of the palm, translucent printing is considered. In addition, as a printing machine used at this time, various types of general machines can be employed as long as the machines can perform printing on a transparent plate.

Thereafter, a hole 624 having, for example, a true circular shape is formed at a Pacinian point on the palm drawn on the transparent plate 622. As illustrated in FIG. 39(b) to be described below, a diameter of the hole 624 has a size through which a tip of a writing implement 626 such as a general ballpoint pen or a marker passes.

Before the user grips the instrument (the instrument 1, the instrument 200, or the like), the user puts a corresponding-side palm on the transparent plate 622 to match the image of the palm. FIG. 39(b) schematically illustrates a state where the palm is put on the transparent plate 622. The user inserts the tip of the writing implement 626 into the hole 624 from a side of a plate surface opposite to the plate surface on which the palm is put, and makes a mark on the palm.

In the examples of FIGS. 39(a) and 39(b), the transparent plate 622 is provided with a guide tube 628 that guides the writing implement 626 and prevents the writing implement 626 from tilting. In addition, the transparent plate 622 has a vertical wall portion 630 that forms a space in which a palm is placed and enables the palm to be inserted thereinto. Further, reference numeral 632 in FIG. 39(b) represents a layer of the printed image of the palm.

As described above, by producing the transparent plate 622 as the auxiliary tool (support jig) and making a mark to the palm using the transparent plate 622, it is possible to show the accurate position of the Pacinian point on the palm. Then, by bringing the contact portion (21, 221, or the like) of the instrument (the instrument 1, the instrument 200, or the like) into contact with the marked Pacinian point, the Pacinian corpuscle can be accurately pressed.

That is, the Pacinian point accurately measured by the locating system 600 is marked, a photograph of the palm is captured, and the transparent plate 622 on which the image of the palm is copied in the same size as the user's hand is produced. Further, the hole 624 is made at a portion corresponding to the Pacinian point of the transparent plate 622 (a portion of the Pacinian point), and the transparent plate 622 is passed to the user.

The user can align the palm with the transparent plate 622, pass the ballpoint pen through the hole 624, make a mark on the palm, and reproduce an accurate Pacinian point every time. Then, the user can use the instrument (the instrument 1, the instrument 200, or the like) for the correct Pacinian point without a burden of searching out the Pacinian point every time.

When the user of the instrument starts an exercise (grip exercise) using the instrument, the user needs to know the position of the Pacinian point accurately. That is, it is most effective to accurately press the Pacinian point when performing an exercise or walking using the instrument.

For this purpose, immediately before starting an exercise or the like, it is necessary to mark one's own Pacinian point and grip the instrument while being conscious of accurately pressing the pressing portion (pressing portion 20, 220, or the like) against the Pacinian point. In addition, it is desirable that before the user exercises at home, an office, a gym, or the like, the user mark the position of the Pacinian point at the correct position of his/her hand every time. By using the auxiliary tool (support jig), the position of the Pacinian point can be easily identified. This facilitates promotion of proper use of the instrument. In addition, it is possible to promote routine use of the instrument, such as daily use or use in every morning and evening.

### Second Embodiment of Invention of Locating Method of Pacinian Point

### [Background]

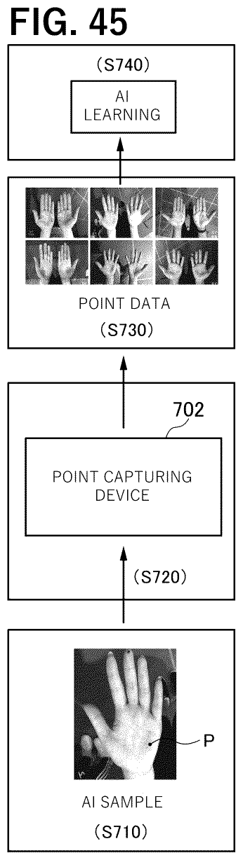

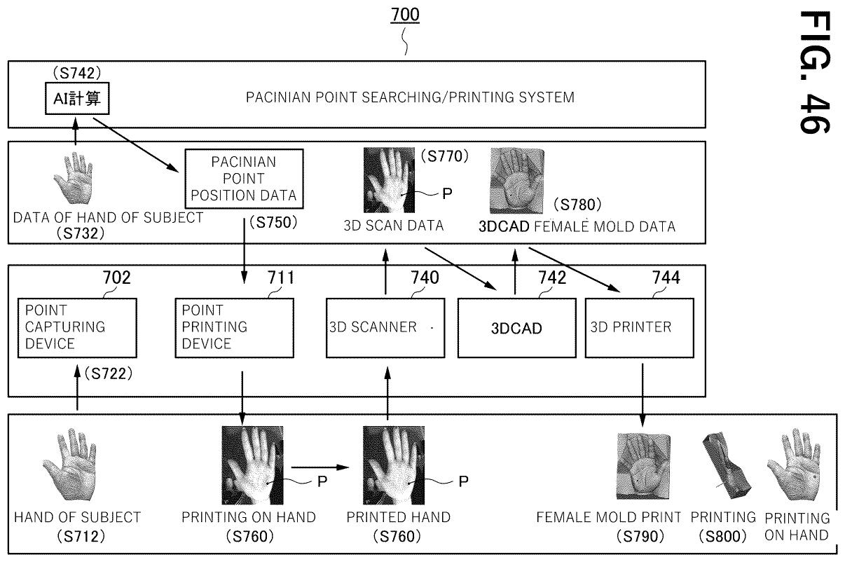

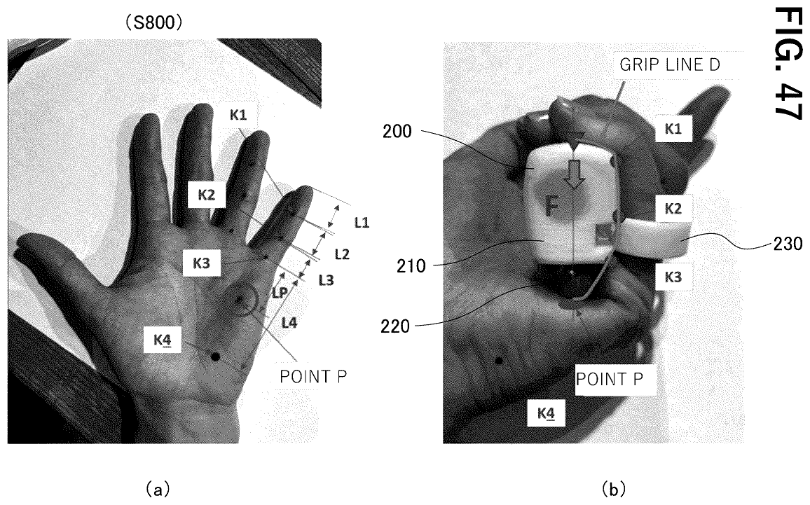

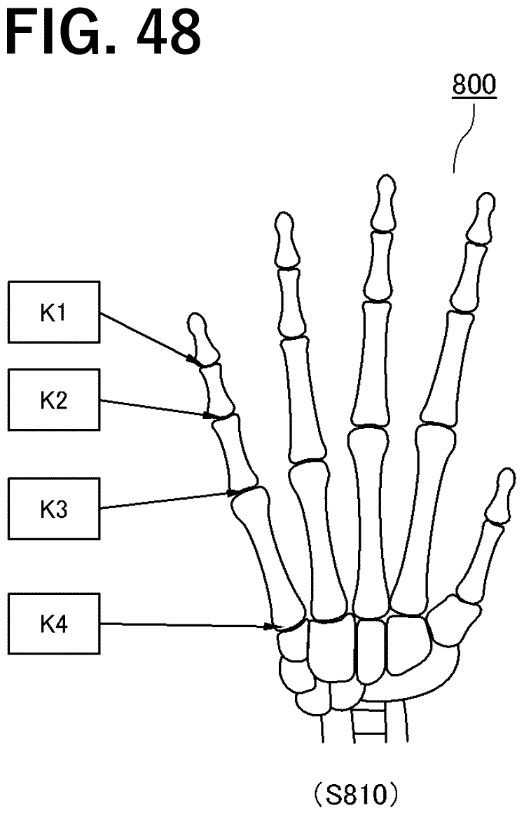

Next, a second embodiment according to the invention of the locating method of a Pacinian point will be described. In the locating method of the present embodiment, data (sample data) of a large number of collected Pacinian points is processed using artificial intelligence (AI) (FIG. 45 and FIG. 46), and an auxiliary tool (support jig) is produced by selecting an optimum Pacinian point (FIG. 46).

FIGS. 45 and 46 schematically illustrate a configuration of a locating system 700 according to the present embodiment and a locating method executed by the locating system 700. Of these, in FIG. 46, a title of “Pacinian point searching and printing system” is assigned, but this title indicates the locating system 700 according to the present embodiment.

In the locating system 700 (and locating method) illustrated in FIGS. 45 and 46, first, a predetermined number of males and females (for example, a total of about 200 males and females of about 100 persons each) are set as sample collection target persons. Then, as illustrated in the lowermost image of FIG. 45, a Pacinian point of each sample collection target person is located, and the located Pacinian point (point P) is marked with a writing implement or the like (step(S) 710). This sample becomes a sample (AI sample) to be processed by AI later.

Here, FIGS. 45 and 46 illustrate each step of the locating method by using a partial configuration of the locating system 700. Then, S710 in FIG. 45 means a step of the locating method executed by the locating system 700. Similarly, reference numerals attached with “S” such as “S720” or “S730” mean each step of the locating method.

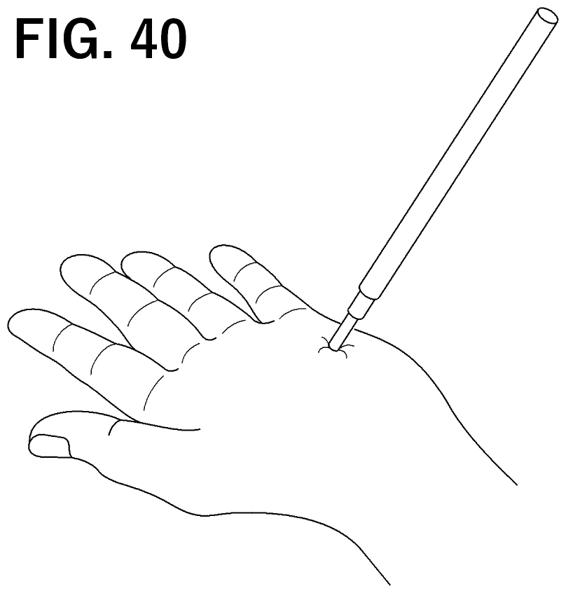

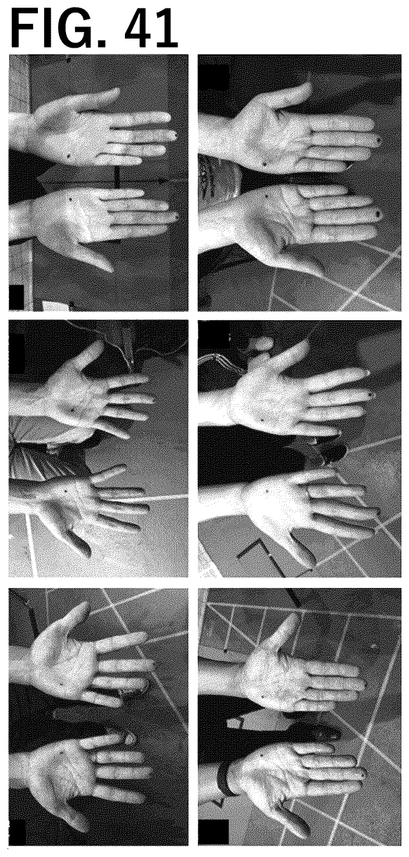

Various locating methods can be employed as the locating method of the Pacinian point in S710 of FIG. 45. For example, it is possible to employ various locating methods such as the locating method executed by sensory recognition illustrated in FIGS. 13(a) and 13(b) and the locating method executed by the action potential illustrated in FIGS. 36 to 38. FIG. 40 illustrates the locating method in which the measurer applies the stimulus to the left hand of the sample collection target person by using the pressing stick (a round stick, a pressing body, a pressure point pressing stick, or the like), similarly to the case of FIG. 13(b). By locating the Pacinian point at this time by a skilled operator, more accurate locating is performed.

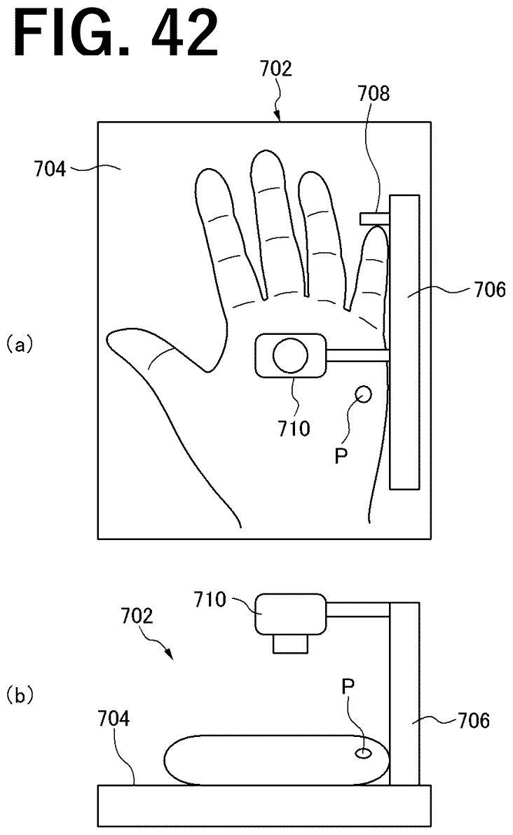

Subsequently, the hands of each individual marked at the Pacinian points are captured (S720). FIG. 41 illustrates some samples (6 persons) as an example. For example, a point capturing device 702 illustrated in FIGS. 42(a) and 42(b) can be used to capture the hands of each individual. In the point capturing device 702 of FIG. 42, a hand side surface stopper 706 and a little finger stopper 708 are provided to protrude upward on a surface plate 704.

Further, a camera 710 is mounted on the point capturing device 702. As the camera 710, a camera having a size smaller than the palm is employed. At the time of capturing a Pacinian point by the camera 710, a hand (left hand in FIG. 42(a)) of an individual which is a capturing target is placed on the surface plate 704, and the palm is directed to the camera 710 disposed above the surface plate 704.

When the hand is placed on the surface plate 704, a side surface of the hand is put on the hand side surface stopper 706, and the little finger is put on the little finger stopper 708 to fix the position of the hand. A capturing range of the camera 710 is adjusted to fit the entire palm. Then, the entire palm is captured by the camera 710, and image data of the palm including the Pacinian point is acquired.

Such palm capturing is performed for all the sample collection target persons (S730). Then, attribute data (for example, data of gender, age, or the like) of the sample collection target persons and data obtained from the images of the palms are compiled into a database, used as big data, and used for Pacinian point search by AI.

In the Pacinian point search, AI learning is performed in advance (S740). For the AI learning, for example, data (feature point data for learning) of feature points of the hands of each individual associated with the attribute data of the sample collection target person is collected. Examples of the feature point data for learning include data such as a size and a shape of a palm, a shape and a length of a finger, a length and a position of a joint of each finger, or the like.

In addition, examples of items of data indicating the size of the palm include items such as a length from a wrist to a tip of each finger, a length of each joint of each finger, a thickness (width) of each joint, or an area of a palm (an area including a finger, an area excluding a finger, or the like). Further, the measurement of these items, for example, can be exemplified with that a wrinkle or a joint of a wrist is recognized by image processing, a part (such as the center) of these is determined as a reference point, and a distance from the reference point to the fingertip or the joint is measured.

The AI learning is performed by an arithmetic processing unit (not illustrated). As the arithmetic processing unit, a computer including a central processing unit (CPU), various storage devices, and the like can be used. In addition, the arithmetic processing unit may be a unit connecting a plurality of computers via a communication network. Further, the arithmetic processing unit may be a unit connecting a computer installed at a place where the Pacinian point is located and a computer (such as a server device) at a remote place.

In the AI learning, classification is performed for each combination of attribute data (for example, a combination of gender and age), and a combination of a plurality of items of feature point data for learning corresponding to each classification and position data of the Pacinian point is used as teacher data. For example, the attribute data and the plurality of items of feature point data for learning corresponding to each classification are used as explanatory variables, and the position data of the Pacinian point is used as an explained variable (objective variable).

The feature point data for learning may be used for various purposes. For example, a correlation of items such as the length from the wrist to the tip of each finger and the length of each joint of each finger described above is quantitatively analyzed, and a function for regression analysis is created from a relationship between analysis results and position data of the corresponding Pacinian point.

Note that the method of AI learning is not limited to machine learning with supervised learning as described above, and for example, other methods of machine learning such as unsupervised learning and reinforcement learning can be employed. In addition, not only regression analysis but also a decision tree or the like can be employed as an analysis method in machine learning. In addition, in a case where the position of the Pacinian point is output as, for example, a plurality of candidates or a region having a predetermined size instead of coordinates for locating one position, clustering or other analysis methods can be employed as the analysis method. Further, the method of AI learning is not limited to statistical machine learning, and deep learning can also be employed.

In performing the AI learning, the feature point data for learning and the position data of the Pacinian point are acquired. In order to acquire the position data of the Pacinian point, certain coordinates (two-dimensional orthogonal coordinates, polar coordinates, or the like) are determined. An origin determined by the hand side surface stopper 706 and the little finger stopper 708 can be used to determine an origin of the coordinates. In addition, it is also possible to set an origin in an image of a palm and use a specific position (for example, a tip of a middle finger, a center of a width of a wrist, or the like) of a palm as the origin.

In using a result of the AI learning for searching for the Pacinian point, as illustrated in the lower left image of FIG. 46, a palm of a user (a subject in this case) who requests to locate the Pacinian point is captured (S712 and S722). A palm capturing device is used to capture the palm. As the palm capturing device, for example, a device having the same configuration as the point capturing device 702 described above can be used (S722). The above-described point capturing device 702 can be used as the palm capturing device as it is. Here, the case where the point capturing device 702 is used as the palm capturing device will be described as an example.

At the time of capturing the palm, the palm is put on the hand side surface stopper 706 and the little finger stopper 708 to fix the position of the hand. A capturing range of the camera 710 is adjusted to fit the entire palm. Then, the entire palm is captured by the camera 710, and image data of the palm is acquired.

Data (user feature data) of features of the hands of the user is extracted from the acquired image data of the palm (S732). The user feature data can be exemplified with, for example, data of a size and shape of a palm, a shape and length of a finger, or the like, similarly to the AI learning described above. In addition, examples of items of data indicating the size of the palm include items such as a length from a wrist to a tip of each finger, a length of each joint of each finger, a thickness (width) of each joint, or an area of a palm (an area including a finger, an area excluding a finger, or the like). Further, the measurement of these items can be performed, for example, in the same manner as in the AI learning described above.

Subsequently, arithmetic computation for the purpose of calculating the position of the Pacinian point is performed on the basis of the result of the AI learning by using the attribute data (for example, data such as gender or age) of the user and the user feature data (S742). Then, the position of the Pacinian point of the user is located (found) by estimation, and data (Pacinian point position data) of the located Pacinian point position is saved (S750).

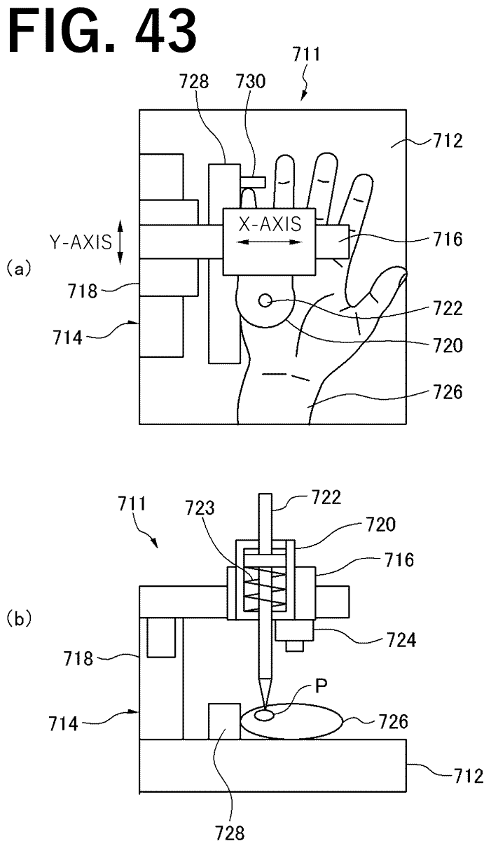

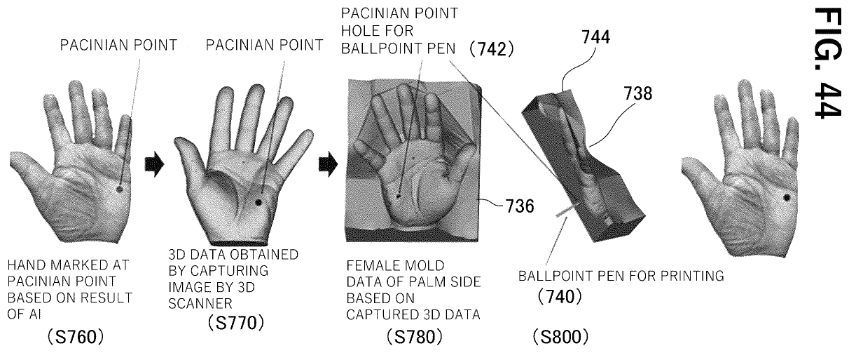

Thereafter, a mark is marked on the palm of the user on the basis of the located Pacinian point position data acquired by the AI, and the palm is captured (S760). In making a mark on the palm, for example, a point printing device 711 having a capturing function as illustrated in FIGS. 43(a) and 43(b) can be used.

In the point printing device 711 of FIGS. 43(a) and 43(b), similarly to the point locating device 601 (FIGS. 36 and 37) in the locating system 600 described above, a linear guide 714 is provided on a surface plate 712 having a flat surface. The linear guide 714 includes an X-axis stage 716 and a Y-axis stage 718, and the X-axis stage 716 and the Y-axis stage 718 can be linearly displaced in directions orthogonal to each other.

As illustrated in FIG. 43(b), the Y-axis stage 718 has a Z-axis displacement mechanism unit 720, and the Z-axis displacement mechanism unit 720 holds a printing stick 722. As the printing stick 722, a general writing implement such as a ballpoint pen or a felt pen can be used. The printing stick 722 is displaceable in the Z-axis direction via an elastic body (for example, a coil spring, a leaf spring, or the like) 723.

Here, the Z-axis direction is a direction orthogonal to a plane formed by the X-axis and the Y-axis (approximate to the flat surface of the surface plate 712). In addition, the X-axis, the Y-axis, and the Z-axis according to the present embodiment are set in the same directions as the respective axes in the locating system 600 of the above-described embodiment.

As illustrated in FIG. 43(b), the Y-axis stage 718 is provided with a camera 724 capable of capturing an image of a lower side. As the camera 724, a camera similar to the camera 710 of the point capturing device 702 illustrated in FIGS. 42(a) and 42(b) can be employed.

In addition, the X-axis stage 716, the Y-axis stage 718, and the Z-axis displacement mechanism unit 720 may be automatically controlled via a controller (not illustrated) or may be manually displaced by a measurer (operator). In addition, an automatic one and a manual one may be used in combination, for example, the X-axis stage 716 and the Y-axis stage 718 may be automatically controlled, and the Z-axis displacement mechanism unit 610 may be configured so that the printing stick 722 is manually displaced.

As illustrated in FIG. 43(a), an arm (right arm in this case) 726 of a mark leaving target person can be placed on the surface plate 712. A hand side surface stopper 728 and a little finger stopper 730 are provided to protrude upward on the surface plate 712. Then, the arm 726 of the mark leaving target person is positioned in a state where a side surface on the little finger side of the hand is put on the hand side surface stopper 728 and the tip of the little finger is put on the little finger stopper 730.

The X-axis stage 716 and the Y-axis stage 718 move the printing stick 722 such that a pen tip of the printing stick 722 is positioned directly above the Pacinian point (point P) on the basis of the located Pacinian point position data acquired by the AI. Thereafter, as illustrated in FIG. 43(b), the printing stick 722 is lowered in the Z-axis direction, the pen tip is brought to hit the palm, and the Pacinian point (point P) is marked.

Thereafter, for example, the palm is captured by the camera 724, and image data of the palm is acquired. Further, on the basis of the image data of the palm, the captured image (two-dimensional image) of the palm is printed at equal magnification (full size) on, for example, a transparent acrylic plate or the like (transparent plate as a transfer base) in the same manner as illustrated in FIGS. 39(a) and 39(b) according to the “first embodiment according to the invention of the locating method of a Pacinian point”. Then, in the same manner as illustrated in FIGS. 39(a) and 39(b), an auxiliary tool (support jig) is produced, and a mark is marked on the palm via the auxiliary tool, so that the accurate position of the Pacinian point is shown on the palm.

Alternatively, instead of the auxiliary tool on which planar printing as described above is performed, an auxiliary tool (also referred to as a “3D support jig”, a “3D jig”, a “template”, or the like) having a three-dimensional shape may be produced. FIG. 44 illustrates a producing procedure and a use method of the three-dimensional auxiliary tool from left to right. In addition, at the lower left part of FIG. 46, the locating method of a Pacinian point in a case where the three-dimensional auxiliary tool is used is illustrated.

At the left end of FIG. 44, a hand marked using AI is illustrated. This mark is marked by the point printing device 711 of FIG. 43. This hand is subjected to 3D scanning by a 3D scanner (reference numeral 740 in FIG. 46), and 3D scan data as illustrated in the next image (right side) in FIG. 44 is acquired (S770).

The 3D scan data also includes data of the Pacinian point. Here, what is described as “Pacinian point” in FIG. 44 is the Pacinian point. Thereafter, as illustrated in the next image in FIG. 44, female mold data for producing a palm mold 748 is created in cooperation with 3D CAD (reference numeral 742 in FIG. 46) using the 3D scan data (S780).

When the 3D scan data is imported into the 3D CAD, the 3D scan data can be imported from a communication interface of the 3D scanner to a personal computer (PC) via a communication interface of the PC. Further, in the PC, the 3D scan data is read in spreadsheet software, and numerical data is read by the 3D CAD from a numeric table created by the spreadsheet software. In this manner, after the 3D scan data is imported into the 3D CAD, data correction (integration of predetermined coefficients, etc.) is performed in the 3D CAD as necessary. In the spreadsheet software, coefficients of parts (various coefficients used for arithmetic computation of variables) are listed, and the coefficients of parts can be imported into the 3D CAD from the spreadsheet software. In addition, in the spreadsheet software, it is also possible to perform arithmetic computation using the coefficients, and arithmetic computation results can be imported into the 3D CAD. A design value of the female mold data determined by the 3D CAD (or imported into the 3D CAD) is transmitted from the communication interface of the PC to a communication interface of a 3D printer (reference numeral 744 in FIG. 46) and read by the 3D printer (reference numeral 744 in FIG. 46). Note that, hereinafter, description of transmission and reception of such data will be omitted as appropriate.

Subsequently, a palm mold (also referred to as a “female mold”, a “3D jig”, or the like) 748 is produced (also referred to as “printed”, a “formed”, or the like) in cooperation with the 3D printer (reference numeral 744 in FIG. 46) (S790). A format of data processed by the 3D printer 744 is triangle-meshed polygon data. The palm mold (3D jig) 748 has a recess 750 obtained by three-dimensionally copying a shape of the palm side with respect to the user's hand.

During the forming of the palm mold (3D jig) 748, the Pacinian point is also reflected. A hole 754 into which a writing implement 752 such as a ballpoint pen can be inserted is made at a position of the Pacinian point, and an auxiliary tool 756 is produced. Then, the hand of the user is placed to overlap the recess 750 of the auxiliary tool 756 in alignment, and the writing implement 752 is inserted into the hole 754 to make a mark on the palm of the user (S800).

According to the invention (the second embodiment) of the locating method of a Pacinian point, the Pacinian point can be accurately located as in the first embodiment. In addition, since the Pacinian point is located using AI, it is not necessary to manually find out the Pacinian point every time, and an operation of locating the Pacinian point can be automated. Further, since the auxiliary tool 756 is used, it is possible to easily locate the position of the Pacinian point on the palm even when the user uses the instrument 200.

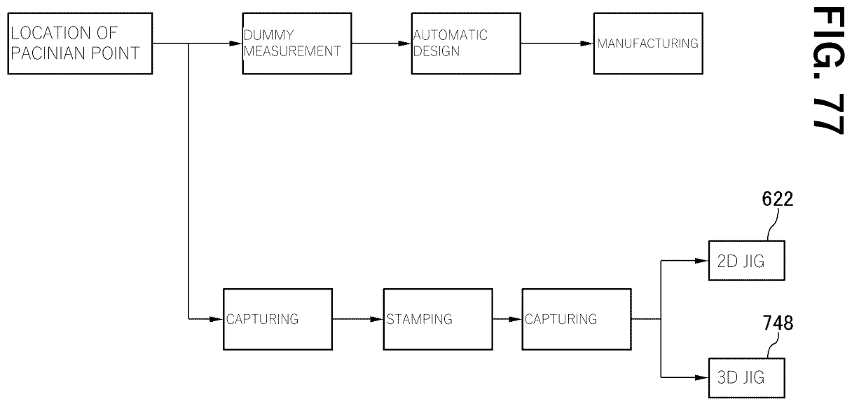

FIG. 76 illustrates an example of an integrated system in which the first embodiment (FIGS. 34 to 39) and the second embodiment (FIGS. 40 to 46) of the invention relating to the Pacinian point locating system (and locating method) are integrated. The invention relating to the Pacinian point locating system (and locating method) can constitute an integrated locating system (and locating method) by being combined in this way.

The upper left box of FIG. 76 illustrates the first embodiment of the invention relating to the Pacinian point locating system (and locating method), and the lower left box illustrates the second embodiment. In the first embodiment in the upper left box, the Pacinian point of the subject is located as indicated by the “XY position finding” through “measurement” of a “linear type” using the linear guide (reference numeral 604 in FIGS. 36 and 37).

On the other hand, in the second embodiment illustrated in the lower left box of FIG. 76, the “AI learning” using “big data” is performed (corresponding to the steps of S710 to S740 in FIG. 45), and the learning result is subjected to “AI calculation” by the “AI system”, and the Pacinian point of the subject is located as indicated by the “XY position finding” (corresponds to steps of S712, S722, S732, S742, and S750 in FIG. 46)

Thereafter, the 2D jig or the 3D jig is produced through “stamping” and “capturing” which are steps common to both the embodiments. In the first embodiment (FIGS. 34 to 39), the “stamping” and the “capturing” correspond to marking with a marker or the like for producing the support jig and the subsequent photograph capturing. In the second embodiment (FIGS. 40 to 46), the “stamping” and the “capturing” correspond to marking by the point printing device 711 having a capturing function and the subsequent photograph capturing (S760).

Thereafter, such a procedure proceeds to the step of producing not only the 2D jig (transparent plate 622) of the first embodiment (FIGS. 34 to 39) but also the 3D jig (palm mold 748) of the second embodiment (FIGS. 40 to 46), and it is possible to produce the 3D jig (palm mold 748). In addition, it is also possible to produce the 2D jig (transparent plate 622) by proceeding from the step according to the second embodiment (FIGS. 40 to 46) to the step of generating the 2D jig (transparent plate 622) of the first embodiment (FIGS. 34 to 39). As described above, the 2D jig (transparent plate 622) that can be produced at a relatively low cost by planar printing and the 3D jig (palm mold 748) that causes relatively high costs by the three-dimensional forming can be produced, and thereby it is possible to give a user an option. It is possible to realize diversification of instrument selection such that a user who is financially secure selects the 3D jig (palm mold 748) and a user who is not financially secure selects the 2D jig (transparent plate 622).

### [Invention Relating to Automatic Design System for Instrument]

Next, automatic design system and method for the above-described instrument (the instrument 1, the instrument 200, or the like) will be described. Note that, here, the automatic design system and the automatic design method will be described by taking a ring model type of instrument 200 as an example.

First, an automatic design technique as will be described below is needed to maximize the effect of the instrument 200. That is, a size of a palm is different for each person, and a position of a Pacinian corpuscle is also different for each person. Therefore, in order to maximize the effect of the instrument 200, it is necessary to provide the instrument 200 adapted (personalized) to a size of each individual user.

For example, when custom-made clothes are made, a defined dimension such as a shoulder width is measured to prepare a pattern paper. In the automatic design system described here, for each person's hand, a dimension of a predefined site and a size of a hand are measured, and an instrument that accurately matches the position of the Pacinian corpuscle is designed.

### (Embodiment of Invention Relating to Automatic Design System)

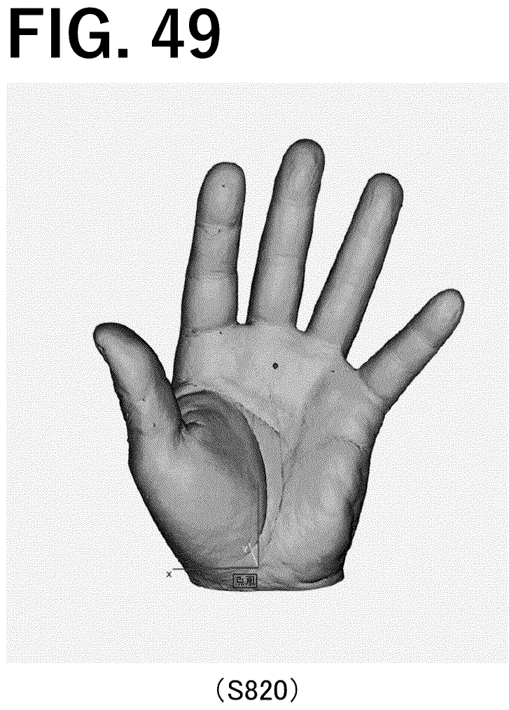

First, a position of a Pacinian point and a position of a finger joint on a palm of a measurement target person are measured, and data of measurement results is stored in a storage device or the like of a computer (not illustrated) (step(S) 800). Among these measurements, the measurement of the position of the Pacinian point can be performed, for example, in the same manner as the method for detecting the position described above (FIG. 13(b)). In the photographic image of FIG. 47(a), a mark is marked with a marker at the measured position of the Pacinian point (point P).

In addition, in the measurement of the position of the joint of the finger, the position of the joint and a length of each part are determined for the little finger as illustrated in FIG. 47(a). For example, a position of a central portion in a width direction of a root of a distal segment on a tip side (a first joint, that is, a distal joint) is set as K1. In addition, a position of a central portion in the width direction at a root of a middle segment (a second joint, that is, a middle joint) is set as K2, and a position of a central portion in the width direction at a root of a proximal segment (a third joint, that is, a proximal joint) is set as K3.

Further, a position of a central portion of a raised portion (little finger ball portion) on the little finger side of the palm is set as K4. Further, a length of the distal segment is set as L1, a length of the middle segment is set as L2, and a length of the proximal segment is set as L3.

Note that the measurement of positions and lengths thereof can be determined, for example, as positions and lengths on coordinates with any part of the palm (the tip of the little finger, the tip of the middle finger, the tip of the thumb, the center of the wrist, etc.) as an origin. Alternatively, the measurement is not limited thereto, and the positions and the lengths can be determined by other methods.

FIG. 47(b) illustrates each position of a hand in a case where a prototype (here, denoted by reference numeral 200) having a function similar to that of the instrument 200 is gripped in the hand (here, the left hand). The little finger and the ring finger pass through the ring portion 230, and the instrument 200 is gripped. In this manner, a grip line D formed by the little finger and the palm is substantially on an arc.

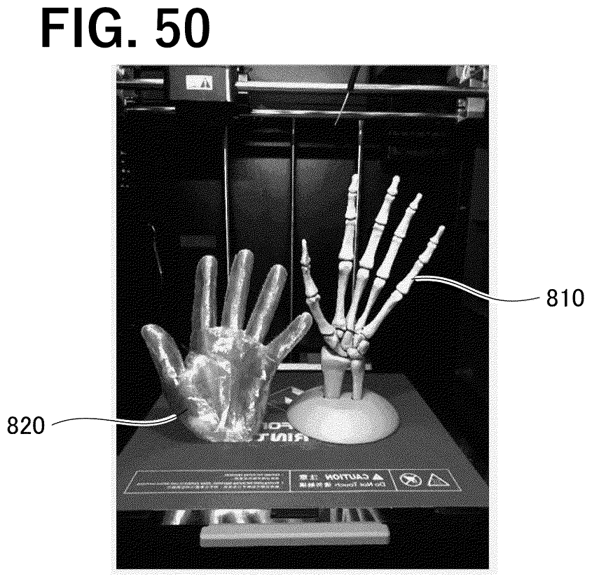

A model of a bone (hand bone model) 810 as illustrated in FIG. 48 can be produced based on the measurement results of the position of the Pacinian point and the positions of the finger joints (S810). The model 810 of a bone is a three-dimensional object and is produced using, for example, a 3D printer. In addition, the model 810 of a bone is produced so that the positions of K1 to K4 and the lengths of L1 to L3 described above are reflected.

For example, regarding the little finger, a position of a central portion in the width direction of a root of a distal segment on a tip side (a first joint, that is, a distal joint) is set as K1. In addition, a position of a central portion in the width direction at a root of a middle segment (a second joint, that is, a middle joint) is set as K2, and a position of a central portion in the width direction at a root of a proximal segment (a third joint, that is, a proximal joint) is set as K3. Further, a position of a central portion of a base of a metacarpal on the little finger side of the palm is set as K4. Further, a length of the distal segment is set as L1, a length of the middle segment is set as L2, a length of the proximal segment is set as L3, and a length of the metacarpal is set as L4.

In addition, here, in order to prevent the description and illustration from being complicated, the descriptions of other fingers and other parts of the palm (ball-of-thumb part, 4-finger basal part, etc.) are omitted, but positions and lengths thereof are similarly measured, and measurement results are reflected in the model 810 of a bone. Then, the model 810 of a bone matching the hand of the measurement target person is obtained.

When the model 810 of a bone is produced, measurement results of the position of the Pacinian point and the positions of the finger joints are converted into numerical information, for example, input into a numeric table of spreadsheet software, and imported into the 3D CAD from the spreadsheet software. The cooperation between the spreadsheet software and the 3D CAD can be performed in the same manner as described above, for example. In the 3D CAD, arithmetic processing such as multiplying information of a basic model of a bone by a predetermined coefficient according to a condition (such as information of age, gender, or physique) of the measurement target person is performed. An arithmetic computation result of the 3D CAD is imported into a 3D printer, and the model 810 of a bone is formed by the 3D printer. The production of the model 810 of a bone can be omitted as long as an instrument that satisfies a measurement target person can be produced by measurement with a dummy grip 880 to be described below:

Subsequently, the shape of the hand of the measurement target person is 3D-scanned by the 3D scanner, and 3D scan data is acquired (S820 in FIG. 49). The acquired 3D scan data is imported into, for example, a numeric table of spreadsheet software and is imported into the 3D CAD in the same manner as in the case of producing the model 810 of a bone. FIG. 49 illustrates the 3D scan data displayed on a monitor device. In the 3D CAD, arithmetic processing such as multiplication by a predetermined coefficient according to a condition (such as information of age, gender, or physique) of the measurement target person is performed. An arithmetic computation result of the 3D CAD is imported into a 3D printer, and a model of a hand (hand model) 820 is formed by the 3D printer (S830). The model 820 of a hand is a hollow three-dimensional object. In addition, the model 820 of a hand matches the model 810 of a bone with the positions K1 to K4 of the joints, the lengths of the joints, and the like. Here, in FIG. 49, a display image is illustrated by being inverted in order to match the orientation of the hand to that in FIG. 47(a).

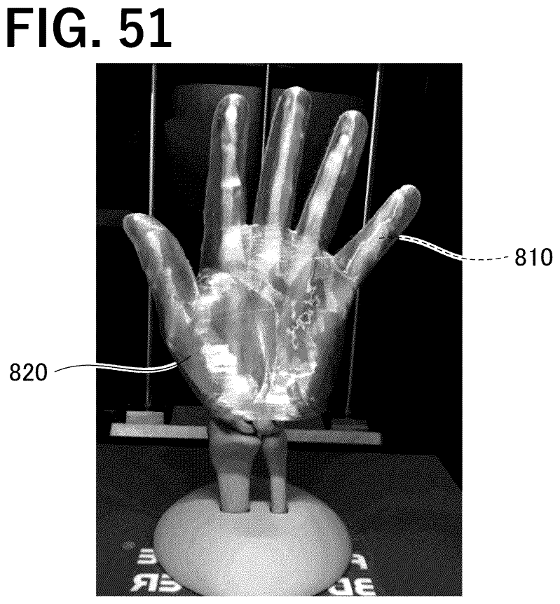

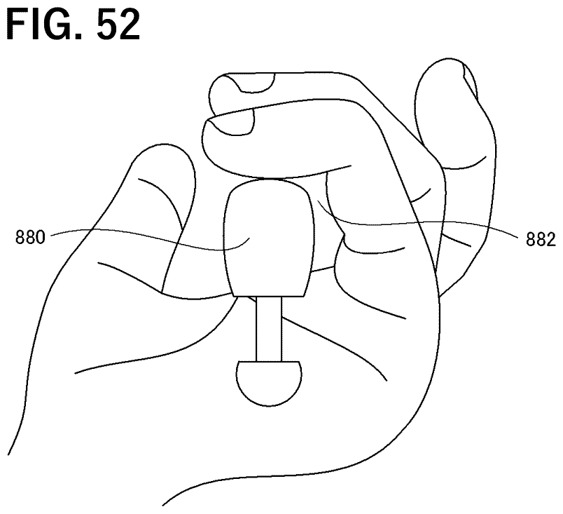

FIG. 50 illustrates an image obtained by capturing the produced model 810 of a bone and model 820 of a hand side by side. In addition, FIG. 51 illustrates an image obtained by capturing a state where the model 810 of a bone is covered with the model 820 of a hand. Here, also in FIGS. 50 and 51, the display image is illustrated by being inverted in order to match the orientation of the hand with that in FIG. 47(a).

By producing the model 820 of a hand in this manner, a 3D model which matches the shape of the hand and the shape of the bone of the measurement target person and in which the hand and the bone are combined is obtained. Note that the production of the model 820 of a hand and the production of the model 810 of a bone can be both omitted as long as an instrument that satisfies a measurement target person can be produced by measurement with a dummy grip to be described below.

Subsequently, as illustrated in FIG. 52, the dummy grip 880 having substantially the same size (outer dimension) as the instrument (200) and imitating the instrument (200) is prepared, and the measurement target person grips the dummy grip 880. Then, in a state where the dummy grip 880 is gripped, the shape of the hand of the measurement target person is 3D-scanned by the 3D scanner (S840). At this time, the dummy grip 880 is gripped such that the gap 882 is formed between the dummy grip 880 and a little finger.

The 3D scan data acquired by the 3D scan is imported into, for example, a numeric table of spreadsheet software and imported into the 3D CAD from the spreadsheet software (S850). In the 3D CAD, a thickness (particularly, a width, a diameter, or the like) of a little finger or a ring finger in the case where the instrument (200) is gripped is measured based on the imported 3D scan data (S860). In the 3D CAD, arithmetic processing such as multiplying basic hand information by a predetermined coefficient according to a condition (such as information of age, gender, or physique) of the measurement target person is performed (S870).

Then, various conditions such as a size (diameter) of a hole of the little finger ring 231 or the ring finger ring 232 in the ring portion 230 of the instrument 200 are determined from the measurement results, and a determined size is used as a design value of the ring portion 230 (S870). In addition, in the 3D CAD, a relationship between the position of the Pacinian point (point P) and the bent little finger or ring finger is determined, and determined details are used as a design value of a dimension of each part (S870).

Here, a reason why the dummy grip 880 is used instead of the instrument 200 at the time of 3D scanning is to facilitate the measurement of the little finger and the ring finger so that the acquired 3D scan data does not include redundantly complicated details.

FIG. 53 illustrates a state where the little finger and the ring finger are bent toward the hand of the measurement target person. The 3D scan data acquired at the time of producing the model 810 of a bone is used with parameters changed so that the little finger and the ring finger are in a bent state as illustrated in FIG. 53. Then, design is performed on the 3D CAD as described above using data of the state where the little finger and the ring finger are bent and the gap 882 (see FIG. 52) is formed.

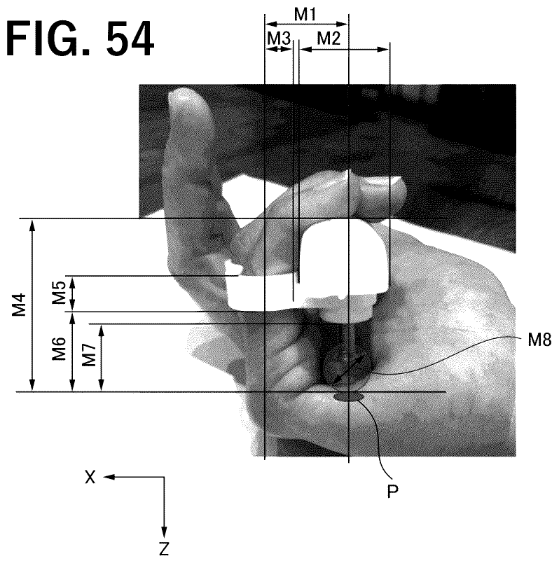

Further, data related to the main body portion 210 and data related to the ring portion 230 described above are combined, and a positional relationship between the main body portion 210 and the ring portion 230 is determined (S880). Then, based on the information derived from polygon data of a triangle mesh, the dimensions of each part of the instrument 200 (a prototype is illustrated in the drawing) are determined, as illustrated in FIG. 54. Here, individual reference numerals in FIG. 54 mean dimensions of the following portions.
M1: Center-to-center distance between main body portion 210 and ring portion 230
M2: Width of main body portion 210 (X-axis direction)
M3: Inner diameter of little finger ring 231
M4: Height of instrument 200 (Z-axis direction)
M5: Width of ring portion 230 (Z-axis direction)
M6: Distance from ring portion 230 to tip of pressing portion 220 (Z-axis direction)
M7: Distance from main body portion 210 to tip of pressing portion 220 (Z-axis direction)
M8: Diameter of R portion in pressing portion 220

Based on the design data obtained as described above, the main body portion 210 and the ring portion 230 are produced by the 3D printer or the like (S890). Then, the instrument 200 is assembled using the main body portion 210, the pressing portion 220, and the ring portion 230 as components. As a result, the measurement target person is provided with the custom-made instrument 200 in which the pressing portion 220 is positioned to accurately brought into contact with the Pacinian point.

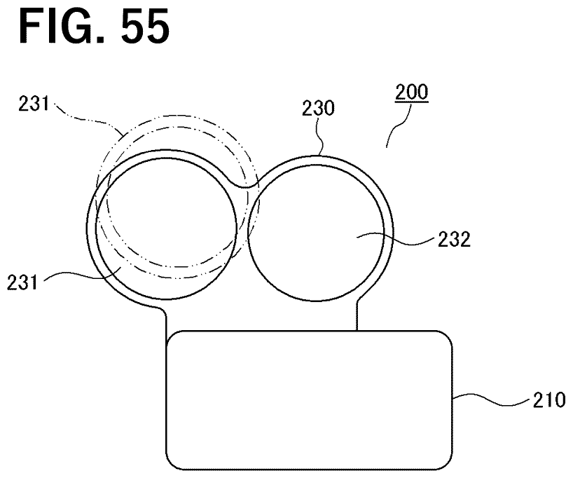

FIG. 55 illustrates that the shape and the size of the instrument 200 are changed by such the design method. For example, a design change for a custom-made instrument is performed on the instrument 200 (a standard product illustrated by solid lines) having a reference size, and the position of the ring portion 230 (here, only the little finger ring is illustrated) is moved to a position away from the main body portion 210 as represented by a two-dot chain line. The ring portion 230 is not necessarily formed in a direction perpendicular to the main body portion 210 and may be formed obliquely inclined with respect to the main body portion 210 depending on factors such as a positional relationship between a finger joint and the main body portion 210. By employing the automatic design system and the automatic design method as described above, it is possible to obtain the custom-made instrument 200. Then, it is possible to provide the instrument 200 having an optimum size depending on individual differences or growth of a child.

Note that it is also possible to employ the following providing scheme, for example, in addition to redesigning the instrument 200 each time, such as every year or every few years. First, a plurality of instruments 200 in which each portion has different sizes, and positional relationships between the individual portions are different are produced and stored in stores or business offices. Then, the measurement (may be performed by the 3D scan) of the palm of the user is performed every predetermined period (every year, every few years, or the like). Then, on the basis of results of the measurement, an appropriate instrument 200 is selected and lent to the measurement target person.

FIG. 77 illustrates an example of an integrated system of the invention of an integrated system relating to the Pacinian point locating system (and locating method) illustrated in FIG. 76 and the invention relating to the automatic design system for the instrument. The invention relating to the Pacinian point locating system (and locating method) and the invention relating to the automatic design system for the instrument can be combined with each other as described above to constitute an integrated instrument/support jig producing system (and producing method).

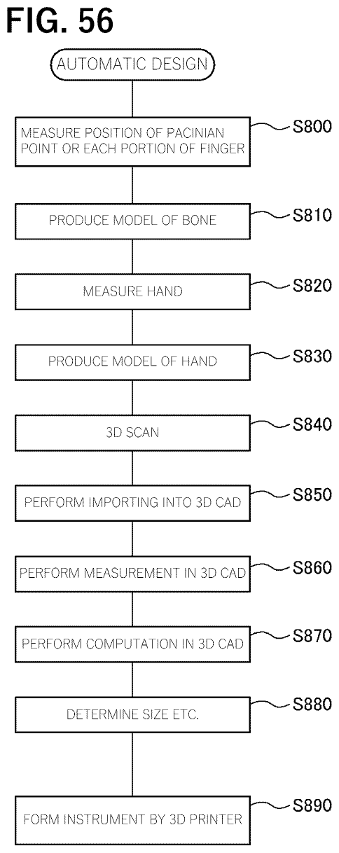

“Location of the Pacinian point” illustrated in the upper left box in FIG. 77 is a step of locating the position of the Pacinian point. The “Location of the Pacinian point” corresponds to the measurement of the position of the Pacinian point (S800 in FIG. 56) in the embodiment (FIGS. 47 to 56) according to the automatic design for the instrument. “Dummy measurement” in the subsequent box corresponds to the step of scanning the hand gripping the dummy grip 880 by the 3D scanner as illustrated in FIG. 52 (S840 in FIG. 56).

“Automatic design” in the subsequent box corresponds to steps of importing 3D scan data into the 3D CAD through the spreadsheet software and determining, in the 3D CAD, the size of and the positional relationship between the portions while the arithmetic processing is performed (S850 to S880 in FIG. 56). Then, “production” corresponds to the step of forming the instrument 200 by the 3D printer (S890 in FIG. 56).

The lower diagram of FIG. 77 illustrates the integrated system relating to the Pacinian point locating system (and locating method) illustrated in FIG. 76. “Capturing” at the left end of the lower diagram corresponds to the capturing in the search for (probing in first embodiment) the position of the Pacinian point or the capturing in the location of the position of the Pacinian point by the AI system (second embodiment). Further, the steps from “stamping” to “2D jig” or “3D jig” are similar to the common steps of the integrated system illustrated in FIG. 76.

### Modification Examples of Ring Portion 230

Next, modification examples of the ring portion 230 in the ring-model instrument 200 described above will be described. Any modification examples of the ring portion 230 described here can be produced by integral molding with a synthetic resin. The ring portion can be produced by the automatic design described above.

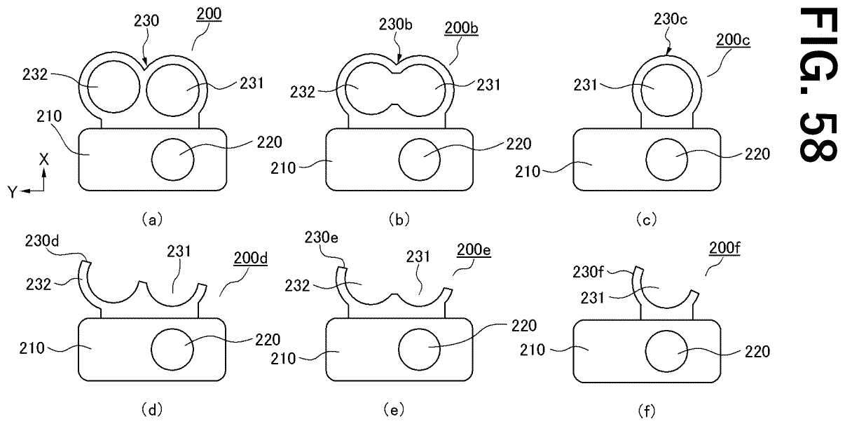

The function of the ring-model instrument 200 as described above is similarly exhibited even if an aspect of the ring portion 230 is changed. FIG. 58 illustrates various shapes that can be employed for the ring portion 230. FIG. 58(a) shows the same instrument 200 as that illustrated in FIGS. 31 and 32. The instrument 200 includes the ring portion 230 in which two rings (the little finger ring 231 and the ring finger ring 232) are formed, as described above. Hereinafter, this type is considered as a reference type related to the ring portion 230.

Note that the instrument 200 illustrated in FIG. 58(a) is turned over with respect to the instrument 200 illustrated in FIG. 32 so that the pressing portion 220 side faces the front, and the positional relationship between the main body portion 210 and the ring portion 230 is also somewhat different.

In contrast to this reference type, FIG. 58(b) illustrates a type of ring portion 230b in which a partition wall positioned between the two rings (the little finger ring 231 and the ring finger ring 232) is partially removed, and internal spaces of the two rings 231 and 232 are connected to one. In addition, FIG. 58(c) illustrates a type of ring portion 230c having only one ring (the little finger ring 231 in this case).

FIGS. 58(d) to 58(f) illustrate types in which distal end sides of the ring portions 231a to 231c in FIGS. 58(a) to 58(c) are cut obliquely (here, so as to be lowered from the ring finger side to the little finger side) with respect to the Y-axis (illustrated in FIG. 58(a)), and the shapes of the rings (231 or 232) are open arc shape (W shape or U shape). Instruments 200b to 200f including these types of ring portions 230b to 230f can also prevent rotation (right/left rotation) about the Z-axis and can also exhibit the same function of fixing the position as the instrument 200 of the present embodiment.

### Modification Examples of Pressing Portion 220

Next, various modification examples of the pressing portion 220 of the instrument 200 will be described. Note that portions similar to those of the instrument 200 of the second embodiment are denoted by the same reference numerals, and descriptions thereof will be omitted as appropriate.

### (First Modification Example of Pressing Portion 220)

In the first embodiment described above, as illustrated in FIG. 5, it is described that the space is preferably formed around the contact portion 21 (Pacinian ball) so as not to stimulate sensory receptors other than the Pacinian corpuscles in a state where the contact portion 21 (Pacinian ball) of the pressing portion 20 included in the instrument 1 sinks in the palm by about 1 mm to 15 mm (preferably 3 mm to 10 mm). In this respect, in an instrument 200A of the second embodiment illustrated in FIG. 59, a radius R of a spherical pressing portion 220A (in particular, the contact portion 221) is optimized.

For example, in a case where the entire (or almost entire) pressing portion 220 (here, 220A) or the contact portion 221 (here, 221A) has a spherical shape, and the radius of the sphere is too large, an arc (spherical surface) of the contact portion 221A that is brought into contact with and presses the palm is also increased. Then, the arc (spherical surface) for pressing the Pacinian is increased, and the shape of the portion approaches a flat surface. As a result, in a case where the Pacinian point is set to a small radius of about 1 mm, it becomes difficult to accurately press the Pacinian point with a force of an appropriate strength.

In addition, when the radius of the contact portion 221A is too small, the pressing portion 220 (here, 220A) is excessively sunk in the palm by a pressing force, and the user feels pain. In this case, it is difficult to transmit an appropriate pressing force to the Pacinian corpuscle. In addition, usually, the size of the palm is different between individuals for each factor (attribute) such as an adult, a child, a female, or a male, and a radius in which the pressing of the contact portion 221 (Pacinian ball) is appropriately felt is different between individuals.

In consideration of these, it is most effective that the contact portion 221A has a spherical shape like the instrument 1 and the instrument 200 described above. In addition, in the example of FIG. 59, the radius R of the contact portion 221A is set to any size within a range of R of 4 mm to 10 mm. In this range, for example, in the case where the radius is R of 4 mm, the contact portion 221A suitable for a baby girl (female child) is obtained. In addition, in the case where the radius is set to R of 10 mm, the contact portion 221 A suitable for a grown man (adult male) is obtained. According to the research by the inventors or the like, R of 7 mm to 8 mm is suitable for Japanese adult female having an average physique, and R of about 8 mm to 10 mm is suitable for Japanese adult female having a physique larger than the average physique. In addition, in a case where a physique is smaller than that of a Japanese female having the average physique, R of about 4 mm to 7 mm is preferable.

### (Second Modification Example of Pressing Portion 220)

FIGS. 60(a) and 60(b) illustrate a pressing portion 220B according to a second modification example in an enlarged manner. In the pressing portion 220B, a contact portion 221B integrally formed with the pressing portion 220B has a protruding shape. The contact portion 221B has a stepped shape (here, a two-step shape) and includes a hemispherical first contact portion 221B1 having a relatively small radius (a tip portion of the pressing portion 220B) and a tapered second contact portion 221B2 having a relatively large radius. In the example of FIG. 60, the pressing portion 220B has a stepped shape of three steps as a whole including the second contact portion 221B2. In FIGS. 60(a) and 60(b), since an angle of a tapered part of the second contact portion 221B2 slightly changes along the second contact portion, an annular line is drawn at a middle portion of the second contact portion 221B2.

As illustrated in FIG. 60(b), a base end side (a side of the shaft portion 222 illustrated in FIG. 31) of the pressing portion 220B is molded flat, and the shaft portion 222 (FIG. 31) is fixed to this flat portion. A portion of the pressing portion 220B excluding the first contact portion 221B1 and the second contact portion 221B2 is molded in a spherical shape, and a radius R_{A} of this portion is, for example, R of about 4 mm to 10 mm.

A radius R_{B} of the first contact portion 221B1 is R of about 0.5 mm to 5 mm (a value smaller than R_{A}). A tip side of the second contact portion 221B2 is a portion on a small diameter side continuously connected to the first contact portion 221B1, and a radius R_{C} (a radius in the horizontal direction in the drawing) thereof is the same as the radius R_{B} of the first contact portion 221B1. The base end side of the second contact portion 221B2 is a portion on a large diameter side, and a radius R_{D} thereof is smaller than R_{A}.

The pressing portion 220B is formed into a plurality of types of spherical shapes as illustrated in FIGS. 60(a) and 60(b), and thereby it is possible to directly apply a stronger stimulus to the accurate Pacinian point by using the first contact portion 221B1 at the tip. Further, the pressing portion 220B can be favorably fitted in the palm by the first contact portion 221B1 at the tip. As a result, the sliding of the contact portion 221B (Pacinian ball) is suppressed, and the contact portion 221B (Pacinian ball) can be prevented from sliding and moving even if the user changes his/her posture in various ways during an exercise.

The shape according to the second modification example enables the first contact portion 221B1 to function as a pivot and enables the Pacinian point to be kept accurately pressed without positional displacement. As described above, since the Pacinian corpuscle is the sensory receptor having a size of about 1 mm, it is important not to displace the position of the pressing portion 220B in order to accurately stimulate the Pacinian point. In addition, when a diameter of the first contact portion 221B1 is very small, there is a possibility that too much pain is felt at the time of pressing. Therefore, the radius R_{B} is preferably R of about 0.5 mm to 5 mm.

In addition, in the second modification example, a portion (a portion on the base end side from the first contact portion 221B1, particularly, the second contact portion 221B2) of the pressing portion 220B other than the first contact portion 221B1 is larger than the first contact portion 221B1. Therefore, in the case where the palm is pressed by the first contact portion 221B1, the second contact portion 221B2 or the like positioned on the base end side from the first contact portion 221B1 function as a stopper. Hence, it is possible to prevent too much sinking and pressure from occurring at the time of pressing.

In addition, it is also possible to define an appropriate degree of pressing by a contact area between the pressing portion 220B (particularly, the first contact portion 221B1 or the second contact portion 221B2) and the palm. Then, the sizes of the first contact portion 221B1 and the second contact portion 221B2 can be determined such that the contact area falls within an appropriate value (or within a range).

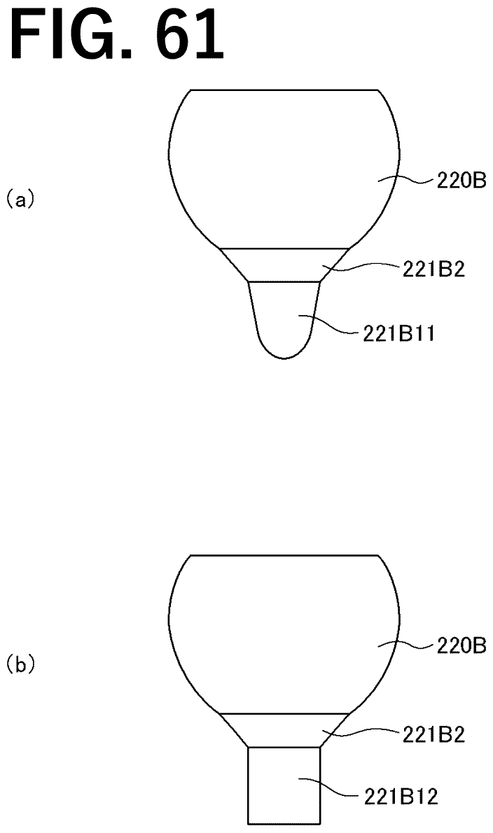

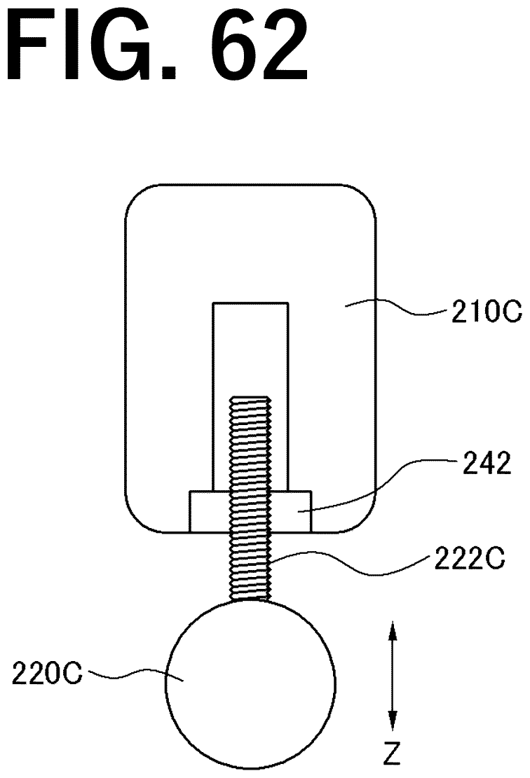

Note that the shape of the first contact portion 221B1 (a tip portion of the pressing portion 220B) may be, for example, a shape (including a curved surface shape) such as a conical shape or a pyramid shape, in addition to a true spherical shape, unless the shape is too much sharp. Here, in FIG. 60, in order to facilitate understanding of the three-dimensional shape of the pressing portion 220B, auxiliary lines connecting the tip to the base end are drawn on an outer peripheral surface at intervals of 90 degrees in a circumferential direction. In addition, FIG. 61(a) illustrates a first contact portion 221B11 that has a conical tip portion having a curved surface shape (may be a true spherical surface shape). Also in this case, the curved surface of the first contact portion 221B11 can be a curved surface substantially equal to a true spherical surface having R of 0.5 mm to 5 mm.

Further, the shape of the tip of the first contact portion 221B1 is not limited to the spherical shape (including the curved surface shape), and for example, as in a first contact portion 221B12 illustrated in FIG. 61(b), the entire shape may be a cylindrical shape, and the tip may be a flat surface. Further, a tip portion of the first contact portion 221B12 illustrated in FIG. 61(b) may have a curved surface shape (may be a true spherical surface shape). Also in this case, the curved surface of the first contact portion 221B12 can be a curved surface substantially equal to a true spherical surface having R of 0.5 mm to 5 mm. In addition, although not illustrated, the tip of the first contact portion 221B1 may have a polyhedral shape (including a regular polyhedral shape), a needle-attached spherical shape (including a curved surface shape, in which the needle-attached spherical shape is also referred to as a “star spherical shape” or the like), or the like.

### (Third Modification Example of Pressing Portion 220)

FIG. 62 schematically illustrates a pressing portion 220C according to a third modification example. The pressing portion 220C has a function of adjusting a height. As described above, a range of the increase in the range of motion of a joint changes by the pressure on the Pacinian corpuscle. In a case where the pressure changes to be increased in a stepwise manner (for example, a case where the level changes in the order of weak, medium, and strong), it is known that the range of motion of a joint increases the most in the case of a strong level of pressure up to a certain pressure.

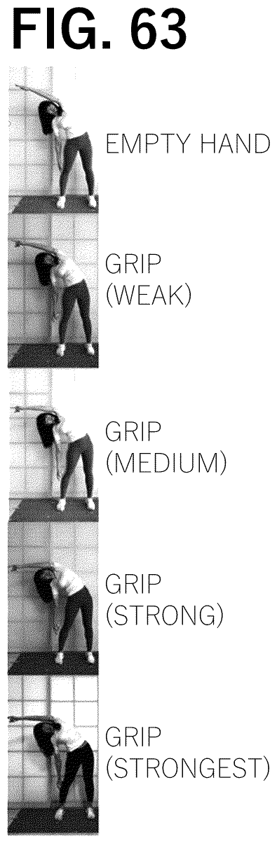

FIG. 63 sequentially illustrates photographic images of forms of lateral bending from the upper image to the lower image of the case of empty hands (in the state where nothing is grasped), the case where the instrument (grip) that presses the Pacinian corpuscle is gripped at a weak level of strength as in the first embodiment and the second embodiment, the case where the instrument (grip) is gripped at a medium level of strength, the case where the instrument (grip) is gripped at a strong level of strength, and the case where the instrument (grip) is gripped at a strength (strongest) higher than the strong level.

With reference to FIG. 63, the left arm of the subject reaches a position closer to the horizontal in the order of the case of the empty hands (the uppermost image), the low level, the medium level, and the strong level. However, when the image of the case of the strongest level (the lowermost image) in which the gripping force is stronger than that of the strong level is compared with the case of the strong level of the immediately upper image, the left arm of the subject does not have a change from that in the case of the strong level. As a result, the position of the arm is slightly higher at the strongest level than at the strong level.

As described above, when the pressure exceeds the pressure at the strong level, the force applied from the user's fingers (here, the little finger and the ring finger) to the instrument 200C is increased, and even when the maximum pressure that the user can exert is applied, the range of motion of a joint does not increase beyond the strong level.

Hence, by changing a protrusion amount of the pressing portion 220C from the main body portion 210C for each user and adjusting the height thereof, it is possible to obtain the same degree of pressure as in the case of exerting the maximum force, even if the user does not exert the maximum force. Consequently, it is possible to efficiently and maximally exhibit individualized effects (effects of increasing the range of motion of a joint) without using excessive force.

FIG. 62 schematically illustrates an example of a mechanism for maximizing the effects. A male screw is formed on a shaft portion 222C connected to the pressing portion 220C, and the shaft portion 222C is screwed into a nut 242 fixed to the main body portion 210C. For example, when the user picks up the pressing portion 220C and rotates the pressing portion 220C forward or backward about a shaft center, the shaft portion 222C moves forward or backward with respect to the main body portion 210C (moves in forward or backward directions of the Z-axis), and a protrusion amount of the pressing portion 220C with respect to the main body portion 210C changes. The shaft portion 222C and the nut 242 constitute a protrusion amount variable mechanism unit, and the protrusion amount of the pressing portion 220C is changed by the protrusion amount variable mechanism unit.

By employing the mechanism, a height of the pressing portion 220C can be adjusted, and an appropriate pressure generating function suitable for each user can be realized. Note that the mechanism for adjusting the height of the pressing portion 220C is not limited to that illustrated in FIG. 62 and can be variously changed. In addition, in FIG. 62, illustration of the ring portion is omitted.

### (Fourth Modification Example of Pressing Portion 220)

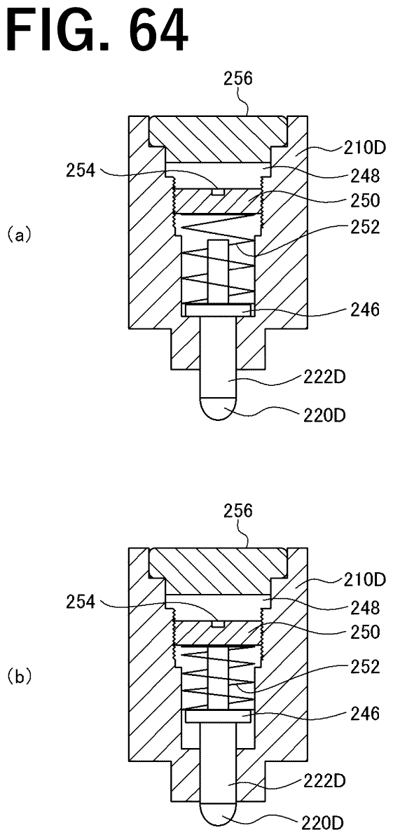

FIGS. 64(a) and 64(b) schematically illustrate a pressing portion 220D according to a fourth modification example. In the example illustrated in FIGS. 64(a) and 64(b), similarly to the example illustrated in FIG. 62, a height of the pressing portion 220D can be adjusted. However, in the example of FIGS. 64(a) and 64(b), the pressing portion 220D is integrally formed with a shaft portion 222D with the same diameter. In addition, the shaft portion 222D is molded in a stepped shape and has a flange portion 246 extending in a radial direction.

A columnar space portion 248 is formed in a main body portion 210D. The shaft portion 222D is inserted into the space portion 248 to be freely displaced in an axial direction in a state where the flange portion 246 is positioned in the space portion 248. A portion having a female screw is formed in a predetermined range on an inner circumferential surface of the space portion 248, and a disk portion 250 is screwed into the main body portion 210D.

A coil spring 252 is interposed between the disk portion 250 and the flange portion 246 of the shaft portion 222D. A portion of the shaft portion 222D closer to the disk portion 250 than the flange portion 246 is inserted into the coil spring 252. Both end portions of the coil spring 252 are in contact with the disk portion 250 and the flange portion 246, respectively.

A groove (driver groove) 254 for a flathead screwdriver is formed at a center of a plate surface of the disk portion 250 which is positioned on the opposite side to the coil spring 252. A lid 256 is mounted on the main body portion 210D, and one end portion (upper end portion in FIGS. 64(a) and 64(b)) of the space portion 248 is closed in an openable manner by the lid 256. The lid 256 can be detached from the main body portion 210D by being pulled up by a user hooking a finger or the like and can (detachably) close the space portion 248 by being inserted into the space portion 248.

As illustrated in FIG. 64(a), in a case where the pressing portion 220D does not receive an external force in the axial direction, the shaft portion 222D enters into a state of protruding from the main body portion 210D due to the elastic restoring force of the coil spring 252. The positions of the pressing portion 220D and the shaft portion 222D are fixed when the flange portion 246 is locked to the main body portion 210D.

FIG. 64(b) illustrates a state where the pressing portion 220D receives an external force in the axial direction. In this case, the coil spring 252 is compressed and elastically deformed via the flange portion 246, and the shaft portion 222D is immersed in the space portion 248 depending on a magnitude of the external force. Then, a protrusion amount of the pressing portion 220D from the main body portion 210D (the height of the pressing portion 220D) becomes smaller (the height becomes smaller) than that in a state where no external force is applied as illustrated in FIG. 40(a).

In FIG. 64(b), the shaft portion 222D is in contact with the disk portion 250, and the pressing portion 220D and the shaft portion 222D are stopped when the shaft portion 222D hits the disk portion 250. That is, at the time of immersion of the shaft portion 222D, the disk portion 250 functions as a stopper that determines the limit of an immersion amount.

As described above, also in the example illustrated in FIGS. 64(a) and 64(b), the height of the pressing portion 220D can be adjusted (the protrusion amount can be changed) similarly to the example illustrated in FIG. 62. Further, in the example illustrated in FIGS. 64(a) and 64(b), it is possible to easily generate a strong level of pressure by changing the elastic protrusion amount using the elastic restoring force of the coil spring 252.

In addition, in the example illustrated in FIGS. 64(a) and 64(b), a detachable lid 256 is provided on the main body portion 210D, and the driver groove 254 is provided in the disk portion 250. The lid 256 is screwed into the main body portion 210D and is in contact with the coil spring 252. From the above-provided descriptions, the elastic restoring force of the coil spring 252 can be changed by removing the lid 256 from the main body portion 210D and rotating the disk portion 250 forward or backward around the shaft center by using a flathead screwdriver.

Hence, for example, even when the user grips an instrument 200D with the same force, it is possible to finely change a pressing force by the pressing portion 220D depending on the position of the disk portion 250 and characteristics (spring constant and the like) of the coil spring 252.

Note that the mechanism for adjusting the height of the pressing portion 220D is not limited to that illustrated in FIGS. 64(a) and 64(b) and can be variously changed. In addition, in FIGS. 64(a) and 64(b), illustration of the ring portion is omitted.

### (Fifth Modification Example of Pressing Portion 220)

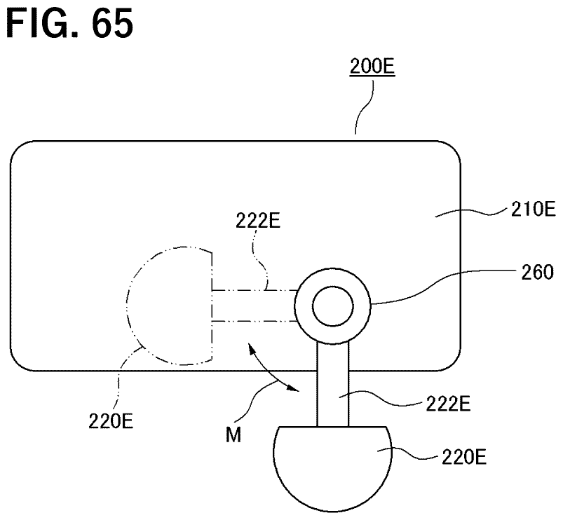

FIG. 65 schematically illustrates a pressing portion 220E according to a fourth modification example. In the fourth modification example, the pressing portion 220D can be housed in the main body portion 210D as represented by an arrow M or can be pulled out from the main body portion 210D. In this way, in a case where a user carries the instrument 200E in a bag (not illustrated) or the like, it is possible to prevent a pressing portion 220E protruding from the main body portion 210E from being caught in the periphery in the bag.

In the example of FIG. 65, the shaft portion 222E is connected to the main body portion 210E via a hinge portion 260 inside the main body portion 210E. As the hinge portion 260, various hinges can be employed. For example, it is conceivable to employ, as the hinge portion 260, one having a mechanism (ratchet mechanism or the like) that stops the pressing portion 220E and the shaft portion 222E at least in two stages of a state of protruding from the main body portion 210E and a state of being housed inside the main body portion 210E.

In addition, it is also conceivable that at least a part of the pressing portion 220E is exposed from a hole, a notch, or the like of the main body portion 210 so that the housed pressing portion 220E can be easily taken out from the main body portion 210E.

### Modification Examples of Main Body Portion 210

Next, various modification examples of the pressing portion 220 of the instrument 200 will be described. Note that portions similar to those of the instrument 200 of the second embodiment are denoted by the same reference numerals, and descriptions thereof will be omitted as appropriate.

### (First Modification Example of Main Body Portion 210)

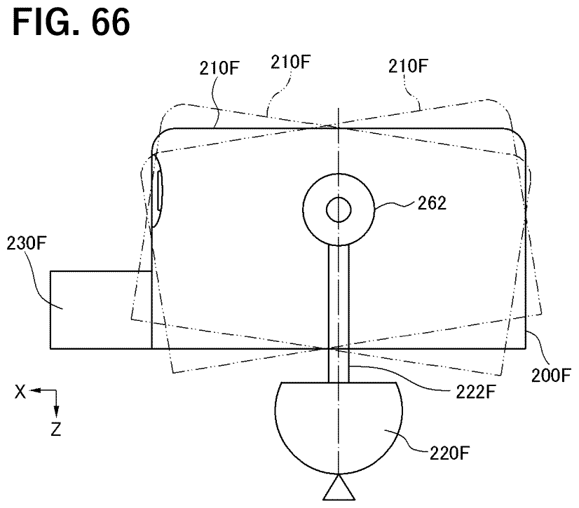

FIG. 66 schematically illustrates a main body portion 210F according to a first modification example. In the example of FIG. 66, the main body portion 210F is of a swing type in which the posture is tilted with respect to a shaft portion 222F (and a pressing portion 220F). The main body portion 210F can be tilted with respect to the shaft portion 222F (and the pressing portion 220F). The shaft portion 222F is connected to the main body portion 210F via a hinge portion 262. As the hinge portion 262, various hinges can be employed.

For example, it is conceivable to employ, as the hinge portion 262, one that can stop the main body portion 210F with respect to the shaft portion 222E by a frictional force. In addition, it is also conceivable to employ, as the hinge portion 262, one having a mechanism (ratchet mechanism or the like) that stops the shaft portion 222E in three or more stages.

In addition, in the example of FIG. 66, a relative positional relationship between a ring portion 230F and the main body portion 210F can also be changed by the swing of the main body portion 210F. In order to change the positional relationship, for example, it is conceivable that the ring portion 230F is made of a material such as a flexible synthetic resin, and a coupling portion (without reference numeral) with the main body portion 210F can be elastically deformed following the swing of the main body portion 210F.

### (Second Modification Example According to Main Body Portion 210)

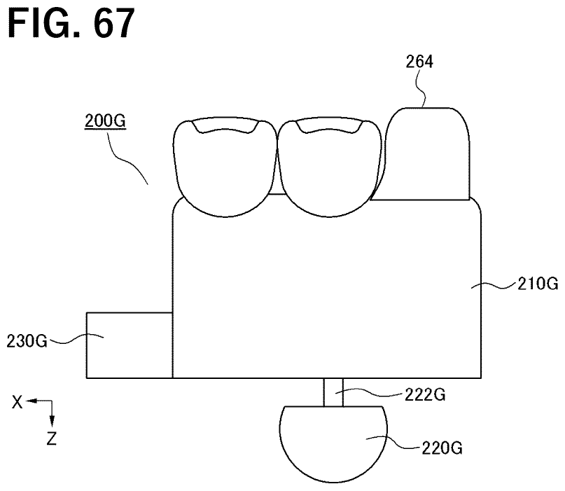

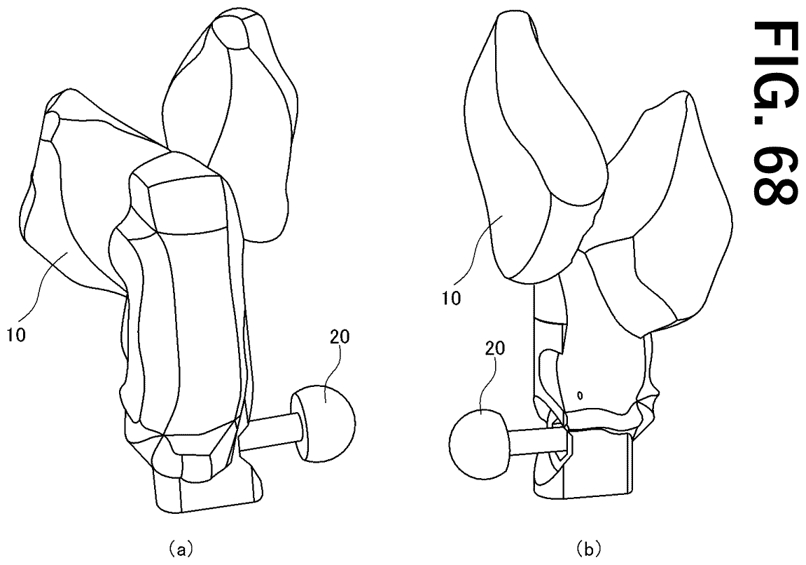

FIG. 67 schematically illustrates a main body portion 210G according to a second modification example. In the example of FIG. 67, a little finger stopper 264 capable of locking a little finger protrudes from the main body portion 210G. The little finger stopper 264 is provided to be reached by and lock a distal portion (first joint) of the little finger passing through the ring portion 230 (not illustrated in FIG. 67). The little finger stopper 264 may be integrally molded with the main body portion 210G or may be formed separately from the main body portion 210G and attached thereto later.

### Third Embodiment Relating to Instrument

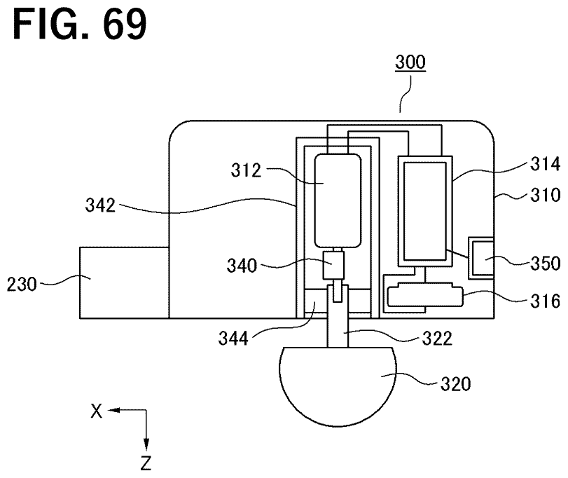

Subsequently, a third embodiment relating to the instrument will be described with reference to FIG. 69. FIG. 69 schematically illustrates an instrument 300 (grip) of a third embodiment. The instrument 300 of the third embodiment is of a ring model type, similarly to the instrument 200 according to the second embodiment. Therefore, in the following description, portions similar to those of the instrument 200 according to the second embodiment are denoted by the same reference numerals, and the description thereof will be omitted as appropriate.

### (Configuration of Instrument 300)

Similarly to the instrument 200 described above, the instrument 300 according to the third embodiment applies pressure stimulation to an accurate position of a Pacinian corpuscle to increase the range of motion of a joint. Further, the instrument 300 of the present embodiment has a vibrating function of vibrating a pressing portion 320. Inside a main body portion 310 of the instrument 300, a vibrating motor 312, a computer 314, and a built-in battery 316 are provided. Here, FIG. 69 schematically illustrates the instrument 300, and devices that are provided in a built-in manner in the instrument 300 are also illustrated by a solid line.

The vibrating motor 312 includes a vibrator (weight) 340 and constitutes a vibration applying unit together with the vibrator (weight) 340. The vibrating motor 312 rotationally displaces the vibrator 340 in an eccentric state and generates vibration within an XY plane by changing the position of the center of gravity. The pressing portion 320 is mounted on the vibrating motor 312 via a connecting portion 322. Although not illustrated, the vibrating motor 312 may be of a type in which the vibrator 340 is provided in a built-in manner and unitized in a case. In this case, the vibrating motor 312 can be used as a vibration applying unit.

The vibrating motor 312 is controlled by the computer 314 and rotates to generate vibration of a predetermined frequency (for example, 150 to 400 Hz). The vibration generated by the vibrating motor 312 is transmitted to the pressing portion 320, and the pressing portion 320 vibrates in the same manner. The frequency of the vibrating motor 312 changes under the control of the computer 314. Electric power for the vibrating motor 312 and the computer 314 is supplied by the built-in battery 316.

In the main body portion 310, the vibrating motor 312 is surrounded by a vibration-proof case 342. The vibration-proof case 342 has a function of preventing vibration generated by the vibrating motor 312 from being transmitted to the main body portion 310.

Reference numeral 344 in FIG. 69 denotes a lid body that closes an opening portion of the vibration-proof case 342 and allows the connecting portion 322 to penetrate. Further, reference numeral 350 in FIG. 69 denotes a storage device 350 provided in the main body portion 310. The storage device 350 can store data and the like for controlling the vibrating motor 312.

As the storage device 350, an external memory of the computer 314 or a memory device (such as an SD card) that can be taken out from the instrument 300 by a user can be employed. In addition, a built-in memory of the computer 314 can also be used for storing information.

According to the instrument 300, it is possible to vibrate the pressing portion 320 in a direction (in the example of FIG. 69, a direction orthogonal to) intersecting a direction (Z-axis direction) in which the pressing portion protrudes from the main body portion 310. Therefore, in addition to the same effect as that of the instrument 200 described above, it is possible to apply vibration to the Pacinian point. As compared with the above-described instrument 200, it is possible to selectively apply pressure stimulation to a Pacinian corpuscle more effectively.

The Pacinian corpuscle can be characterized in that the Pacinian corpuscle is a receptor that senses pressure and vibration. Further, the Pacinian corpuscle receives vibration at 100 to 300 Hz and is most sensitive to vibration around 200 Hz. It is possible to further improve the effect of using the instrument 300 by actively applying the pressure stimulation by using the characteristics of the Pacinian corpuscle.

Further, since it is possible to change the frequency, it is possible to generate vibration and pressure (change in pressure) appropriate to, for example, a tempo, a rhythm, a tune (melody), strength, and the like in music (including voice). A stimulus such as music can be input to the body via the instrument 300 and the Pacinian corpuscle and transmitted to the brain. As a result, the brain can simultaneously perceive auditory information from the ears and body sensory information from the Pacinian corpuscle. Further, the instrument 300 can function as a communication tool with the user via vibration or pressure (change in pressure). In addition, it is possible to perform communication using the palm in which a Pacinian corpuscle is present as if the palm were a second ear.

### Fourth Embodiment of Instrument

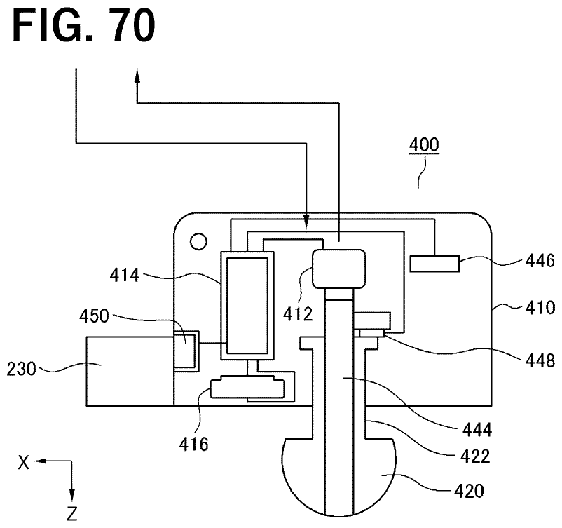

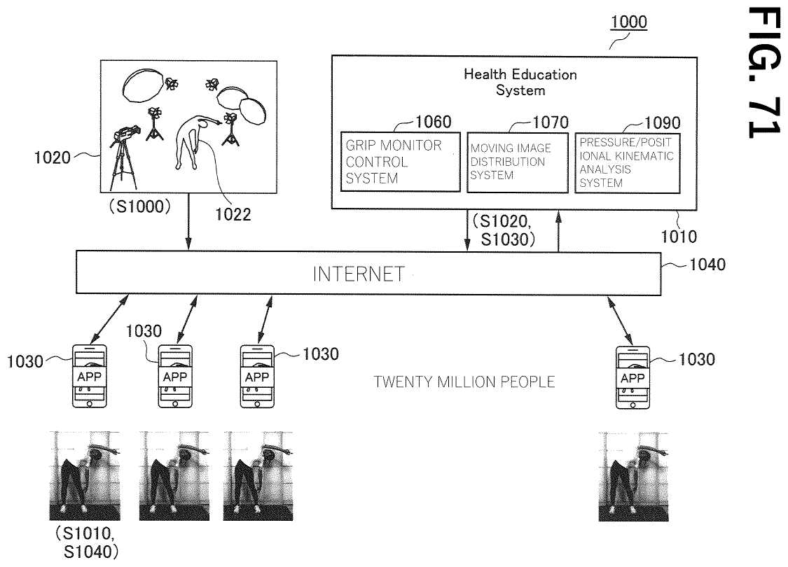

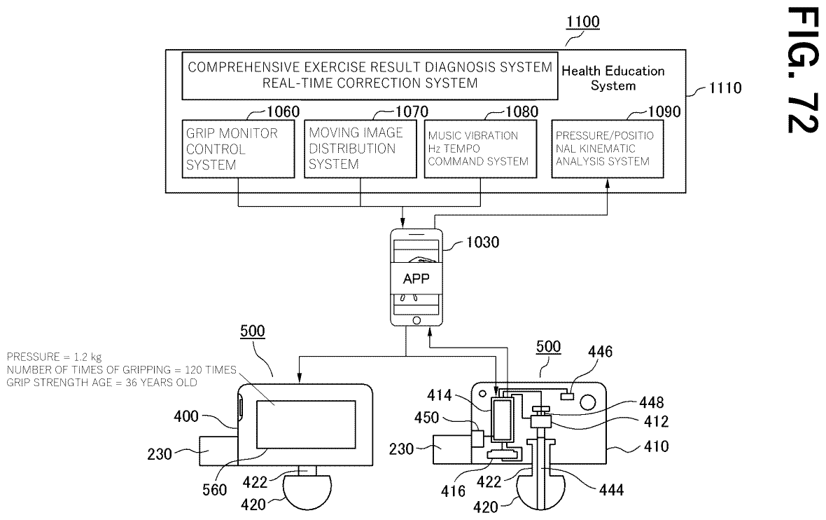

Subsequently, a fourth embodiment relating to the instrument will be described with reference to FIG. 70. FIG. 70 illustrates an instrument 400 (grip) of the fourth embodiment. The instrument 400 of the fourth embodiment is of a ring model type, similarly to the instrument 200 (FIG. 31) according to the second embodiment or the instrument 300 (FIG. 69) according to the third embodiment. Therefore, in the following description, portions similar to those of the instrument 200 according to the second embodiment or the instrument 300 (FIG. 69) according to the third embodiment are denoted by the same reference numerals, and the description thereof will be omitted as appropriate.

### (Configuration of Instrument 400)

Similarly to the instrument 200 or the instrument 300 described above, the instrument 400 according to the fourth embodiment applies pressure stimulation to an accurate position of a Pacinian corpuscle to increase the range of motion of a joint. Further, similarly to the instrument 300 according to the third embodiment, the instrument 400 of the present embodiment has a vibrating function of vibrating a pressing portion 420. In addition, the instrument 400 has a use state detecting function (state information detecting function) of detecting information (use state information as state information) on a use state of the instrument 400 such as a grasp force or a position.

Inside a main body portion 410 of the instrument 400, a vibrator 412, a computer 414, and a built-in battery 416 are provided. Of the components, as the vibrator 412, various general vibrators that vibrate with energization can be employed. As the vibrator 412, for example, a vibrator that generates vibration in the Z-axis direction by a piezoelectric element such as a piezo-element can be employed.

A vibration stick (vibration body) 444 is attached to the vibrator 412. As the vibration stick 444, a round stick or a square stick can be employed. Here, the vibrator 412 can be used as the vibration applying unit, or a combination of the vibrator 412 and the vibration stick 444 can be used as the vibration applying unit.

The vibration stick 444 is concentrically inserted into a tubular connecting portion 422 and penetrates the connecting portion 422 and the pressing portion 420. In the instrument 400 of the fourth embodiment, the connecting portion 422 is fixed so as not to be displaced with respect to the main body portion 410. The vibration stick 444 is gently inserted into the connecting portion 422 and the pressing portion 420 and vibrates in the axial direction (Z-axis direction) in the connecting portion 422 and the pressing portion 420. A tip portion of the vibration stick 444 protrudes somewhat (for example, about less than 1 mm) from the pressing portion 420 when the vibration stick 444 is displaced in a direction away from the main body portion 410 (downward in FIG. 70)

For example, a relationship between the pressing portion 420 and the vibration stick 444 can be described as follows. A part (here, a lower end side portion) of the vibration stick 444 is incorporated in the pressing portion 420, and the pressing portion 420 is configured to include a part of the vibration stick 444.

The vibrator 412 is controlled by the computer 414 and rotates to generate vibration of a predetermined frequency (for example, 150 to 400 Hz). The vibration generated by the vibrator 412 is transmitted to the vibration stick 444, and the vibration stick 444 vibrates in the same manner. The frequency of the vibrator 412 can be changed by control of the computer 414. Electric power for vibrator 412 and computer 414 is supplied by the built-in battery 416 (here, a button type).

In the main body portion 410, a position sensor 446 and a pressure sensor 448 as use state detecting units (and state detecting units) are provided. In a situation where the instrument 400 is grasped and used by a user, these units detect information related to a use state such as a movement amount and a grasp force.

Of the sensors, the position sensor 446 is provided to detect a position of the instrument 400 in a space. As the position sensor 446, for example, a sensor (acceleration sensor) that detects a change in acceleration can be employed. Information on a speed and displacement can be obtained through integral processing of an output of the acceleration sensor. An output signal (here, an acceleration signal) of the position sensor 446 is input to the computer 414, and the computer 414 can calculate a displacement amount of the instrument 400.

The pressure sensor 448 detects a reaction force (grasp force) when the instrument 400 is sandwiched between the palm and the fingers (the little finger and the ring finger) and the pressing portion 420 is pressed against the palm. In the computer 414, the pressure is calculated based on the output of the pressure sensor 448.

The outputs of the position sensor 446 and the pressure sensor 448 are used for arithmetic computation of the computer 414, and an arithmetic computation result of the computer 414 is stored in a storage device 450. As the storage device 450, various memory devices provided in the instrument 400 can be used.

As the memory device, an external memory of the computer 414 or a memory device (such as an SD card) that can be taken out from the instrument 400 by a user can be employed. In addition, a built-in memory of the computer 414 can also be used. The storage device 450 can store data and the like in advance for controlling the vibrating motor 312.

In addition, a communication circuit unit (not illustrated) is provided in a built-in manner in the instrument 400, and an output (an external output) of state information to an external device (not illustrated) and an input (an external input) of various items of information transmitted from the external device are performed. The communication circuit unit may be provided in a built-in manner in the computer 314 or may be externally attached to the computer 314. In addition, communication for an external output or an external input may be performed by, for example, wired connection via a USB cable or the like or may be performed by wireless connection via Wi-Fi, Bluetooth (registered trademark), or the like.

Examples of the external device include a smartphone, a mobile phone, a tablet terminal, a notebook PC, a desktop PC, an electronic book reader, a wearable computer, a portable game machine, and the like. In addition, an external output destination may be a server device or the like of a service provider which is connected via a communication network such as the Internet.

Note that, in a case where the instrument 400 is connected to these external devices (not illustrated), it is possible to externally output the detection results of the position sensor 446 and the pressure sensor 448 described above and perform arithmetic computation of use state information such as pressure and a displacement amount in the external devices.

According to the instrument 400, it is possible to detect a state by the position sensor 446 and the pressure sensor 448, in addition to obtaining the same effects as those of the instrument 200 or the instrument 300 described above. For example, the instrument 400 includes a liquid crystal display device or the like so that it is possible to perform a display of a result of state detection and a display based on the result. Further, the use of the communication function enables cooperation with an external device.

### [Invention Relating to Application to User Information Providing System]

Next, application of the instrument 1, the instrument 200, the instrument 300, the instrument 400, and the like of the respective embodiments described above to a user information providing system, multi-functionalization of the instruments which is suitable for the application thereof to the user information providing system, and the like will be described. Note that, in various exercise promotion systems to be described below; it is possible to appropriately select and use the instrument 1, the instrument 200, the instrument 300, the instrument 400, and the like of the respective embodiments. However, in a case where there is a particularly suitable instrument, a description will be provided using the suitable instrument.

### First Embodiment According to Invention of User Information Providing System

First, a first embodiment according to the invention of the user information providing system will be described with reference to FIG. 71. FIG. 71 schematically illustrates a configuration of an exercise promotion system 1000 considered as the user information providing system according to the first embodiment. The exercise promotion system 1000 is a system in which it is assumed that a plurality of people (for example, unit of several people to tens of millions of people) can perform an exercise (hereinafter, referred to as “grip exercise”) using an instrument (not limited to any instrument).

In the exercise promotion system 1000 illustrated in FIG. 71, an operating system (in FIG. 71, illustrated by a name of “Health Education System”) 1010 of a management center, an information processing device (not illustrated) of a capturing studio 1020, and a communication terminal 1030 owned by each individual are connected via a communication network 1040.

The operating system 1010 of the management center is constructed using a server device (not illustrated). The server device can be installed, for example, by an operating company of the exercise promotion system 1000. The operating system 1010 manages the exercise promotion system 1000 by using a central processing unit (CPU), a ROM, a RAM, and the like.

The CPU is a processor that executes various types of arithmetic processing. The ROM is a non-volatile storage unit in which control programs such as a basic input output system (BIOS) and an operating system (OS) for causing the CPU to execute various types of arithmetic processing are stored in advance. The RAM is a volatile or non-volatile storage unit that stores various items of information and is used as a temporary storage memory (work area) for various types of processing executed by the CPU. The operating system 1010 causes the CPU to execute various control programs stored in advance in the storage unit such as the ROM, thereby performing processing for managing the exercise promotion system 1000.

Here, the operating system 1010 may be configured to include one server device or a plurality of server devices in which functions are distributed. In addition, the operating system 1010 may also be referred to as an “operating device” or the like.

As the information processing device of the capturing studio 1020, a general desktop PC, a notebook PC, a server device, or the like can be employed. As will be described below; the information processing device of the capturing studio 1020 enables a moving image captured by a camera in the capturing studio 1020 to be distributed to each individual via the communication network 1040. The information processing device of the capturing studio 1020 may be a smartphone, a tablet terminal, or the like that is an information processing device integrally provided with a camera. Further, the information processing device of the capturing studio 1020 may be integrated with a server device in the operating system 1010 of the management center.

As the communication terminal 1030 owned by each individual, a smartphone, a mobile phone, a tablet terminal, a notebook PC, a desktop PC, a television receiver, an electronic book reader, a wearable computer, a portable game machine, or the like can be employed. Examples of the communication network 1040 include a network (including a so-called cloud) connected to each other via the Internet, a LAN, a WAN, a public phone line, a base station, a mobile communication network, a gateway, or the like.

In this exercise promotion system 1000, an instructor 1022 performs an exercise (grip exercise) while stimulating a Pacinian point by using the instrument (for example, the instrument 400) in the capturing studio 1020. Examples of types of grip exercises include stretching, yoga, and muscle training included in the above-described applications. Further, the grip exercises can also be exemplified with model movements of various games, movements of rehabilitation, and the like.

Movements of the instructor 1022 are captured as a moving image in the capturing studio 1020. Further, the moving image obtained by imaging the instructor 1022 is transmitted to the communication network 1040 and distributed to a large number of communication terminals 1030 via the communication network 1040 (step(S) 1000). Here, as steps from moving image capturing to distribution, various general steps can be employed.

For example, it is possible to perform processing for distribution (so-called live streaming) at the same time as capturing, perform moving image distribution after a predetermined time has elapsed after capturing of the moving image, or the like. In addition, it is also possible to perform distribution after editing the moving image after the capturing. Further, in the distribution of the moving image, moving image data may be transferred to the operating system 1010 of the management center or may be stored in the operating system 1010 of the management center and then distributed to the communication terminal 1030.

Application software (so-called app) capable of displaying the distributed moving image, performing an input related to the moving image, and the like is installed in the communication terminal 1030 of each individual. In FIG. 71, a portion having characters “APP” drawn in an overlapping manner with the communication terminal 1030 schematically indicates that the application software is installed in the communication terminal 1030.

Each individual also possesses the instrument (for example, the instrument 400) and performs a grip exercise following the instructor 1022 while watching a moving image displayed on the communication terminal 1030 (S1010). Each individual who is a user of the instrument (for example, the instrument 400) becomes a participant of a grip exercise (world simultaneous grip exercise) simultaneously performed around the world, and a mass scale grip exercise (large-scale grip exercise) on a scale of ten million people (about twenty million people in FIG. 71) can be simultaneously performed around the world while the people watch the communication terminal 1030.

In this manner, the communication terminal 1030, the instrument (for example, the instrument 400), and the brain of each individual who has received a nerve transmission signal from the instrument (for example, the instrument 400) constitute one network. Then, the exercise promotion system 1000 for the purpose of maintaining and improving motor skills of each individual is constructed using this network.

In addition, the application software installed in the communication terminal 1030 has a function of displaying, for example, the number of individuals (the number of participants) participating in the large-scale grip exercise on the communication terminal 1030. In order to perform such a display, the operating system 1010 collects information (state information) obtained via the communication network 1040 and the communication terminal 1030, specifically, via the application software of the communication terminal 1030 (S1020).

In addition, not only an image of the instructor 1022 but also information (also referred to as “reference exercise information”, “standard exercise information”, “instruction information”, “model information”, or the like) of a standard exercise state (a tempo and a rhythm of an exercise, a size of movement of arms, or the like) can be output to the communication terminal 1030 in terms of characters or numerical values (including voice output) to be presented to the user.

Further, the reference exercise information can be presented via vibration or vertical movement (movement of the pressing portion 420 in a protruding direction) generated by the instrument 400. In this case, for example, the reference exercise information is presented to the user by causing the instrument 400 to generate the vibration or the vertical movement synchronized with a rhythm, a tempo, or the like of a standard exercise.

As described above, by presenting the reference exercise information via the instrument 400, it is possible to generate a signal transmitted from a Pacinian corpuscle to a brain. Further, in a case where the reference exercise information by a video or music and the reference exercise information transmitted from the instrument 400 are simultaneously combined (synchronized) and output, visual information, auditory information, and information from the Pacinian corpuscle are integrally transmitted to the brain of the user. Therefore, it is possible to perform information transmission in a novel and unprecedented mode.

In the exercise promotion system 1000, when a mass scale grip exercise (large-scale grip exercise) is performed using the multi-functional instrument 400 having a vibrating function and an information collecting function, a state of each individual is detected. A result of the state detection is received by the communication terminal 1030 from the instrument 400 and transmitted from the communication terminal 1030 to the operating system 1010 of the management center via the communication network 1040. Here, the instrument 400 may have a function of communicating with an operating system 1010 via the communication network 1040.

In the operating system 1010, various internal systems operate, and exercise promotion information as user information is transmitted to the communication terminal 1030 (S1030). Although not illustrated, various internal systems of the operating system 1010 can be exemplified with a grip monitor control system 1060, a moving image distribution system 1070, a pressure/positional kinematic analysis system 1090, and the like.

Here, the “grip monitor control system”, the “moving image distribution system”, and the “pressure/positional kinematic analysis system” can also be referred to as, for example, a “grip monitor control unit”, a “moving image distribution unit”, a “pressure/positional kinematic analysis unit”, and the like.

Of the systems, the grip monitor control system 1060 is a system that controls contents displayed on a display device in a case where the instrument 400 includes the display device. Information for a display performed by the instrument 400 may be transmitted from the grip monitor control system 1060 to the instrument 400 via the communication terminal 1030 or may be transmitted skipping the communication terminal 1030.

The moving image distribution system 1070 is a system that controls distribution of a moving image to the communication terminal 1030. In addition, the pressure/positional kinematic analysis system 1090 is a system that receives state information sent from an instrument 500 via the communication terminal 1030 and analyzes the state information.

In the operating system 1010, for example, the pressure/positional kinematic analysis system 1090 analyzes information (use state information as the state information) obtained from the communication terminal 1030 of each individual and computes a statistical value (for example, total, mean, standard deviation, ranking, or the like) in data of a large number of people (big data). Further, an arithmetic computation result is classified for each attribute such as gender or age, and a correlation with individual information is obtained. Then, for the individual information, for example, comparison information of ranking, a deviation value, and the like is computed, and the obtained arithmetic computation result is transmitted to the corresponding individual.

Information (user information) based on the arithmetic computation result is displayed on, for example, the communication terminal 1030 or the instrument 400 and is notified to the corresponding individual (S1040). Examples of the information displayed (presented) on the communication terminal 1030 and the instrument 400 include the number of individuals (the number of participants) participating in the large-scale grip exercise described above, the ranking described above, and the like. These items of information indicate positioning of each individual among the large number of people.

As described above, the positioning among the large number of people is transmitted and notified to the corresponding individual, and thereby it is possible to encourage the participants in the large-scale grip exercise to be competitive or motivate the participants to continue the exercise. Here, a process of generating information to be returned to an individual by using big data may be performed by statistical machine learning by AI, deep learning, or the like.

The grip exercise and play elements can be combined by displaying the number of participants and displaying the ranking or the like as described above. That is, in recent years, it has been difficult to secure time to exercise in a sports gym or the like due to a double income, a new coronavirus, or the like. Thus, there is an increasing demand for exercise performed by one person in a narrow place such as home.

Thus, by performing the grip exercise at the same time with a large number of people and notifying the participants of the number of participants, it is possible to motivate each individual to perform the grip exercise. For example, even if a person performs the grip exercise alone in his/her own place at the same time every day, the person can feel that he or she performs the grip exercise together with many people, and this can be an incentive to continue the grip exercise. Information (user information) presented to the user is not limited to information presented to the user immediately (in real time) on the basis of the collected information. For example, information on the past exercise history may be presented in units such as one day, one week, one month, or one year. The same applies to various embodiments and modification examples to be described below.

In addition, as described above, since the reference exercise information serving as model information for the exercise by the user is transmitted so that the user can exercise on the basis of the model information, the user can exercise after obtaining the information on an appropriate exercise. Thereafter, in the operating system 1010, for example, acceleration information, speed information, and position information (use state information as state information) in the motion of a hand are acquired for each individual, and personal user information can be fed back to the user. Through such mutual communication, the user can reflect (self-reflect, mirror, and the like) by himself/herself and learn a relationship between his/her body and exercise. The user information providing system can also be referred to as an “exercise education/reflection system” or the like.

It can be described that the exercise promotion system 1000 of the present embodiment is a combination of the grip exercise and play elements. A play has various definitions. For example, according to “classification of plays” by Roger Caillois, the play is considered to be competition, movement, simulation, dizziness, or a game. In addition, according to the “concept of play” by Johan Huizinga, play is a voluntary act or activity performed within a certain clearly defined time/space.

Then, according to the exercise promotion system 1000 of the present embodiment, as a result of video distribution and the mutual communication with the state information of the individual in response to the distribution, the large-scale grip exercise adapted to various plays can be performed. It is also possible to combine audio of contents for encouraging participation in the grip exercise with the video distribution, or to encourage participation in the grip exercise only by audio depending on situations.

The exercise promotion system (user information providing system) 1000 can also be used as follows. First, the reference exercise information to be presented to the user is information that conveys an exercise program corresponding to each age group (assumed from children to about 90 's) and created from the viewpoint of physical education pedagogy, exercise/movement science, sports psychology, and the like. The reference exercise information is presented by live broadcasting from the capturing studio 1020 or moving image distribution using a moving image stored in the server device. The above-described “exercise program” includes, for example, exercise components such as a rhythm, a tempo, an accurate position, and a form.

In order to optimize the exercise by the user according to the reference exercise information, the rhythm and the tempo of the exercise program are essential components. Therefore, it is necessary to present the exercise program to the user, depending on motor skills of each age group or individual. According to knowledge of the inventors and the like, in many cases, a user is easily motivated and easily figures out an appropriate exercise speed by adjusting (adjusting a timing of) the exercise to music in which a melody is added to a rhythm and a tempo. The user performs an exercise according to a moving image or the like in accordance with an exercise program created in consideration of these above-described points.

After the user starts to exercise, in the step of collecting the state information, a state of the instrument 400 such as position data, movement acceleration data, or a change in the grasp force of the instrument 400 is transmitted to the operating system 1010 by state information detecting means (such as the position sensor 446 or the pressure sensor 448) mounted on the instrument 400.

Subsequently, the operating system 1010 presents an analysis result to the user on the basis of the analysis program and notifies the user of the analysis result. In the analysis, in a case where it is determined that the user is performing an incomplete exercise or an exercise that does not meet a reference on the basis of the transmitted various items of state information, analysis is performed to determine which item is involved of the items such as a tempo, a rhythm, an accurate position, and a form of the above-described exercise components. Then, a learning task (ideal learning task) for improving the movement of the corresponding user is selected on the basis of the analysis result, and an exercise task of the corresponding user is derived on the basis of a predetermined derivation condition obtained by integrating a quantitative condition and a qualitative condition of the movement.

This derived result may be presented to the user, and the user may begin to know his/her state and think about what to improve. Then, the user continues the exercise using the instrument 400 with a purpose such that the user's exercise is improved. A cycle of such an approach to the user and exercise performance of the user can be referred to as a cycle of education and reflection.

### Second Embodiment According to Invention of User Information Providing System

Next, a second embodiment according to the invention of the user information providing system will be described with reference to FIG. 72. Note that portions similar to those of the fourth embodiment of the instrument or the first embodiment according to the invention of the exercise promotion system are denoted by the same reference numerals, and the description thereof will be omitted as appropriate.

As a user information providing system according to the second embodiment, an exercise promotion system 1100 has been studied. Similarly to the exercise promotion system 1000 according to the first embodiment, the exercise promotion system 1100 is a system assuming that a large number of people (for example, ten million people) perform the grip exercise.

In the exercise promotion system 1100 illustrated in FIG. 72, an operating system (in FIG. 72, illustrated as “Health Education System”) 1110 of a management center, and a communication terminal 1030 owned by each individual are connected via a communication network (not illustrated). Although not illustrated, as the communication network, one similar to the communication network 1040 of the exercise promotion system 1000 according to the first embodiment can be applied. In addition, the operating system 1110 can also have a hardware configuration similar to that of the operating system 1010 according to the first embodiment.

FIG. 72 illustrates a case where the instrument 500 is used in the exercise promotion system 1100. The instrument 500 illustrated in FIG. 72 includes a vibrator 412, a computer 414, a built-in battery 416, a position sensor 446, a pressure sensor 448, and the like, similarly to the instrument 400 described in the fourth embodiment relating to the instrument. The instrument 500 has a vibrating function and a state detecting function.

A communication circuit unit (not illustrated) is provided in a built-in manner in the instrument 500, and the above-described state information can be externally output. As the communication circuit unit (not illustrated), one having the same configuration and function as those of the above-described instrument 400 can be employed. Here, it is also possible to provide the instrument 500 having a function of communicating with the operating system 1110 via the above-described communication network (1040 with reference to FIG. 71).

Further, as illustrated on the left side of the lower diagram in FIG. 72, the instrument 500 includes a display device 560. The display device 560 is disposed on an outer surface of the main body portion 410, and can display state information or information such as a user attribute under the control of the computer 414. In FIG. 72, the instrument 500, in which internal devices of the main body portion 410 are schematically illustrated, is illustrated on the right side of the lowermost diagram, and the instrument 500, in which the outside of the main body portion 410 is illustrated, is described on the left side thereof. That is, in the lowermost diagram of FIG. 72, an internal configuration and an external configuration of one instrument 500 are illustrated side by side on the right and left sides.

In FIG. 72, names of a “comprehensive exercise result diagnosis system” and a “real-time correction system” are separately illustrated for the operating system 1110. In the operating system 1110, various internal systems operate, and exercise promotion information as user information is transmitted to the communication terminal 1030. As various internal systems of the operating system 1110, FIG. 72 illustrates a grip monitor control system 1160, a moving image distribution system 1170, a music vibration Hz tempo command system 1180, and a pressure/positional kinematic analysis system 1190 from the left.

Of these systems, the grip monitor control system 1160 is a system that controls contents displayed on the display device 560 of the instrument 500, similarly to the grip monitor control system (not illustrated) described above. The moving image distribution system 1170 is also a system that controls distribution of a moving image to the communication terminal 1030, similarly to the moving image distribution system (not illustrated) described above.

The music vibration Hz tempo command system 1180 is a system that transmits, to the communication terminal 1030, information corresponding to a tempo of music (including BGM of the moving image) distributed to the communication terminal 1030. Further, the pressure/positional kinematic analysis system 1190 is a system that receives the state information sent from the instrument 500 via the communication terminal 1030, similarly to the pressure/positional kinematic analysis system (not illustrated) described above.

In the operating system 1110, similarly to the operating system 1010 according to the first embodiment, the information obtained from the communication terminal 1030 of each individual is analyzed, a statistical value is computed, and an arithmetic computation result of comparison information of ranking, a deviation value, and the like is transmitted to the corresponding individual. Information based on the arithmetic computation result is displayed on, for example, the communication terminal 1030 and is notified to the corresponding individual.

More specifically, a video of a grip exercise captured by the capturing studio 1020 (refer to FIG. 71) is distributed to the communication terminal 1030 of each individual by the moving image distribution system 1170 of the operating system 1110. An individual who receives the distribution of the moving image performs a grip exercise following the moving image displayed on the communication terminal 1030. Since the distribution of the moving image is performed for a large number of individuals, a large-scale grip exercise can be performed.

A piece of music is distributed together with a video of the grip exercise. The music vibration Hz tempo command system 1180 of the operating system 1110 transmits command information for driving the vibrator 412 of the instrument 500 to the communication terminal 1030 of each individual according to an element affecting a tune such as a tempo, a rhythm, a tune (melody), and strength of the music.

The vibrator 412 vibrates according to elements such as the tempo, the rhythm, and the strength of the music, and the vibration of the vibrator 412 is transmitted to the vibration stick 444. Then, the vibration of the vibrator 412 is transmitted to the individual who grips the instrument 500, via the vibration stick 444. Note that a vibration generating mechanism is not limited to a type in which the vibrator 412 vibrates the vibration stick 444, and for example, as illustrated in FIG. 69, a type of vibration generating mechanism in which the pressing portion 220 vibrates can also be employed.

Subsequently, information on an output of the position sensor 446 and the pressure sensor 448 is transmitted to the operating system 1110 via the communication terminal 1030. In the operating system 1110, an exercise condition of an individual is analyzed by the pressure/positional kinematic analysis system 1190. Then, information is transmitted from the grip monitor control system 1160 to the communication terminal 1030, and the instrument 500 displays the information received from the communication terminal 1030 on the display device 560.

Examples of the information displayed on the display device 560 can include a diagnosis result indicating strength or time of exercise, an exercise technique correction proposal (an increase in exercise time, making large movements, or the like), or information considered to be useful for other individuals. In the example of FIG. 72, the display device 560 of the instrument 500 displays a pressure to grip the instrument 500 (1.2 kg), the number of times of gripping (120 times), and the age (36 years old) estimated from grip strength.

In addition, as the information to be notified to the individual, it is conceivable to compare information with the information of the individual stored so far on the basis of detection results (arithmetic computation results) of the speed of walking, jogging, or the like, determine whether the physical condition is good, and suggest a break or picking a pace up. Further, it is also conceivable to issue a command to change a tempo of the exercise by the vibration generated by the instrument 500.

As described above, it is possible to provide useful information (information such as suggestion, guidance, or advice) to an individual performing the grip exercise via the operating system 1110. The output of the useful information may be performed by any one of the instrument 500 and the communication terminal 1030 or may be performed by both of them. In a case where both the instrument 500 and the communication terminal 1030 output a suggestion or an instruction, the same display content or voice output content may be used, or different content may be used.

### Third Embodiment According to Invention of User Information Providing System

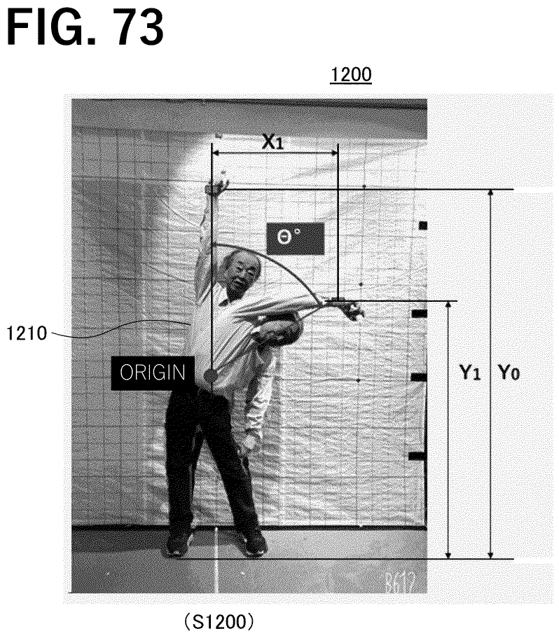

Next, a third embodiment according to the invention of the exercise promotion system will be described with reference to FIG. 73. Note that portions similar to those of the above-described instrument (the instrument 400, the instrument 500, or the like) or the second embodiment according to the invention of the exercise promotion system (the exercise promotion system 1100 in FIG. 72) are denoted by the same reference numerals, and the description thereof will be omitted as appropriate.

As a user information providing system according to the third embodiment, an exercise promotion system 1200 has been studied. Similarly to the exercise promotion system 1100 according to the second embodiment, the exercise promotion system 1200 also promotes exercise of each individual through mutual communication of information related to the grip exercise.

First, it is reported that the grip strength and the muscle strength of the entire body are proportional to each other. In addition, a decline in flexibility of the body is a cause falls in the aging population. Examples of descriptions related to this include that “The grip strength has been reported to indicate general fitness. It has been reported that the lower the grip strength, the higher the incidence rate of deterioration in physical function and impairment of daily movements, and the higher the mortality rate (Newman et al., 2006).” at the beginning of “Effect of Habitual Exercise on Health: Grip Strength as an Indicator” by Aoi Nakamaru et al.

In addition, in “Overview of Survey Results on Physical Fitness and Motor Skill in 2014” by the Ministry of Education, Culture, Sports, Science and Technology (2015), results of a survey on the trend of a change with aging by measuring the grip strength as an indicator of the muscle strength are also reported.

https://www.mext.go.jp/sports/b_menu/toukei/chousa04/tairyoku/kekka/k_detail/1368152.htm

Based on the reports, in the exercise promotion system 1200 according to the present embodiment, data related to the grip strength is collected using an information collecting function of the instrument such as the instrument 400 or the instrument 500 (step(S) 1200). In the exercise promotion system 1200, a hardware configuration similar to that of the exercise promotion system 1000 according to the first embodiment can be employed.

In the exercise promotion system 1200 according to the present embodiment, for example, the pressure sensor 448 detects and measures, by the instrument 500, the pressure by the little finger and the ring finger of an individual 1210 who grips the instrument 500. Then, the measurement result is stored in the storage device 450 of the instrument 500. It is possible to calculate information on the grip strength (grasp force) of an individual who has gripped the instrument 500 on the basis of the information on the pressure. In order to convert the pressure into the grip strength (grasp force), for example, it is conceivable to multiply a value of the pressure by an integer or obtain a product of the value of the pressure and a predetermined coefficient.

Subsequently, the position sensor 446 provided in a built-in manner in the instrument 500 detects and measures the position of the instrument 500. As described above, for example, an acceleration sensor can be employed as the position sensor 446, and a displacement amount can be calculated by integrating an output of the acceleration sensor. By setting a predetermined origin as will be described below; information on the displacement amount can be converted into the position information.

Measurement results of the grasp force and the position are stored in the storage device 450 of the instrument 500. In addition, a menu of measurement exercises is determined in advance and stored in the instrument 500 or the operating system 1110. The “measurement exercises” mean exercises to be measured (measurement target exercises). Examples of the menu of the measurement exercises include forward bending and lateral bending.

When the measurement exercises are performed, a file in which data of the measured grasp force (grasp force data) and data of the position (position data) are stored is transferred to the operating system (“Health Education System” with reference to FIG. 72) of the management center via the communication terminal 1030 (S1210). In the operating system of the management center, the origin is set using the position data of the instrument 500, and a value of an indicator based on the origin is calculated (S1220).

In the example of FIG. 73, regarding an individual, the origin is set at an upper center of the waist (around the navel position), and an angle obtained during the lateral bending around the origin is set as one indicator (θ). Then, the instrument 500 measures a value θ° of the indicator of the angle between an orientation of an arm (an orientation of the arm before lateral bending) obtained by stretching the arm (the right arm in this case) to be straight upward from the floor surface on which the individual is standing and an orientation of the arm during the lateral bending.

Further, an indicator (X) in the horizontal direction and an indicator (Y) in a height direction are also set. In the example of FIG. 73, a displacement amount of a position of the hand in the horizontal direction (a horizontal displacement amount in a lateral bending direction) is set as a value X1 of the indicator X. In addition, a value of the indicator Y of a height from the floor surface is set as Y0 for the hand before the lateral bending, and a value of the height from the floor surface is set as Y1 for the hand during the lateral bending.

These indicators are indicators indicating flexibility of an individual who has performed the grip exercise. For example, it can be determined that the larger the value θ° of the angle during the lateral bending, or the larger the value X1 of the horizontal displacement amount, the higher the flexibility of an individual. In addition, it can be determined that the smaller the arithmetic computation result of Y1/Y0, the higher the flexibility of the individual.

For these indicators, data of a large number of people is collected in advance together with data (attribute data) such as age or gender, and AI learning is performed on the collected data for the purpose of calculating an age. Then, an age is calculated from data of indicators collected from an individual on the basis of the result of the AI learning, and the obtained age is displayed as an estimated physical strength age on the instrument 500 (or the communication terminal 1030) of the individual who has performed the grip exercise (S1230).

Further, the operating system (the operating system 1110 with reference to FIG. 72) of the management center causes the instrument 500 (or the communication terminal 1030) of the individual who has performed the grip exercise to display a name and contents of a physical exercise program for enhancing flexibility by a physical exercise using the instrument 500 and notifies the name and the contents of the physical exercise program (S1240).

The operating system (the operating system 1110 with reference to FIG. 72) of the management center collects subsequent information on the individual to be notified (S1250). Then, it is determined whether or not the notified physical exercise program is habitually performed on the basis of detection results of the position sensor 446 and the pressure sensor 448. Then, it is determined whether or not flexibility is improved with reference to the values of the indicators (S1260), and a display according to the determination result is performed on the display device 560 (or the communication terminal 1030) of the instrument 500 on the basis of the determination result (S1270).

With this display, whether or not flexibility is increased (whether or not the rejuvenation effect is exhibited) is notified to the individual. It is also possible to combine sound with the display at this time or to notify the effect of the grip exercise only by sound.

### Fourth Embodiment According to Invention of User Information Providing System

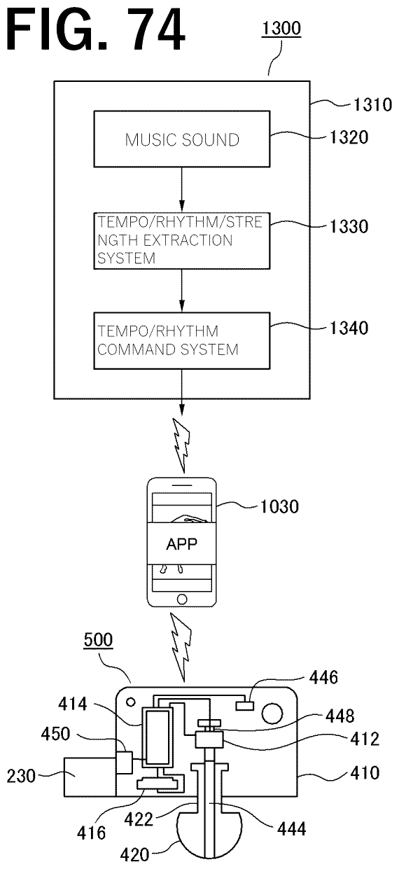

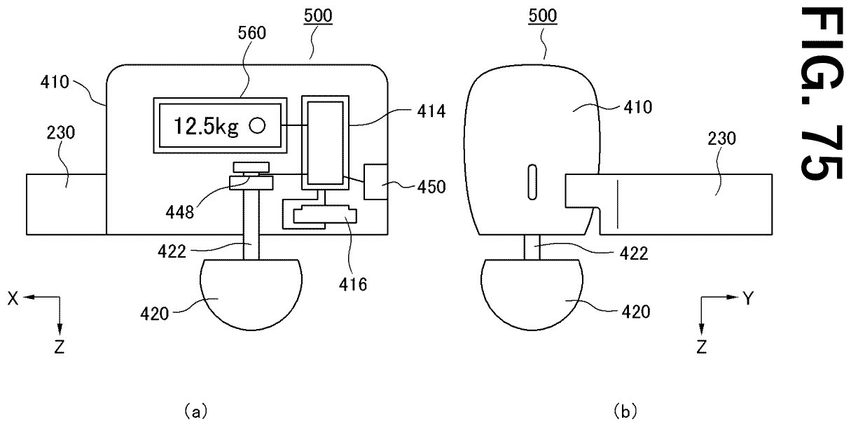

Next, a fourth embodiment according to the invention of the exercise promotion system will be described with reference to FIG. 74. Note that portions similar to those of the above-described instrument (the instrument 400, the instrument 500, or the like) or the second embodiment according to the invention of the exercise promotion system (the exercise promotion system 1100 in FIG. 72) are denoted by the same reference numerals, and the description thereof will be omitted as appropriate.

As a user information providing system according to the fourth embodiment, an exercise promotion system 1300 has been studied. Similarly to the exercise promotion system 1100 according to the second embodiment, the exercise promotion system 1300 also promotes exercise of each individual through mutual communication of information related to the grip exercise. Further, the exercise promotion system 1300 prevents the sensitivity of vibration at a Pacinian corpuscle from decreasing and enables the effect of the grip movement to be continuously exhibited.

First, as described above, the Pacinian corpuscle can be characterized in that the Pacinian corpuscle is a receptor that senses pressure and vibration. Further, the Pacinian corpuscle receives vibration at 100 to 300 Hz and is most sensitive to vibration around 200 Hz. However, in a case where vibration of a constant frequency is continuously applied, vibration is perceived with high sensitivity at the beginning of vibration application, but if this state is maintained, the Pacinian corpuscle adapts to the vibration, and it becomes difficult to perceive the vibration.

In addition, when the instrument 500 is grasped and the grip exercise is performed, the grasp force changes with the movement of the body, and the pressure transmitted to the Pacinian corpuscle changes. Therefore, when the grasp force changes, the Pacinian corpuscle does not adapt to the change, and the effect of use of the instrument 500 is maintained.

In the exercise promotion system 1300 of the present embodiment, the adaptation of the Pacinian corpuscle is prevented by focusing on the above-described points and adding more applications thereof. More specifically, the frequency and the pressure transmitted to the Pacinian corpuscle are changed following the tempo and the rhythm of music to prevent the adaptation of the Pacinian corpuscle. The pressure transmitted to the Pacinian corpuscle can be always changed depending on the change in the grasp force and the change in the vibration at the time of the grip exercise.

As illustrated in FIG. 74, in the exercise promotion system 1300, an operating system 1310 of the management center includes a tempo/rhythm/strength extraction system 1330 and a tempo/rhythm command system 1340. Of these systems, the tempo/rhythm/strength extraction system 1330 has a function of extracting information on the tempo, the rhythm, and the strength of a sound from any music sound (here, music or the like is denoted by reference numeral 1320) stored in a storage device (not illustrated) and converting the information into data. Elements such as the tempo, the rhythm, and the strength in the music sound affect a tone.

The tempo/rhythm command system 1340 performs data conversion on the data of the tempo/rhythm/strength extracted by the tempo/rhythm/strength extraction system 1330 and creates vibration mode information to be instructed to the instrument 500. The vibration mode information includes information such as a frequency of vibration generated by the instrument 500.

The tempo/rhythm command system 1340 transmits the vibration mode information to the communication terminal 1030 of an individual via a communication network (not illustrated). As the communication network, one similar to the communication network 1040 of the exercise promotion system 1000 according to the first embodiment can be applied. In addition, the tempo/rhythm command system 1340 also transmits music sound information on music of a music sound or the like to the communication terminal 1030. Examples of the music sound information include information for identifying music, music sound data of the music itself, and the like.

The communication terminal 1030 transmits a command to the instrument 500 by application software (so-called app) installed in advance and notifies the instrument 500 of the vibration mode information. The communication terminal 1030 outputs music or the like as a music sound on the basis of the music sound information described above. An individual possessing the communication terminal 1030 can recognize a music sound by hearing the source. The instrument 500 generates vibration and changes the frequency on the basis of the vibration mode information. By changing the frequency, the vibration intensity can also be changed.

According to the exercise promotion system 1300, it is possible to continuously change stimulation to the Pacinian corpuscle by the grip exercise and the music sound 1320. An individual who uses the instrument 500 can simultaneously perceive auditory information from the ears and body sensory information from the Pacinian corpuscles with the brain. The individual who uses the instrument 500 can perform the grip exercise more comfortably by synchronizing the auditory information and the body sensory information.

The first embodiment (FIG. 71) to the fourth embodiment (FIG. 74) according to the invention of the user information providing system (here, the exercise promotion system) described above can also be described as follows. For example, according to these exercise promotion systems 1000, 1100, 1200, and 1300, it is possible to cause reflection (self-reflection, mirroring, and the like) to an individual who uses or holds the instrument by transmitting (uploading) information on the individual via the instrument (the instrument 400, the instrument 500, or the like) and receiving (downloading) information on the individual via the instrument or the communication terminal 1030.

Further, as also described in the first embodiment (FIG. 71), the reference exercise information serving as model information for the exercise by the user is transmitted so that the user can exercise on the basis of the model information, and thereby the user can exercise after obtaining the information on an appropriate exercise. In addition, the reference exercise information can be presented via the vibration or the vertical movement (the movement of the pressing portion 420 in the protruding direction) generated by the instrument (the instrument 400, the instrument 500, or the like). In this case, for example, the reference exercise information can be presented to the user by causing the instrument (the instrument 400, the instrument 500, or the like) to generate the vibration or the vertical movement synchronized with a rhythm, a tempo, or the like of the standard exercise. As described above, by presenting the reference exercise information via the instrument (the instrument 400, the instrument 500, or the like), it is possible to generate a signal transmitted from the Pacinian corpuscle to the brain.

Further, in a case where the reference exercise information by a video or music and the reference exercise information transmitted from the instrument (the instrument 400, the instrument 500, or the like) are simultaneously combined (synchronized) and output, visual information, auditory information, and information from the Pacinian corpuscle are integrally transmitted to the brain of the user. Therefore, it is possible to perform information transmission in a novel and unprecedented mode.

Thereafter, in the exercise promotion systems 1000, 1100, 1200, and 1300, the information of each individual (the use state information as the state information) is acquired by mutual communication, and personal user information is fed back to the user, and thereby the effect of reflection (self-reflection, mirroring, and the like) in the user can be further enhanced. The user information providing system can also be referred to as an “exercise education/reflection system” or the like.

Since the information to be mutually communicated is information of an individual, and the information given to the individual (information to be fed back) reflects a personal situation, it is possible to generate a situation as if a trainer for an individual (personal trainer) performs diagnosis and indicator creation on the basis of an exercise menu for an individual or instructs or gives advice (an instruction or the like) to an individual. Then, the individual who has received the instruction or the like can recognize that a way of performing an exercise (exercise condition) is smooth or recognize excess or deficiency.

Further, as the individual recognizes his/her exercise condition and continues daily exercise while improving the way of performing the exercise, self-improvement is sequentially achieved, and as a result, spiralling-up in a way of progressing the exercise by the individual can be expected. In addition, with the function of mutual communication that enables an individual to experience the spiralling-up, it is also possible to encourage an individual to have a desire (including a desire of purchase) for the instrument (the instrument 400, the instrument 500, or the like).

### Other Examples Related to Information to be Processed by Instrument

Next, other examples related to information to be processed by the instrument (here, the instrument 500) will be described. Note that portions similar to those of the above-described instrument (the instrument 500, or the like) or the second embodiment according to the invention of the exercise promotion system (the exercise promotion system 1100 in FIG. 72) are denoted by the same reference numerals, and the description thereof will be omitted as appropriate.

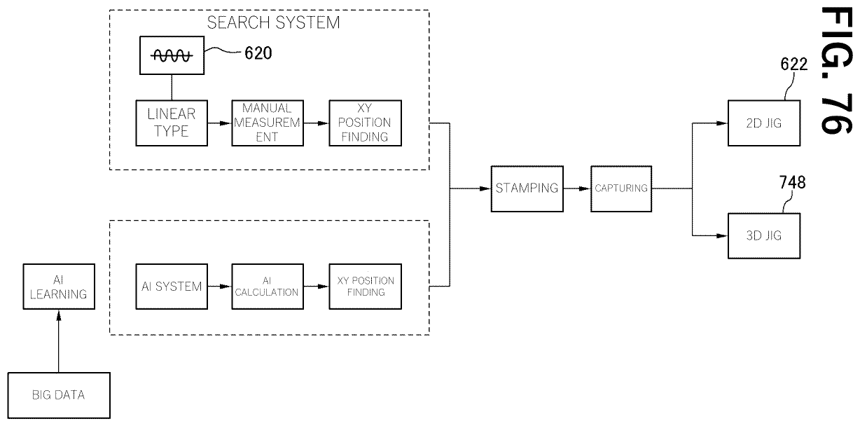

Regarding the instrument 500, the grasp force (grip strength) is measured by the instrument 500, and the current grasp force, the number of grips on that day, a time of grip exercise, or the like is notified to an individual who uses the instrument. In the example of FIGS. 75(a) and 75(b), the display device 560 of the instrument 500 is used as an indicator for notifying the grasp force. In addition, in the instrument 500 (or the communication terminal 1030), the most effective grasp force can be input and stored for an individual who uses the instrument. Then, when the targeted grasp force (target grasp force) is set and the grasp force reaches a target value, this is notified. Examples of means for notifying that the target has been reached include the display device 560 or a lamp (LED) having a predetermined color (green or the like).

In addition, as another example, a sensor (health indicator sensor) that measures a health indicator such as blood pressure is installed in the instrument 500, and the measured health indicator is displayed on the display device 560. Communication with the communication terminal 1030 is performed, and the health indicator is continuously managed in the communication terminal 1030. In this manner, it is possible to perform health management in conjunction with the communication terminal 1030.

In addition, information transmitted and received between the instrument (the instrument 400, the instrument 500, or the like) and the operating system (the operating system 1110 or the operating system 1310) of the management center is not limited to the information described above. For example, the state information of the instrument may be malfunction information, loss information, or the like of the instrument.

Regarding the malfunction information of the instrument (the instrument 400, the instrument 500, or the like), for example, it is conceivable to provide a malfunction detecting unit (state detecting unit) inside the instrument (in various main body portions or the like). In the case where it is found that energization of an electric circuit (including an electronic circuit) in the instrument is not normal by the function of the malfunction detecting unit, a signal indicating this state or information subjected to arithmetic processing is transmitted from the instrument to the operating system (the operating system 1110 or the operating system 1310).

In addition, regarding the loss information of the instrument (the instrument 400, the instrument 500, or the like), for example, it is conceivable to provide a position information system circuit unit (a GPS circuit unit or the like) as a state detecting unit in the instrument. Then, the operating system (the operating system 1110 or the operating system 1310) of the management center transmits the position information of the instrument to the communication terminal 1030 via a detection system (not illustrated). The communication terminal 1030 superimposes and displays the map information and the position information to notify the position of the instrument.

Although the embodiments have been described above, the embodiments can also be comprehensively described as follows. First, the Pacinian point search can be performed by various methods such as the manual search method using the pressure point pressing stick or the like (the search method as illustrated in FIG. 13(b) or FIG. 40), the mechanical search method (the search method as illustrated in FIGS. 36 to 38), and the AI search method (a search method as illustrated in FIGS. 45 to 46).

Further, through various search methods, the position the Pacinian point is marked on the hand of the user of the instrument. This marked hand is then utilized for forming a positioning format (production of the 2D jig or the 3D jig) that enhances the convenience of use of the instrument and for automatic design for the instrument (automatic design as illustrated in FIGS. 47 to 56).

By using the 2D jig (such as the transparent plate 622) or the 3D jig (such as the palm mold 748) produced through the formation of the positioning format (production of the 2D jig or the 3D jig), the user can easily mark the position of the Pacinian point and confirm the position of the Pacinian point. Then, the user can smoothly start a routine use. As a result, it is possible to promote the exercise using the instrument and habituation of the use of the instrument.

Such comprehensive view regarding the instrument can be referred to as an instrument providing system (instrument providing method) including a series of steps of supplying to utilizing the instrument, devices therefor, or the like.

In addition, the inventions described above can also be described as follows.

### <Inventions of Instrument and Inventions of Position Locating Method>

(1-1)

An instrument being capable of being grasped with one hand, the instrument including a pressing portion capable of pressing a Pacinian corpuscle present in a palm, when the instrument is grasped with the one hand, in which the Pacinian corpuscle probed using a pressing body capable of pressing the Pacinian corpuscle is pressed.

(1-2)

The instrument according to (1-1), including:
a main body portion and the pressing portion provided to protrude from the main body portion, in which
by grasping the main body portion with one hand, the pressing portion can be in contact with skin on the Pacinian corpuscle present in the palm to press the Pacinian corpuscle, and
the Pacinian corpuscle searched using the pressing body capable of pressing the Pacinian corpuscle is pressed.
   (1-3)

A position locating method for using an instrument having a pressing portion capable of pressing a Pacinian corpuscle present in a palm, the method including: electrically detecting a human body reaction caused by pressing of the Pacinian corpuscle and locating a position of the Pacinian corpuscle.

(1-4)

A position locating method for using an instrument having a pressing portion capable of pressing a Pacinian corpuscle present in a palm, the method including: estimating a position of the Pacinian corpuscle by computation for the purpose of the position of the Pacinian corpuscle based on sample data of the position of the Pacinian corpuscle collected from a plurality of palms.

(1-5)

The position locating method according to any one of (1-1) to (1-4), in which a jig that reproduces the position of the located Pacinian corpuscle is used to reproduce the position of the Pacinian corpuscles when the instrument is used.

### <Inventions of Instrument Design Method>

(2-1)

An instrument design method for designing an instrument including
a main body portion and a pressing portion provided to protrude from the main body portion, in which
by grasping the main body portion with one hand, the pressing portion can be in contact with skin on the Pacinian corpuscle present in the palm to press the Pacinian corpuscle, and the method includes measuring a hand in a state where a user of the instrument grips the instrument and determining a dimension of the instrument depending on the user, by using data of the hand gripping the instrument.
   (2-2)

The instrument design method according to (2-1), in which the dimension of the instrument is determined by computation based on the data measured in a state where the instrument is gripped to form a gap between the instrument and a little finger.

### <Inventions of Instrument (Ring Model)>

(3-1)

An instrument capable of being grasped with one hand, the instrument including:
a pressing portion capable of pressing a Pacinian corpuscle present in a palm when the instrument is grasped with one hand; and a finger lock portion that is locked to at least a little finger of five fingers to prevent a change in posture.
   (3-2)

The instrument according to (3-1) including:
a main body portion; and the pressing portion provided to protrude from the main body portion, in which
the pressing portion and the finger lock portion have a certain positional relationship with each other, and
by grasping the main body portion with one hand, the pressing portion is configured to be brought into contact with skin on the Pacinian corpuscle present in the palm to press the Pacinian corpuscle.
   (3-3)

The instrument according to (3-1) or (3-2), in which
the finger lock portion has a ring shape, and
the finger lock portion is locked to at least the little finger between the little finger and a ring finger.
   (3-4)

The instrument according to any one of (3-1) to (3-3), in which a shape of the pressing portion is a stepped shape.

(3-5)

The instrument according to any one of (3-1) to (3-3), in which at least a tip portion of the pressing portion has a spherical shape having a radius (R) of 0.5 mm to 5 mm

(3-6)

The instrument according to any one of (3-1) to (3-3), in which a shape of at least a tip portion of the pressing portion is a conical shape.

(3-7)

The instrument according to any one of (3-1) to (3-3), in which a shape of at least a tip portion of the pressing portion is a cylindrical shape.

### <Inventions of Instrument (Including Vibration Applying Unit or the Like)>

(4-1)

An instrument capable of being grasped with one hand, the instrument including:
a pressing portion capable of pressing a Pacinian corpuscle present in a palm while transmitting vibration to the Pacinian corpuscle, when the instrument is grasped with one hand.
   (4-2)

The instrument according (4-1), including:
a main body portion:
the pressing portion provided to protrude from the main body portion; and
a vibration applying unit that generates vibration, in which
by grasping the main body portion with one hand, the pressing portion is configured to be brought into contact with skin on the Pacinian corpuscle present in the palm to press the Pacinian corpuscle while transmitting vibration to the Pacinian corpuscle.
   (4-3)

The instrument according to (4-1) or (4-2), in which the pressing portion vibrates.

(4-4)

The instrument according to (4-1) or (4-2), in which the pressing portion is configured to include at least a part of a vibrating body that vibrates.

(4-5)

The instrument according to (4-2), in which the vibration is vibration in a direction intersecting a direction in which the pressing portion protrudes from the main body portion.

(4-6)

The instrument according to (4-2), in which the vibration is vibration in a direction in which the pressing portion protrudes from the main body portion.

(4-7)

The instrument according to any one of (4-1) to (4-6), including a use state detecting unit capable of detecting a use state in a grasping situation.

(4-8)

An instrument capable of being grasped with one hand, the instrument including:
a pressing portion capable of pressing a Pacinian corpuscle present in a palm when the instrument is grasped with one hand; and
a state detecting unit capable of detecting a state of the instrument.

### <Inventions of User Information Providing System and the Like>

(5-1)

A user information providing system in which
at least one instrument is used, the instrument being capable of being grasped with one hand and including a pressing portion capable of pressing a Pacinian corpuscle present in a palm, when the instrument is grasped in the one hand, and
state information indicating a state of the instrument is collected by the instrument, and user information related to a user can be presented to the user of the instrument based on the collected state information.
   (5-2)

The user information providing system, in which
at least one instrument is used, the instrument being configured to include a main body portion and the pressing portion provided to protrude from the main body portion, in which by grasping the main body portion with one hand, the pressing portion can contact skin on the Pacinian corpuscle present in the palm to press the Pacinian corpuscle,
the instrument includes a state detecting unit capable of detecting a state of the instrument, and
state information indicating a state of the instrument is collected by the state detecting unit, and user information related to a user can be presented to the user of the instrument based on the collected state information.
   (5-3)

The user information providing system according to (5-1) or (5-2), in which
the state information is use state information indicating a use state of the instrument in a grasped situation, and
the user information is exercise information related to an exercise using the instrument.
   (5-4)

The user information providing system according to any one of (5-1) to (5-3), in which
when the instrument is grasped with one hand, the instrument can press the Pacinian corpuscle present in the palm by the pressing portion while transmitting vibration, and
a frequency of the vibration is changed.
   (5-5)

The user information providing system according to any one of (5-1) to (5-4), in which reference exercise information to be used as a reference for use of the instrument can be presented to the user of the instrument before collection of the state information.

(5-6)

A method for providing user information in which
at least one instrument is used, the instrument being capable of being grasped with one hand and including a pressing portion capable of pressing a Pacinian corpuscle present in a palm, when the instrument is grasped in the one hand,
the method includes:
a step of collecting, by the instrument, state information indicating a state of the instrument; and
a step of presenting user information related to a user to the user of the instrument based on the collected state information.
   (5-7)

A method for providing user information in which
an instrument is provided to be capable of being grasped with one hand and including a pressing portion capable of pressing a Pacinian corpuscle present in a palm, when the instrument is grasped with the one hand, and at least one instrument is used, the instrument being configured to include a main body portion and the pressing portion provided to protrude from the main body portion, in which by grasping the main body portion with one hand, the pressing portion can contact skin on the Pacinian corpuscle present in the palm to press the Pacinian corpuscle, and the instrument includes a state detecting unit capable of detecting a state of the instrument, and
the method includes:
a step of collecting state information indicating a state of the instrument, by the state detecting unit; and
a step of presenting, to a user of the instrument, user information related to the user based on the collected state information.
   (5-8)

The method for providing user information according to claim (5-6) or (5-7), in which reference exercise information to be used as a reference for use of the instrument is presented to the user of the instrument before collection of the state information.

Although the embodiments have been described above, the present invention is not limited thereto, and many modifications can be made within the scope of the technical idea of the present invention. Further, various aspects described above can be appropriately combined as long as no particular problem occurs.

In addition, each of the above embodiments is merely an example of implementation in implementing the present invention, and the technical scope of the present invention should not be construed to be limited by this. That is, the present invention can be implemented in various forms without departing from the gist or main features thereof. For example, each configuration of the embodiments may be combined and implemented.

### REFERENCE SIGNS LIST

1, 200, 200A to 200F, 300, 400, 500 instrument
10, 210, 210A to 210F, 310, 410 main body portion
101 first main body portion
101a protrusion
101b recess
102 second main body portion
102a first protrusion
102b second protrusion
102c recess
103 third main body portion
103a recess
104 fourth main body portion
104a recess
11A first stopper (little finger stopper)
11B second stopper (middle finger stopper)
11C third stopper (thumb stopper)
12A first recess
12B second recess
20, 220, 220A to 220F, 320, 420 pressing portion
20a protrusion
21, 221 contact portion (Pacinian ball)
21A, 221a contact surface
22, 222, 322, 422 connecting portion
600, 700 Pacinian point locating system
810 model of bone (hand bone model)
820 model of hand (hand model)
312 vibrating motor (vibration applying unit)
340 vibrator (vibration applying unit)
412 vibrator (vibration applying unit)
444 vibration stick (vibration applying unit, vibrating body)
446 position sensor (state detecting unit)
448 pressure sensor (state detecting unit)
612 pressing stick (pressing body)
1000, 1100, 1200, 1300 exercise promotion system (user information providing system)

1. An instrument capable of being grasped with one hand, the instrument comprising:
a pressing portion capable of pressing a Pacinian corpuscle present in a palm while transmitting vibration to the Pacinian corpuscle, when the instrument is grasped with one hand.

2. The instrument according to claim 1, comprising:
a main body portion;
the pressing portion provided to protrude from the main body portion; and
a vibration applying unit that generates vibration, wherein
by grasping the main body portion with one hand, the pressing portion is configured to be brought into contact with skin on the Pacinian corpuscle present in the palm to press the Pacinian corpuscle while transmitting vibration to the Pacinian corpuscle.

3. The instrument according to claim 1, wherein the pressing portion vibrates.

4. The instrument according to claim 1, wherein the pressing portion is configured to include at least a part of a vibrating body that vibrates.

5. The instrument according to claim 2, wherein the vibration is vibration in a direction intersecting a direction in which the pressing portion protrudes from the main body portion.

6. The instrument according to claim 2, wherein the vibration is vibration in a direction in which the pressing portion protrudes from the main body portion.

7. The instrument according to claim 1, comprising a use state detecting unit capable of detecting a use state in a grasping situation.

8. An instrument capable of being grasped with one hand, the instrument comprising:
a pressing portion capable of pressing a Pacinian corpuscle present in a palm when the instrument is grasped with one hand; and
a state detecting unit capable of detecting a state of the instrument.

9. An instrument capable of being grasped with one hand, the instrument comprising:
a pressing portion capable of pressing a Pacinian corpuscle present in a palm when the instrument is grasped with one hand; and
a finger lock portion that is locked to at least a little finger of five fingers to prevent a change in posture.

10. The instrument according to claim 9, comprising:
a main body portion; and
the pressing portion provided to protrude from the main body portion, wherein
the pressing portion and the finger lock portion have a certain positional relationship with each other, and
by grasping the main body portion with one hand, the pressing portion is configured to be brought into contact with skin on the Pacinian corpuscle present in the palm to press the Pacinian corpuscle.

11. The instrument according to claim 9, wherein
the finger lock portion has a ring shape, and
the finger lock portion is locked to at least the little finger between the little finger and a ring finger.

12. The instrument according to claim 9, wherein a shape of the pressing portion is a stepped shape.

13. The instrument according to claim 9, wherein at least a tip portion of the pressing portion has a spherical shape having a radius (R) of 0.5 mm to 5 mm.

14. The instrument according to claim 9, wherein a shape of at least a tip portion of the pressing portion is a conical shape.

15. The instrument according to claim 9, wherein a shape of at least a tip portion of the pressing portion is a cylindrical shape.
